(19) United States
(12) Patent Application Publication
(10) Pub. No.: US 2014/0088066 A1
(43) Pub. Date: Mar. 27, 2014

(54) PLATINUM COMPOUNDS, COMPOSITIONS AND METHODS FOR THE TREATMENT OF CANCER

(71) Applicant: Blend Therapeutics, Watertown, MA (US)

(72) Inventors: Mark T. Bilodeau, Concord, MA (US); Craig A. Dunbar, Needham, MA (US); Timothy E. Barder, Arlington, MA (US); Edward R. Lee, Sudbury, MA (US); Rossitza G. Alargova, Brighton, MA (US); Danielle N. Rockwood, Medford, MA (US); Benoît Moreau, Newton, MA (US); Rajesh Shinde, Waltham, MA (US); Melaney Bouthillette, Newton, MA (US)

(73) Assignee: Blend Therapeutics, Watertown, MA (US)

(21) Appl. No.: 14/024,188

(22) Filed: Sep. 11, 2013

Related U.S. Application Data
(60) Provisional application No. 61/699,638, filed on Sep. 11, 2012.
(60) Provisional application No. 61/791,109, filed on Mar. 15, 2013.

(51) Int. Cl. C07F 15/00

(52) U.S. Cl. CPC C07F 15/0093
USPC 514/187; 546/10; 514/185; 548/108; 514/186; 546/5; 546/6

(57) ABSTRACT

The present disclosure relates to novel pharmaceutical compositions comprising a nanoparticle associated with, tether to, or encapsulating a platinum-based active pharmaceutical agent. The platinum-based drug is released from the nanoparticles in a controlled fashion. Also contemplated are methods of making the nanoparticles, as well as methods for using them in the treatment or prevention of diseases or conditions. One embodiment relates to phenanthriplatin nanoparticles and methods of using and making the same.

### RELATED CASES

This application claims priority to U.S. Provisional Application No. 61/791,109 filed on Mar. 15, 2013, and to U.S. Provisional Application No. 61/699,638 filed on Sep. 11, 2012, which are incorporated herein by reference in their entirety to the full extent permitted by law.

### FIELD

The present disclosure relates to novel compounds, and pharmaceutical compositions comprising a nanoparticle associated with or encapsulating a platinum-based active pharmaceutical agent. The platinum-based drug may be administered alone, or as nanoparticles, where it is released from the nanoparticles in a controlled fashion. Also contemplated are methods of making the nanoparticles, as well as methods for using them in the treatment or prevention of diseases or conditions. In one embodiment, the invention relates to phenanthriplatin nanoparticles and methods of using and making the same.

### BACKGROUND

Platinum-based drugs are among the most active and widely used anticancer agents and cisplatin represents one of three FDA-approved, platinum-based cancer chemotherapeutics. Although cisplatin is effective against a number of solid tumors, especially testicular and ovarian cancer, its clinical use has been limited because of its toxic effects as well as the intrinsic and acquired resistance of some tumors to this drug. To overcome these limitations, platinum analogs with lower toxicity and greater activity in cisplatin-resistant tumors have been developed and tested, resulting in the approval of carboplatin and oxaliplatin in the United States. Carboplatin is generally less nephrotoxic, and oxaliplatin exhibits a different anticancer spectrum from that of cisplatin. Oxaliplatin has been approved as the first or second line therapy in combination with 5-fluorouracil/leucovorin for advanced colorectal cancer, for which cisplatin and carboplatin are essentially inactive. These platinum drugs have platinum in the 2+ oxidative state (Pt(II)).

Novel developments in nanomedicine are directed towards improving the pharmaceutical properties of the drugs and enhancing the targeted delivery in a cell-specific manner. Several cell-specific drugs are known in literature, and include monoclonal antibodies, aptamers, peptides, and small molecules. Despite some of the potential advantages of these drugs, disadvantages have limited their clinical application. Such disadvantages include size, stability, manufacturing cost, immunogenicity, poor pharmacokinetics and other factors.

However, nanoparticulate drug delivery systems are attractive in systemic drug delivery because of their ability to prolong drug circulation half-life, reduce non-specific uptake, and better accumulate at the tumors through an enhanced permeation and retention (EPR) effect. As a result, several therapeutic nanoparticles, such as Doxil® and Abraxane®, are used as the frontline therapies. Nevertheless, research efforts have heretofore focused on single or multiple drug encapsulations or tethering without cell-specific targeting moieties. The development of nanotechnologies for effective delivery of drugs or drug candidates to specific diseased cells and tissues, e.g., to cancer cells, in specific organs or tissues, in a tempospatially regulated manner can potentially overcome the therapeutic challenges faced to date.

### SUMMARY OF THE INVENTION

The present teachings relate to compositions, for example, for reducing, disrupting, or inhibiting the growth of a cancer cell or inducing the death of a cancer cell. The composition can include a platinum compound.

In various embodiments, the present teachings provide a compound of Formula I:

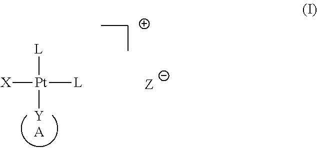

wherein:
X is a halide, sulfonate, sulfate, phosphate, or carboxylate such as stearate;
L each is independently ammonia or an amine;
Y is selected from N, P, and S;
A together with Y form a heteroaromatic optionally substituted with one or more substituents each independently selected from halogen, cyano, nitro, hydroxyl, ester, ether, alkoxy, aryloxy, amino, amide, carbamate, alkyl, alkenyl, alkynyl, aryl, arylalkyl, cycloalkyl, heteroaryl, heterocyclyl, phosphono, phosphate, sulfide, sulfinyl, sulfino, sulfonyl, sulfo, and sulfonamide, wherein each of the ester, ether, alkoxy, aryloxy, amino, amide, carbamate, alkyl, alkenyl, alkynyl, aryl, arylalkyl, cycloalkyl, heteroaryl, heterocyclyl, phosphono, phosphate, sulfide, sulfinyl, sulfino, sulfonyl, sulfo, and sulfonamide is optionally substituted with one or more suitable substituents; and
Z is a pharmaceutically acceptable counter ion;
wherein two of the adjacent X and Ls form a bidentate ligand, or
X and two Ls form a tridentate ligand, or
A, together with Y, and X form a bidentate ligand.

In some embodiments, the present disclosure relates to novel pharmaceutical compositions comprising a platinum complex of Formula (II):

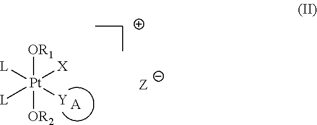

or a salt thereof,
X is a halide, sulfonate, sulfate, phosphate, or carboxylate such as stearate;
L each is independently ammonia or an amine;
Y is selected from N, P, and S;
A together with Y form a heteroaromatic optionally substituted with one or more substituents each independently selected from halogen, cyano, nitro, hydroxyl, ester, ether, alkoxy, aryloxy, amino, amide, carbamate, alkyl, alkenyl, alkynyl, aryl, arylalkyl, cycloalkyl, heteroaryl, heterocyclyl, phosphono, phosphate, sulfide, sulfinyl, sulfino, sulfonyl, sulfo, and sulfonamide, wherein each of the ester, ether, alkoxy, aryloxy, amino, amide, carbamate, alkyl, alkenyl, alkynyl, aryl, arylalkyl, cycloalkyl, heteroaryl, heterocyclyl, phosphono, phosphate, sulfide, sulfinyl, sulfino, sulfonyl, sulfo, and sulfonamide is optionally substituted with one or more suitable substituents; and
Z is a pharmaceutically acceptable counter ion;
wherein two of the adjacent X and Ls form a bidentate ligand, or
X and two Ls form a tridentate ligand, or
A, together with Y, and X form a bidentate ligand.
wherein each hydrogen atom of the aryl ring system is optionally replaced with a halide; and R¹ and R² individually is a hydrogen, alkyl, alkenyl, alkynyl, heteroalkyl, heteroalkenyl, heteroalkynyl, aryl, heteroalkyl, carbamoyl, and carbonyl, each optionally substituted, or are absent.

In one embodiment, the platinum compound is phenanthriplatin, a compound having the structure:

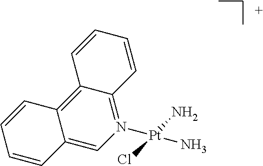

In another embodiment, the platinum complexes disclosed herein are encapsulated in, tethered to, or otherwise associated with a nanoparticle. In a further embodiment, the nanoparticles may contain a plurality of the same or different platinum compounds.

As mentioned, the platinum compounds taught herein may be formulated as nanoparticles. In some embodiments they are encapsulated, in whole or in part, in the inner portion of the nanoparticles, or may be tethered or otherwise associated with nanoparticles. The nanoparticles may have a substantially spherical, non spherical configuration (e.g. upon swelling or shrinkage) or non spherical configuration in terms of morphology (e.g. rods, box, fibers, cups etc.). The nanoparticles may include polymer blends. In various embodiments, the base component of the nanoparticles comprises a polymer, a small molecule, or a mixture thereof. The base component can be biologically derived. For example, the small molecule can be a lipid. A “lipid,” as used herein, refers to a hydrophobic or amphiphilic small molecule. Without attempting to limit the scope of the present teachings, lipids, because of their amphiphilicity, can form particles, including liposomes and micelles. The base component may be a cyclodextrin or an inorganic platform useful in forming nanoparticles.

In some embodiments, the base component comprises a polymer. For example, the polymer can be a biopolymer. Non-limiting examples include peptides or proteins (i.e., polymers of various amino acids), nucleic acids such as DNA or RNA. In certain embodiments, the polymer is amphiphilic, i.e., having a hydrophilic portion and a hydrophobic portion, or a relatively hydrophilic portion and a relatively hydrophobic portion.

In another embodiment, a pharmaceutical composition is provided comprising the nanoparticulate platinum compounds described herein, or pharmaceutically acceptable salts thereof, in a pharmaceutically acceptable vehicle. For example, an isotonic solution suitable for intravenous injection is contemplated by the present disclosure. In other embodiments, the compositions are formulated as oral, subcutaneous, and intramuscular dosage forms.

In yet another embodiment, the platinum compounds are released from the nanoparticle in a controlled fashion. Also contemplated are methods of making the nanoparticles, as well as methods for using them in the treatment or prevention of diseases or conditions.

In various embodiments, the methods of the present teachings are useful for the prevention or treatment of diseases that benefit from increased cell death or decreased cell proliferation. For example, the method of the present teachings can be used to increase cancer cell death or decrease cancer cell proliferation. The increased cancer cell death or decreased cancer proliferation can occur, for example, outside the body (in vitro) or inside the body (in vivo). Certain embodiments of the present teachings also provide for use of a compound as described herein in the manufacture of a medicament.

Other embodiments, objects, features, and advantages will be set forth in the detailed description of the embodiments that follow and, in part, will be apparent from the description or may be learned by practice of the claimed invention. These objects and advantages will be realized and attained by the compositions and methods described and claimed herein. The foregoing Summary has been made with the understanding that it is to be considered as a brief and general synopsis of some of the embodiments disclosed herein, is provided solely for the benefit and convenience of the reader, and is not intended to limit in any manner the scope, or range of equivalents, to which the appended claims are lawfully entitled.

### BRIEF DESCRIPTION OF THE DRAWINGS

FIG. 1 is the ¹H NMR spectrum of compound 22 in d6-DMSO (400 MHz Varian)

FIG. 2 is the ¹H NMR spectrum of compound 23 in d7-DMF (400 MHz Varian)

FIG. 3 is the ¹H NMR spectrum of compound 27 in d7-DMF (400 MHz Varian)

### DETAILED DESCRIPTION

While the present disclosure is capable of being embodied in various forms, the description below of several embodiments is made with the understanding that the present disclosure is to be considered as an exemplification of the claimed subject matter, and is not intended to limit the appended claims to the specific embodiments illustrated and/or described. Accordingly, it should not be construed to limit the scope or breadth of the present invention. The headings used throughout this disclosure are provided for convenience only and are not to be construed to limit the claims in any way. Embodiments illustrated under any heading may be combined with embodiments illustrated under any other heading.

### I. DEFINITIONS

For convenience, before further description of the present teachings, certain terms employed in the specification, examples, and appended claims are collected below. These definitions should be read in light of the remainder of the disclosure and understood as by a person of ordinary skill in the art. Unless defined otherwise, all technical and scientific terms used herein have the same meaning as commonly understood by a person of ordinary skill in the art.

A. General Terms

The use of the terms “a,” “an” and “the” and similar references in the context of this disclosure (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., such as, preferred, preferably) provided herein, is intended merely to further illustrate the content of the disclosure and does not pose a limitation on the scope of the claims. No language in the specification should be construed as indicating any non-claimed element as essential to the practice of the present disclosure.

The phrase “and/or,” as used herein, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements).

As used herein, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein, the phrase “at least one” in reference to a list of one or more elements should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, all transitional phrases such as “comprising,” “including,” “carrying,” “having,” “containing,” “involving,” “holding,” “associated,” “associated with” and the like are to be understood to be open-ended, i.e., to mean including but not limited to.

Only the transitional phrases “consisting of” and “consisting essentially of” shall be closed or semi-closed transitional phrases, respectively, as set forth in the United States Patent Office Manual of Patent Examining Procedures.

The use of individual numerical values is stated as approximations as though the values were preceded by the word “about” or “approximately.” Similarly, the numerical values in the various ranges specified in this application, unless expressly indicated otherwise, are stated as approximations as though the minimum and maximum values within the stated ranges were both preceded by the word “about” or “approximately.” In this manner, variations above and below the stated ranges can be used to achieve substantially the same or similar results as values within the ranges. As used herein, the terms “about” and “approximately” when referring to a numerical value shall have their plain and ordinary meanings to a person of ordinary skill in the art to which the disclosed subject matter is most closely related or the art relevant to the range or element at issue. The amount of broadening from the strict numerical boundary depends upon many factors. For example, some of the factors which may be considered include the criticality of the element and/or the effect a given amount of variation will have on the performance of the claimed subject matter, as well as other considerations known to those of skill in the art. As used herein, the use of differing amounts of significant digits for different numerical values is not meant to limit how the use of the words “about” or “approximately” will serve to broaden a particular numerical value or range. Thus, as a general matter, “about” or “approximately” broaden the numerical value. Also, the disclosure of ranges is intended as a continuous range including every value between the minimum and maximum values plus the broadening of the range afforded by the use of the term “about” or “approximately.” Thus, recitation of ranges of values herein are merely intended to serve as a shorthand method of referring individually to each separate value falling within the range, unless otherwise indicated herein, and each separate value is incorporated into the specification as if it were individually recited herein.

B. Terms Related to Compositions of the Present Disclosure

The terms “therapeutic agent” or “active agent” or “pharmaceutically active agent” are art-recognized and refer to an agent capable of having a desired biological effect in a host.

The term “nanoparticle” as used herein refers to a particle having a characteristic dimension of less than about 1 micrometer, where the characteristic dimension of a particle is the diameter of a perfect sphere having the same volume as the particle. The plurality of particles can be characterized by an average diameter (e.g., the average diameter for the plurality of particles). In some embodiments, the diameter of the particles may have a Gaussian-type distribution. In some embodiments, the plurality of particles have an average diameter of less than about 300 nm, less than about 250 nm, less than about 200 nm, less than about 150 nm, less than about 100 nm, less than about 50 nm, less than about 30 nm, less than about 10 nm, less than about 3 nm, or less than about 1 nm. In some embodiments, the particles have an average diameter of at least about 5 nm, at least about 10 nm, at least about 30 nm, at least about 50 nm, at least about 100 nm, at least about 150 nm, or greater. In certain embodiments, the plurality of the particles have an average diameter of about 10 nm, about 25 nm, about 50 nm, about 100 nm, about 150 nm, about 200 nm, about 250 nm, about 300 nm, about 500 nm, or the like. In some embodiments, the plurality of particles have an average diameter between about 10 nm and about 500 nm, between about 50 nm and about 400 nm, between about 100 nm and about 300 nm, between about 150 nm and about 250 nm, between about 175 nm and about 225 nm, or the like. In some embodiments, the plurality of particles have an average diameter between about 10 nm and about 500 nm, between about 20 nm and about 400 nm, between about 30 nm and about 300 nm, between about 40 nm and about 200 nm, between about 50 nm and about 175 nm, between about 60 nm and about 150 nm, between about 70 nm and about 120 nm, or the like. For example, the average diameter can be between about 70 nm and 120 nm.

C. Terms Related to Methods of Treatment

As used herein, a “subject” or a “patient” refers to any mammal (e.g., a human), such as a mammal that may be susceptible to a disease or disorder, for example, tumorigenesis or cancer. Examples include a human, a non-human primate, a cow, a horse, a pig, a sheep, a goat, a dog, a cat, or a rodent such as a mouse, a rat, a hamster, or a guinea pig. In various embodiments, a subject refers to one that has been or will be the object of treatment, observation, or experiment. For example, a subject can be a subject diagnosed with cancer or otherwise known to have cancer or one selected for treatment, observation, or experiment on the basis of a known cancer in the subject.

As used herein, “treatment” or “treating” refers to an amelioration of a disease or disorder, or at least one discernible symptom thereof. In another embodiment, “treatment” or “treating” refers to an amelioration of at least one measurable physical parameter, not necessarily discernible by the patient. In yet another embodiment, “treatment” or “treating” refers to reducing the progression of a disease or disorder, either physically, e.g., stabilization of a discernible symptom, physiologically, e.g., stabilization of a physical parameter, or both. In yet another embodiment, “treatment” or “treating” refers to delaying the onset of a disease or disorder.

As used herein, “prevention” or “preventing” refers to a reduction of the risk of acquiring a given disease or disorder.

The phrase “therapeutically effective amount” as used herein means that amount of a compound, material, or composition comprising a compound of the present teachings which is effective for producing some desired therapeutic effect. Accordingly, a therapeutically effective amount treats or prevents a disease or a disorder. In various embodiments, the disease or disorder is a cancer.

The term “therapeutic effect” is art-recognized and refers to a local or systemic effect in animals, e.g., mammals, including humans, caused by a pharmacologically active substance. The term thus means any substance intended for use in the diagnosis, cure, mitigation, treatment or prevention of disease or in the enhancement of desirable physical or mental development and conditions in an animal or human.

The term “modulation” is art-recognized and refers to up regulation (i.e., activation or stimulation), down regulation (i.e., inhibition or suppression) of a response, or the two in combination or apart.

The terms “systemic administration,” “administered systemically,” “peripheral administration” and “administered peripherally” are art-recognized and refer to the administration of a composition, therapeutic or other material other than directly into the central nervous system, such that it enters the patient's system and, thus, is subject to metabolism and other like processes, for example, intravenous or subcutaneous administration.

The terms “parenteral administration” and “administered parenterally” are art-recognized and refer to modes of administration other than enteral and topical administration, usually by injection, and includes, without limitation, intravenous, intramuscular, intraarterial, intrathecal, intracapsular, intraorbital, intracardiac, intradermal, intraperitoneal, transtracheal, subcutaneous, subcuticular, intra-articulare, subcapsular, subarachnoid, intraspinal, and intrasternal injection.

D. Chemical Terms

A dash (“-”) that is not between two letters or symbols is used to indicate a point of attachment for a substituent. For example, —CONH₂ is attached through the carbon atom (C).

By “optional” or “optionally” is meant that the subsequently described event or circumstance may or may not occur, and that the description includes instances where the event or circumstance occurs and instances in which it does not. For example, “optionally substituted aryl” encompasses both “aryl” and “substituted aryl” as defined herein. It will be understood by those skilled in the art, with respect to any group containing one or more substituents, that such groups are not intended to introduce any substitution or substitution patterns that are sterically impractical, synthetically non-feasible, and/or inherently unstable.

The term “alkyl” as used herein refers to a saturated straight or branched hydrocarbon, such as a straight or branched group of 1-22, 1-8, 1-6, or 1-4 carbon atoms, referred to herein as (C₁-C₂₂)alkyl, (C₁-C₈)alkyl, (C₁-C₆)alkyl, and (C₁-C₄)alkyl, respectively. Exemplary alkyl groups include, but are not limited to, methyl, ethyl, propyl, isopropyl, 2-methyl-1-propyl, 2-methyl-2-propyl, 2-methyl-1-butyl, 3-methyl-1-butyl, 2-methyl-3-butyl, 2,2-dimethyl-1-propyl, 2-methyl-1-pentyl, 3-methyl-1-pentyl, 4-methyl-1-pentyl, 2-methyl-2-pentyl, 3-methyl-2-pentyl, 4-methyl-2-pentyl, 2,2-dimethyl-1-butyl, 3,3-dimethyl-1-butyl, 2-ethyl-1-butyl, butyl, isobutyl, t-butyl, pentyl, isopentyl, neopentyl, hexyl, heptyl, and octyl.

The term “alkenyl” as used herein refers to an unsaturated straight or branched hydrocarbon having at least one carbon-carbon double bond, such as a straight or branched group of 2-22, 2-8, 2-6, or 2-4 carbon atoms, referred to herein as (C₂-C₂₂)alkenyl, (C₂-C₈)alkenyl, (C₂-C₆)alkenyl, and (C₂-C₄)alkenyl, respectively. Exemplary alkenyl groups include, but are not limited to, vinyl, allyl, butenyl, pentenyl, hexenyl, butadienyl, pentadienyl, hexadienyl, 2-ethylhexenyl, 2-propyl-2-butenyl, and 4-(2-methyl-3-butene)-pentenyl.

The term “alkynyl” as used herein refers to an unsaturated straight or branched hydrocarbon having at least one carbon-carbon triple bond, such as a straight or branched group of 2-22, 2-8, 2-6, 2-4 carbon atoms, referred to herein as (C₂-C₂₂)alkynyl, (C₂-C₈)alkynyl, (C₂-C₆)alkynyl, and (C₂-C₄)alkynyl, respectively. Exemplary alkynyl groups include, but are not limited to, ethynyl, propynyl, butynyl, pentynyl, hexynyl, methylpropynyl, 4-methyl-1-butynyl, 4-propyl-2-pentynyl, and 4-butyl-2-hexynyl.

The term “cycloalkyl” as used herein refers to a saturated or unsaturated cyclic, bicyclic, other multicyclic, or bridged bicyclic hydrocarbon group. A cyclicalkyl group can have 3-22, 3-12, or 3-8 carbons, referred to herein as (C₃-C₂₂)cycloalkyl, (C₃-C₁₂)cycloalkyl, or (C₃-C₈)cycloalkyl, respectively. Exemplary cycloalkyl groups include, but are not limited to, cyclohexanes, cyclohexenes, cyclopentanes, and cyclopentenes. Cycloalkyl groups can be fused to other cycloalkyl saturated or unsaturated, aryl, or heterocyclyl groups.

Exemplary monocyclic cycloalkyl groups include, but are not limited to, cyclopentanes (cyclopentyls), cyclopentenes (cyclopentenyls), cyclohexanes (cyclohexyls), cyclohexenes (cyclopexenyls), cycloheptanes (cycloheptyls), cycloheptenes (cycloheptenyls), cyclooctanes (cyclooctyls), cyclooctenes (cyclooctenyls), cyclononanes (cyclononyls), cyclononenes (cyclononenyls), cyclodecanes (cyclodecyls), cyclodecenes (cyclodecenyls), cycloundecanes (cycloundecyls), cycloundecenes (cycloundecenyls), cyclododecanes (cyclododecyls), and cyclododecenes (cyclododecenyls). Other exemplary cycloalkyl groups, including bicyclic, multicyclic, and bridged cyclic groups, include, but are not limited to, bicyclobutanes (bicyclobutyls), bicyclopentanes (bicyclopentyls), bicyclohexanes (bicyclohexyls), bicycleheptanes (bicycloheptyls, including bicyclo[2,2,1]heptanes (bicycle[2,2,1]heptyls) and bicycle[3,2,0]heptanes (bicycle[3,2,0]heptyls)), bicyclooctanes (bicyclooctyls, including octahydropentalene (octahydropentalenyl), bicycle[3,2,1]octane (bicycle[3,2,1]octyl), and bicylo[2,2,2]octane (bicycle[2,2,2]octyl)), and adamantanes (adamantyls). Cycloalkyl groups can be fused to other cycloalkyl saturated or unsaturated, aryl, or heterocyclyl groups.

The term “aryl” as used herein refers to a mono-, bi-, or other multi-carbocyclic aromatic ring system. The aryl can have 6-22, 6-18, 6-14, or 6-10 carbons, referred to herein as (C₆-C₂₂)aryl, (C₆-C₁₈)aryl, (C₆-C₁₄)aryl, or (C₆-C₁₀)aryl, respectively. The aryl group can optionally be fused to one or more rings selected from aryls, cycloalkyls, and heterocyclyls. The term “bicyclic aryl” as used herein refers to an aryl group fused to another aromatic or non-aromatic carbocylic or heterocyclic ring. Exemplary aryl groups include, but are not limited to, phenyl, tolyl, anthracenyl, fluorenyl, indenyl, azulenyl, and naphthyl, as well as benzo-fused carbocyclic moieties such as 5,6,7,8-tetrahydronaphthyl. Exemplary aryl groups also include, but are not limited to a monocyclic aromatic ring system, wherein the ring comprises 6 carbon atoms, referred to herein as “(C₆)aryl” or phenyl. The phenyl group can also be fused to a cyclohexane or cyclopentane ring to form another aryl.

The term “arylalkyl” as used herein refers to an alkyl group having at least one aryl substituent (e.g., -aryl-alkyl-). Exemplary arylalkyl groups include, but are not limited to, arylalkyls having a monocyclic aromatic ring system, wherein the ring comprises 6 carbon atoms, referred to herein as “(C₆)arylalkyl.” The term “benzyl” as used herein refers to the group —CH₂-phenyl.

The term “heteroalkyl” refers to an alkyl group as described herein in which one or more carbon atoms is replaced by a heteroatom. Suitable heteroatoms include oxygen, sulfur, nitrogen, phosphorus, and the like. Examples of heteroalkyl groups include, but are not limited to, alkoxy, amino, thioester, and the like.

The terms “heteroalkenyl” and “heteroalkynyl” refer to unsaturated aliphatic groups analogous in length and possible substitution to the heteroalkyls described above, but that contain at least one double or triple bond, respectively.

The term “heterocycle” refers to cyclic groups containing at least one heteroatom as a ring atom, in some cases, 1 to 3 heteroatoms as ring atoms, with the remainder of the ring atoms being carbon atoms. Suitable heteroatoms include oxygen, sulfur, nitrogen, phosphorus, and the like. In some cases, the heterocycle may be 3- to 10-membered ring structures or 3- to 7-membered rings, whose ring structures include one to four heteroatoms. The term “heterocycle” may include heteroaryl groups, saturated heterocycles (e.g., cycloheteroalkyl) groups, or combinations thereof. The heterocycle may be a saturated molecule, or may comprise one or more double bonds. In some case, the heterocycle is a nitrogen heterocycle, wherein at least one ring comprises at least one nitrogen ring atom. The heterocycles may be fused to other rings to form a polycylic heterocycle. Thus, heterocycles also include bicyclic, tricyclic, and tetracyclic groups in which any of the above heterocyclic rings is fused to one or two rings independently selected from aryls, cycloalkyls, and heterocycles. The heterocycle may also be fused to a spirocyclic group.

Heterocycles include, for example, thiophene, benzothiophene, thianthrene, furan, tetrahydrofuran, pyran, isobenzofuran, chromene, xanthene, phenoxathiin, pyrrole, dihydropyrrole, pyrrolidine, imidazole, pyrazole, pyrazine, isothiazole, isoxazole, pyridine, pyrazine, pyrimidine, pyridazine, indolizine, isoindole, indole, indazole, purine, quinolizine, isoquinoline, quinoline, phthalazine, naphthyridine, quinoxaline, quinazoline, cinnoline, pteridine, carbazole, carboline, triazole, tetrazole, oxazole, isoxazole, thiazole, isothiazole, phenanthridine, acridine, pyrimidine, phenanthroline, phenazine, phenarsazine, phenothiazine, furazan, phenoxazine, pyrrolidine, oxolane, thiolane, oxazole, oxazine, piperidine, homopiperidine (hexamethyleneimine), piperazine (e.g., N-methyl piperazine), morpholine, lactones, lactams such as azetidinones and pyrrolidinones, sultams, sultones, other saturated and/or unsaturated derivatives thereof, and the like.

In some cases, the heterocycle may be bonded to a compound via a heteroatom ring atom (e.g., nitrogen). In some cases, the heterocycle may be bonded to a compound via a carbon ring atom. In some cases, the heterocycle is pyridine, imidazole, pyrazine, pyrimidine, pyridazine, acridine, acridin-9-amine, bipyridine, naphthyridine, quinoline, isoquinoline, benzoquinoline, benzoisoquinoline, phenanthridine-1,9-diamine, or the like.

The term “heteroaromatic” or “heteroaryl” as used herein refers to a mono-, bi-, or multi-cyclic aromatic ring system containing one or more heteroatoms, for example one to three heteroatoms, such as nitrogen, oxygen, and sulfur. Heteroaryls can also be fused to non-aromatic rings. In various embodiments, the term “heteroaromatic” or “heteroaryl,” as used herein except where noted, represents a stable 5- to 7-membered monocyclic, stable 9- to 10-membered fused bicyclic, or stable 12- to 14-membered fused tricyclic heterocyclic ring system which contains an aromatic ring that contains at least one heteroatom selected from the group consisting of oxygen, nitrogen, and sulfur. In some embodiments, at least one nitrogen is in the aromatic ring.

Heteroaromatics or heteroaryls can include, but are not limited to, a monocyclic aromatic ring, wherein the ring comprises 2-5 carbon atoms and 1-3 heteroatoms, referred to herein as “(C₂-C₅)heteroaryl.” Illustrative examples of monocyclic heteroaromatic (or heteroaryl) include, but are not limited to, pyridine (pyridinyl), pyridazine (pyridazinyl), pyrimidine (pyrimidyl), pyrazine (pyrazyl), triazine (triazinyl), pyrrole (pyrrolyl), pyrazole (pyrazolyl), imidazole (imidazolyl), (1,2,3)- and (1,2,4)-triazole ((1,2,3)- and (1,2,4)-triazolyl), pyrazine (pyrazinyl), pyrimidine (pyrimidinyl), tetrazole (tetrazolyl), furan (furyl), thiophene (thienyl), isoxazole (isoxazolyl), thiazole (thiazolyl), isoxazole (isoxazolyl), and oxazole (oxazolyl). In certain embodiments, the heteroaromatics or heteroaryls is pyridine (pyridinyl) or imidazole (imidazolyl).

The term “bicyclic heteroaromatic” or “bicyclic heteroaryl” as used herein refers to a heteroaryl group fused to another aromatic or non-aromatic carbocylic or heterocyclic ring. Exemplary bicyclic heteroaromatics or heteroaryls include, but are not limited to 5,6- or 6,6-fused systems, wherein one or both rings contain heteroatoms. The term “bicyclic heteroaromatic” or “bicyclic heteroaryl” also encompasses reduced or partly reduced forms of fused aromatic system wherein one or both rings contain ring heteroatoms. The ring system may contain up to three heteroatoms, independently selected from oxygen, nitrogen, and sulfur.

Exemplary bicyclic heteroaromatics (or heteroaryls) include, but are not limited to, quinazoline (quinazolinyl), benzoxazole (benzoxazolyl), benzothiophene (benzothiophenyl), benzoxazole (benzoxazolyl), benzisoxazole (benzisoxazolyl), benzimidazole (benzimidazolyl), benzothiazole (benzothiazolyl), benzofurane (benzofuranyl), benzisothiazole (benzisothiazolyl), indole (indolyl), indazole (indazolyl), indolizine (indolizinyl), quinoline (quinolinyl), isoquinoline (isoquinolinyl), naphthyridine (naphthyridyl), phthalazine (phthalazinyl), phthalazine (phthalazinyl), pteridine (pteridinyl), purine (purinyl), benzotriazole (benzotriazolyl), and benzofurane (benzofuranyl). In some embodiments, the bicyclic heteroaromatic (or bicyclic heteroaryl) is selected from quinazoline (quinazolinyl), benzimidazole (benzimidazolyl), benzothiazole (benzothiazolyl), indole (indolyl), quinoline (quinolinyl), isoquinoline (isoquinolinyl), and phthalazine (phthalazinyl). In certain embodiments, the bicyclic heteroaromatic (or bicyclic heteroaryl) is quinoline (quinolinyl) or isoquinoline (isoquinolinyl). In certain embodiments, the bicyclic heteroaromatic (or bicyclic heteroaryl) is benzimidazole (benzimidazolyl).

The term “tricyclic heteroaromatic” or “tricyclic heteroaryl” as used herein refers to a bicyclic heteroaryl group fused to another aromatic or non-aromatic carbocylic or heterocyclic ring. The term “tricyclic heteroaromatic” or “tricyclic heteroaryl” also encompasses reduced or partly reduced forms of fused aromatic system wherein one or both rings contain ring heteroatoms. Each of the ring in the tricyclic heteroaromatic (tricyclic heteroaryl) may contain up to three heteroatoms, independently selected from oxygen, nitrogen, and sulfur.

Exemplary tricyclic heteroaromatics (or heteroaryls) include, but are not limited to, acridine (acridinyl), 9H-pyrido[3,4-b]indole (9H-pyrido[3,4-b]indolyl), phenanthridine (phenanthridinyl), benzo[c][1,5]naphthyridine (benzo[c][1,5]naphthyridinyl), benzo[c][1,6]naphthyridine (benzo[c][1,6]naphthyridinyl), benzo[c][1,7]naphthyridine (benzo[c][1,7]naphthyridinyl), benzo[h][1,6]naphthyridine (benzo[h][1,6]naphthyridinyl), benzo[c][2,6]naphthyridine (benzo[c][2,6]naphthyridinyl), benzo[c][2,7]naphthyridine (benzo[c][2,7]naphthyridinyl), pyrido[1,2-a]benzimidazole (pyrido[1,2-a]benzimidazolyl), and pyrido[1,2-b]indazole (pyrido[1,2-b]indazolyl). In certain embodiments, the tricyclic heteroaromatics (or heteroaryls) is phenanthridine (phenanthridinyl), benzo[c][1,5]naphthyridine (benzo[c][1,5]naphthyridinyl), or pyrido[1,2-a]benzimidazole (pyrido[1,2-a]benzimidazolyl).

The term “alkoxy” as used herein refers to an alkyl group attached to an oxygen (—O-alkyl-). “Alkoxy” groups also include an alkenyl group attached to an oxygen (“alkenyloxy”) or an alkynyl group attached to an oxygen (“alkynyloxy”) groups. Exemplary alkoxy groups include, but are not limited to, groups with an alkyl, alkenyl or alkynyl group of 1-22, 1-8, or 1-6 carbon atoms, referred to herein as (C₁-C₂₂)alkoxy, (C₁-C₈)alkoxy, or (C₁-C₆)alkoxy, respectively. Exemplary alkoxy groups include, but are not limited to, methoxy and ethoxy.

The term “cycloalkoxy” as used herein refers to a cycloalkyl group attached to an oxygen.

The term “aryloxy” or “aroxy” as used herein refers to an aryl group attached to an oxygen atom. Exemplary aryloxy groups include, but are not limited to, aryloxys having a monocyclic aromatic ring system, wherein the ring comprises 6 carbon atoms, referred to herein as “(C₆)aryloxy.”

The term “amine” or “amino” as used herein refers to both unsubstituted and substituted amines, e.g., NRₐR_{b}R_{b′}, where Rₐ, R_{b}, and R_{b′} are independently selected from alkyl, alkenyl, alkynyl, aryl, arylalkyl, carbamate, cycloalkyl, haloalkyl, heteroaryl, heterocyclyl, and hydrogen, and at least one of the Rₐ, R_{b}, and R_{b′} is not hydrogen. The amine or amino can be attached to the parent molecular group through the nitrogen. The amine or amino also may be cyclic, for example any two of Rₐ, R_{b}, and R_{b′} may be joined together and/or with the nitrogen to form a 3- to 12-membered ring (e.g., morpholino or piperidinyl). The term amino also includes the corresponding quaternary ammonium salt of any amino group. Exemplary amines include alkylamine, wherein at least one of Rₐ, R_{b}, or R_{b′} is an alkyl group, or cycloalkylamine, wherein at least one of Rₐ, R_{b}, or R_{b′} is a cycloalkyl group.

The term “ammonia” as used herein refers to NH₃.

The term “aldehyde” or “formyl” as used herein refers to —CHO.

The term “acyl” as used herein refers to a carbonyl radical attached to an alkyl, alkenyl, alkynyl, cycloalkyl, heterocycyl, aryl, or heteroaryl. Exemplary acyl groups include, but are not limited to, acetyl, formyl, propionyl, benzoyl, and the like.

The term “amide” as used herein refers to the form —NR_{c}C(O)(R_{d})— or —C(O)NR_{c}Rₑ, wherein R_{c}, R_{d}, and Rₑ are each independently selected from alkyl, alkenyl, alkynyl, aryl, arylalkyl, cycloalkyl, haloalkyl, heteroaryl, heterocyclyl, and hydrogen. The amide can be attached to another group through the carbon, the nitrogen, R_{c}, R_{d}, or Rₑ. The amide also may be cyclic, for example R_{c} and Rₑ, may be joined to form a 3- to 12-membered ring, such as a 3- to 10-membered ring or a 5- or 6-membered ring. The term “amide” encompasses groups such as sulfonamide, urea, ureido, carbamate, carbamic acid, and cyclic versions thereof. The term “amide” also encompasses an amide group attached to a carboxy group, e.g., -amide-COOH or salts such as -amide-COONa.

The term “arylthio” as used herein refers to an aryl group attached to an sulfur atom. Exemplary arylthio groups include, but are not limited to, arylthios having a monocyclic aromatic ring system, wherein the ring comprises 6 carbon atoms, referred to herein as “(C₆)arylthio.”

The term “arylsulfonyl” as used herein refers to an aryl group attached to a sulfonyl group, e.g., —S(O)₂-aryl-. Exemplary arylsulfonyl groups include, but are not limited to, arylsulfonyls having a monocyclic aromatic ring system, wherein the ring comprises 6 carbon atoms, referred to herein as “(C₆)arylsulfonyl.”

The term “carbamate” as used herein refers to the form —R_{f}OC(O)N(R_{g})—, —R_{f}OC(O)N(R_{g})Rₕ—, or —OC(O)NR_{g}Rₕ, wherein R_{f}, R_{g}, and Rₕ are each independently selected from alkyl, alkenyl, alkynyl, aryl, arylalkyl, cycloalkyl, haloalkyl, heteroaryl, heterocyclyl, and hydrogen. Exemplary carbamates include, but are not limited to, arylcarbamates or heteroaryl carbamates (e.g., wherein at least one of R_{f}, R_{g} and Rₕ are independently selected from aryl or heteroaryl, such as pyridinyl, pyridazinyl, pyrimidinyl, and pyrazinyl).

The term “carbonyl” as used herein refers to —C(O)—.

The term “carboxy” or “carboxylate” as used herein refers to Rⱼ—COOH or its corresponding carboxylate salts (e.g., Rⱼ—COONa), where Rⱼ can independently be selected from alkoxy, aryloxy, alkyl, alkenyl, alkynyl, amide, amino, aryl, arylalkyl, cycloalkyl, ether, haloalkyl, heteroaryl, and heterocyclyl. Exemplary carboxys include, but are not limited to, alkyl carboxy wherein Rⱼ is alkyl, such as —O—C(O)-alkyl. Exemplary carboxy also include aryl or heteoraryl carboxy, e.g., wherein Rⱼ is an aryl, such as phenyl and tolyl, or heteroaryl group such as pyridine, pyridazine, pyrmidine and pyrazine. The term carboxy also includes “carboxycarbonyl,” e.g., a carboxy group attached to a carbonyl group, e.g., —C(O)—COOH or salts, such as —C(O)—COONa.

The term “dicarboxylic acid” as used herein refers to a group containing at least two carboxylic acid groups such as saturated and unsaturated hydrocarbon dicarboxylic acids and salts thereof. Exemplary dicarboxylic acids include alkyl dicarboxylic acids. Dicarboxylic acids include, but are not limited to succinic acid, glutaric acid, adipic acid, suberic acid, sebacic acid, azelaic acid, maleic acid, phthalic acid, aspartic acid, glutamic acid, malonic acid, fumaric acid, (+)/(−)-malic acid, (+)/(−) tartaric acid, isophthalic acid, and terephthalic acid. Dicarboxylic acids further include carboxylic acid derivatives thereof, such as anhydrides, imides, hydrazides (for example, succinic anhydride and succinimide).

The term “cyano” as used herein refers to —CN.

The term “ester” refers to the structure —C(O)O—, —C(O)O—Rᵢ—, —RⱼC(O)O—Rᵢ—, or —RⱼC(O)O—, where O is not bound to hydrogen, and Rᵢ and Rⱼ can independently be selected from alkoxy, aryloxy, alkyl, alkenyl, alkynyl, amide, amino, aryl, arylalkyl, cycloalkyl, ether, haloalkyl, heteroaryl, and heterocyclyl. Rᵢ can be a hydrogen, but Rⱼ cannot be hydrogen. The ester may be cyclic, for example the carbon atom and Rⱼ, the oxygen atom and Rᵢ, or Rᵢ and Rⱼ may be joined to form a 3- to 12-membered ring. Exemplary esters include, but are not limited to, alkyl esters wherein at least one of Rᵢ or Rⱼ is alkyl, such as —O—C(O)-alkyl, —C(O)—O-alkyl, and -alkyl-C(O)—O-alkyl-. Exemplary esters also include aryl or heteoraryl esters, e.g., wherein at least one of Rᵢ or Rⱼ is an aryl group, such as phenyl or tolyl, or a heteroaryl group, such as pyridine, pyridazine, pyrmidine, or pyrazine, such as a nicotinate ester. Exemplary esters also include reverse esters having the structure —RⱼC(O)O—, where the oxygen is bound to the parent molecule. Exemplary reverse esters include succinate, D-argininate, L-argininate, L-lysinate, and D-lysinate. Esters also include carboxylic acid anhydrides and acid halides.

The term “ether” refers to the structure —RₖO—Rₗ—, where Rₖ and Rₗ can independently be alkyl, alkenyl, alkynyl, aryl, cycloalkyl, heterocyclyl, and ether. The ether can be attached to the parent molecular group through Rₖ or Rₗ. Exemplary ethers include, but are not limited to, alkoxyalkyl and alkoxyaryl groups. Ethers also includes polyethers, e.g., where one or both of Rₖ and Rₗ are ethers.

The terms “halo” or “halogen” or “hal” as used herein refer to F, Cl, Br, or I.

The term “haloalkyl” as used herein refers to an alkyl group substituted with one or more halogen atoms. “Haloalkyls” also encompass alkenyl or alkynyl groups substituted with one or more halogen atoms.

The terms “hydroxy” and “hydroxyl” as used herein refers to —OH.

The term “hydroxyalkyl” as used herein refers to a hydroxy attached to an alkyl group.

The term “hydroxyaryl” as used herein refers to a hydroxy attached to an aryl group.

The term “ketone” as used herein refers to the structure —C(O)—Rₘ (such as acetyl, —C(O)CH₃) or —Rₘ—C(O)—Rₙ—. The ketone can be attached to another group through Rₘ or Rₙ. Rₘ or Rₙ can be alkyl, alkenyl, alkynyl, cycloalkyl, heterocyclyl or aryl, or Rₘ or Rₙ can be joined to form, for example, a 3- to 12-membered ring.

The term “monoester” as used herein refers to an analogue of a dicarboxylic acid wherein one of the carboxylic acids is functionalized as an ester and the other carboxylic acid is a free carboxylic acid or salt of a carboxylic acid. Examples of monoesters include, but are not limited to, to monoesters of succinic acid, glutaric acid, adipic acid, suberic acid, sebacic acid, azelaic acid, oxalic and maleic acid.

The term “nitro” as used herein refers to —NO₂.

The term “nitrate” as used herein refers to NO₃⁻.

The term “perfluoroalkyl” as used herein refers to an alkyl group in which all of the hydrogen atoms have been replaced by fluorine atoms. Exemplary perfluoroalkyl groups include, but are not limited to, C₁-C₅ perfluoroalkyl, such as trifluoromethyl.

The term “perfluorocycloalkyl” as used herein refers to a cycloalkyl group in which all of the hydrogen atoms have been replaced by fluorine atoms.

The term “perfluoroalkoxy” as used herein refers to an alkoxy group in which all of the hydrogen atoms have been replaced by fluorine atoms.

The term “phosphate” as used herein refers to the structure —OP(O)O₂²⁻, —RₒOP(O)O₂²⁻, —OP(O)(OR_{q})O⁻, or —RₒOP(O)(ORₚ)O⁻, wherein Rₒ, Rₚ and R_{q} each independently can be alkyl, alkenyl, alkynyl, aryl, cycloalkyl, heterocyclyl, or hydrogen.

The term “sulfide” as used herein refers to the structure —R_{q}S—, where R_{q} can be alkyl, alkenyl, alkynyl, aryl, arylalkyl, cycloalkyl, haloalkyl, heteroaryl, heterocyclyl. The sulfide may be cyclic, for example, forming a 3 to 12-membered ring. The term “alkylsulfide” as used herein refers to an alkyl group attached to a sulfur atom.

The term “sulfinyl” as used herein refers to the structure —S(O)O—, —RᵣS(O)O—, —RᵣS(O)ORₛ—, or —S(O)ORₛ, wherein Rᵣ and Rₛ can be alkyl, alkenyl, aryl, arylalkyl, cycloalkyl, haloalkyl, heteroaryl, heterocyclyl, hydroxyl. Exemplary sulfinyl groups include, but are not limited to, alkylsulfinyls wherein at least one of Rᵣ or Rₛ is alkyl, alkenyl, or alkynyl.

The term “sulfonamide” as used herein refers to the structure —(Rₜ)—N—S(O)₂—Rᵥ—or —Rₜ(Rᵤ)N—S(O)₂—Rᵥ, where Rₜ, Rᵤ, and Rᵥ can be, for example, hydrogen, alkyl, alkenyl, alkynyl, aryl, cycloalkyl, and heterocyclyl. Exemplary sulfonamides include alkylsulfonamides (e.g., where Rᵥ is alkyl), arylsulfonamides (e.g., where Rᵥ is aryl), cycloalkyl sulfonamides (e.g., where Rᵥ is cycloalkyl), and heterocyclyl sulfonamides (e.g., where Rᵥ is heterocyclyl).

The term “sulfonate” as used herein refers to a salt or ester of a sulfonic acid. The term “sulfonic acid” refers to R_{w}SO₃H, where R_{w} is alkyl, alkenyl, alkynyl, aryl, cycloalkyl, or heterocyclyl (e.g., alkylsulfonyl). The term “sulfonyl” as used herein refers to the structure RₓSO₂—, where Rₓ, can be alkyl, alkenyl, alkynyl, aryl, cycloalkyl, and heterocyclyl (e.g., alkylsulfonyl). The term “alkylsulfonyl” as used herein refers to an alkyl group attached to a sulfonyl group. “Alkylsulfonyl” groups can optionally contain alkenyl or alkynyl groups. In various embodiments, the sulfonate refers to R_{w}SO₃⁻, where R_{w} is alkyl, alkenyl, alkynyl, aryl, cycloalkyl, or heterocyclyl.

The term “sulfonate” as used herein refers R_{w}SO₃⁻, where R_{w} is alkyl, alkenyl, alkynyl, cycloalkyl, aryl, heterocyclyl, hydroxyl, alkoxy, aroxy, or aralkoxy, where each of the alkyl, alkenyl, alkynyl, cycloalkyl, aryl, heteroaryl, alkoxy, aroxy, or aralkoxy optionally is substituted. Non-limiting examples include triflate (also known as trifluoromethanesulfonate, CF₃SO₃), benzenesulfonate, tosylate (also known as toluenesulfonate), and the like.

The term “thioketone” refers to the structure —R_{y}—C(S)—R_{z}—. The ketone can be attached to another group through R_{y} or R_{z}. R_{y} or R_{z} can be alkyl, alkenyl, alkynyl, cycloalkyl, heterocyclyl or aryl, or R_{y} or R_{z} can be joined to form a ring, for example, a 3- to 12-membered ring.

Each of the above groups may be optionally substituted. As used herein, the term “substituted” is contemplated to include all permissible substituents of organic compounds, “permissible” being in the context of the chemical rules of valence known to those of ordinary skill in the art. It will be understood that “substituted” also includes that the substitution results in a stable compound, e.g., which does not spontaneously undergo transformation such as by rearrangement, cyclization, elimination, etc. In some cases, “substituted” may generally refer to replacement of a hydrogen with a substituent as described herein. However, “substituted,” as used herein, does not encompass replacement and/or alteration of a functional group by which a molecule is identified, e.g., such that the “substituted” functional group becomes, through substitution, a different functional group. For example, a “substituted phenyl group” must still comprise the phenyl moiety and cannot be modified by substitution, in this definition, to become, e.g., a pyridine ring.

In a broad aspect, the permissible substituents include acyclic and cyclic, branched and unbranched, carbocyclic and heterocyclic, aromatic and nonaromatic substituents of organic compounds. Illustrative substituents include, for example, those described herein. The permissible substituents can be one or more and the same or different for appropriate organic compounds. For purposes of the present teachings, the heteroatoms such as nitrogen may have hydrogen substituents and/or any permissible substituents of organic compounds described herein which satisfy the valencies of the heteroatoms.

In various embodiments, the substituent is selected from alkoxy, aryloxy, alkyl, alkenyl, alkynyl, amide, amino, aryl, arylalkyl, carbamate, carboxy, cyano, cycloalkyl, ester, ether, formyl, halogen, haloalkyl, heteroaryl, heterocyclyl, hydroxyl, ketone, nitro, phosphate, sulfide, sulfinyl, sulfonyl, sulfonic acid, sulfonamide, and thioketone, each of which optionally is substituted with one or more suitable substituents. In some embodiments, the substituent is selected from alkoxy, aryloxy, alkyl, alkenyl, alkynyl, amide, amino, aryl, arylalkyl, carbamate, carboxy, cycloalkyl, ester, ether, formyl, haloalkyl, heteroaryl, heterocyclyl, ketone, phosphate, sulfide, sulfinyl, sulfonyl, sulfonic acid, sulfonamide, and thioketone, wherein each of the alkoxy, aryloxy, alkyl, alkenyl, alkynyl, amide, amino, aryl, arylalkyl, carbamate, carboxy, cycloalkyl, ester, ether, formyl, haloalkyl, heteroaryl, heterocyclyl, ketone, phosphate, sulfide, sulfinyl, sulfonyl, sulfonic acid, sulfonamide, and thioketone can be further substituted with one or more suitable substituents.

Examples of substituents include, but are not limited to, halogen, azide, alkyl, aralkyl, alkenyl, alkynyl, cycloalkyl, hydroxyl, alkoxyl, amino, nitro, sulfhydryl, imino, amido, phosphonate, phosphinate, carbonyl, carboxyl, silyl, ether, alkylthio, sulfonyl, sulfonamido, ketone, aldehyde, thioketone, ester, heterocyclyl, —CN, aryl, aryloxy, perhaloalkoxy, aralkoxy, heteroaryl, heteroaryloxy, heteroarylalkyl, heteroaralkoxy, azido, alkylthio, oxo, acylalkyl, carboxy esters, carboxamido, acyloxy, aminoalkyl, alkylaminoaryl, alkylaryl, alkylaminoalkyl, alkoxyaryl, arylamino, aralkylamino, alkylsulfonyl, carboxamidoalkylaryl, carboxamidoaryl, hydroxyalkyl, haloalkyl, alkylaminoalkylcarboxy, aminocarboxamidoalkyl, cyano, alkoxyalkyl, perhaloalkyl, arylalkyloxyalkyl, and the like. In some embodiments, the substituent is selected from cyano, halogen, hydroxyl, and nitro.

As a non-limiting example, in various embodiments when one of the Rₐ, R_{b}, and R_{b′} in NRₐR_{b}R_{b′}, referred to herein as an amine or amino, is selected from alkyl, alkenyl, alkynyl, cycloalkyl, and heterocyclyl, each of the alkyl, alkenyl, alkynyl, cycloalkyl, and heterocyclyl independently can be optionally substituted with one or more substituents each independently selected from alkoxy, aryloxy, alkyl, alkenyl, alkynyl, amide, amino, aryl, arylalkyl, carbamate, carboxy, cycloalkyl, ester, ether, formyl, haloalkyl, heteroaryl, heterocyclyl, ketone, phosphate, sulfide, sulfinyl, sulfonyl, sulfonic acid, sulfonamide, and thioketone, wherein each of the alkoxy, aryloxy, alkyl, alkenyl, alkynyl, amide, amino, aryl, arylalkyl, carbamate, carboxy, cycloalkyl, ester, ether, formyl, haloalkyl, heteroaryl, heterocyclyl, ketone, phosphate, sulfide, sulfinyl, sulfonyl, sulfonic acid, sulfonamide, and thioketone can be further substituted with one or more suitable substituents. In some embodiments when the amine is an alkyl amine or a cycloalkylamine, the alkyl or the cycloalkyl can be substituted with one or more substituents each independently selected from alkoxy, aryloxy, alkyl, alkenyl, alkynyl, amide, amino, aryl, arylalkyl, carbamate, carboxy, cyano, cycloalkyl, ester, ether, formyl, halogen, haloalkyl, heteroaryl, heterocyclyl, hydroxyl, ketone, nitro, phosphate, sulfide, sulfinyl, sulfonyl, sulfonic acid, sulfonamide, and thioketone. In certain embodiments when the amine is an alkyl amine or a cycloalkylamine, the alkyl or the cycloalkyl can be substituted with one or more substituents each independently selected from amino, carboxy, cyano, and hydroxyl. For example, the alkyl or the cycloalkyl in the alkyl amine or the cycloalkylamine is substituted with an amino group, forming a diamine.

As used herein, a “suitable substituent” refers to a group that does not nullify the synthetic or pharmaceutical utility of the compounds of the invention or the intermediates useful for preparing them. Examples of suitable substituents include, but are not limited to: (C₁-C₂₂), (C₁-C₈), (C₁-C₆), or (C₁-C₄) alkyl, alkenyl or alkynyl; (C₆-C₂₂), (C₆-C₁₈), (C₆-C₁₄), or (C₆-C₁₀) aryl; (C₂-C₂₁), (C₂-C₁₇), (C₂-C₁₃), or (C₂-C₉) heteroaryl; (C₃-C₂₂), (C₃-C₁₂), or (C₃-C₈) cycloalkyl; (C₁-C₂₂), (C₁-C₈), (C₁-C₆), or (C₁-C₄) alkoxy; (C₆-C₂₂), (C₆-C₁₈), (C₆-C₁₄), or (C₆-C₁₀) aryloxy; —CN; —OH; oxo; halo, carboxy; amino, such as —NH((C₁-C₂₂), (C₁-C₈), (C₁-C₆) or (C₁-C₄) alkyl), —N((C₁-C₂₂), (C₁-C₈), (C₁-C₆), or (C₁-C₄) alkyl)₂, —NH((C₆)aryl), or —N((C₆-C₁₀) aryl)₂; formyl; ketones, such as CO((C₁-C₂₂), (C₁-C₈), (C₁-C₆), or (C₁-C₄) alkyl), —CO((C₆-C₁₀) aryl) esters, such as —CO₂((C₁-C₂₂), (C₁-C₈), (C₁-C₆), or (C₁-C₄) alkyl) and —CO₂((C₆-C₁₀) aryl). One of skill in art can readily choose a suitable substituent based on the stability and pharmacological and synthetic activity of the compound of the invention.

Unless otherwise specified, the chemical groups include their corresponding monovalent, divalent, trivalent, and tetravalent groups. For example, methyl include monovalent methyl (—CH₃), divalent methyl (—CH₂—, methylyl), and trivalent methyl

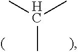

and tetravalent methyl

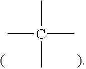

Unless otherwise specified, all numbers expressing quantities of ingredients, reaction conditions, and other properties or parameters used in the specification and claims are to be understood as being modified in all instances by the term “about.” Accordingly, unless otherwise indicated, it should be understood that the numerical parameters set forth in the following specification and attached claims are approximations. At the very least, and not as an attempt to limit the application of the doctrine of equivalents to the scope of the claims, numerical parameters should be read in light of the number of reported significant digits and the application of ordinary rounding techniques.

All numerical ranges herein include all numerical values and ranges of all numerical values within the recited range of numerical values. As a non-limiting example, (C₁-C₆) alkyls also include any one of C₁, C₂, C₃, C₄, C₅, C₆, (C₁-C₂), (C₁-C₃), (C₁-C₄), (C₁-C₅), (C₂-C₃), (C₂-C₄), (C₂-C₅), (C₂-C₆), (C₃-C₄), (C₃-C₅), (C₃-C₆), (C₄-C₅), (C₄-C₆), and (C₅-C₆) alkyls.

Further, while the numerical ranges and parameters setting forth the broad scope of the disclosure are approximations as discussed above, the numerical values set forth in the Examples section are reported as precisely as possible. It should be understood, however, that such numerical values inherently contain certain errors resulting from the measurement equipment and/or measurement technique.

A “polymer,” as used herein, is given its ordinary meaning as used in the art, i.e., a molecular structure comprising one or more repeating units (monomers), connected by covalent bonds. The repeating units may all be identical, or in some cases, there may be more than one type of repeating unit present within the polymer.

If more than one type of repeating unit is present within the polymer, then the polymer is said to be a “copolymer.” It is to be understood that in any embodiment employing a polymer, the polymer being employed may be a copolymer in some cases. The repeating units forming the copolymer may be arranged in any fashion. For example, the repeating units may be arranged in a random order, in an alternating order, or as a “block” copolymer, i.e., comprising one or more regions each comprising a first repeating unit (e.g., a first block), and one or more regions each comprising a second repeating unit (e.g., a second block), etc. Block copolymers may have two (a diblock copolymer), three (a triblock copolymer), or more numbers of distinct blocks.

The term “hydrophilic,” as used herein, generally describes the property of attracting water and the term “hydrophobic,” as used herein, generally describes the property of repelling water. Thus, a hydrophilic compound (e.g., small molecule or polymer) is one generally that attracts water and a hydrophobic compound (e.g., small molecule or polymer) is one that generally repels water. A hydrophilic or a hydrophobic compound can be identified, for example, by preparing a sample of the compound and measuring its contact angle with water. In some cases, the hydrophilicity of two or more compounds may be measured relative to each other, i.e., a first compound may be more hydrophilic than a second compound.

E. Terms Related to Pharmaceutics

The term “pharmaceutically acceptable counter ion” refers to a pharmaceutically acceptable anion or cation. In various embodiments, the pharmaceutical acceptable counter ion is a pharmaceutical acceptable ion. For example, the pharmaceutical acceptable counter ion is selected from citrate, matate, acetate, oxalate, chloride, bromide, iodide, nitrate, sulfate, bisulfate, phosphate, acid phosphate, isonicotinate, acetate, lactate, salicylate, tartrate, oleate, tannate, pantothenate, bitartrate, ascorbate, succinate, maleate, gentisinate, fumarate, gluconate, glucaronate, saccharate, formate, benzoate, glutamate, methanesulfonate, ethanesulfonate, benzenesulfonate, p-toluenesulfonate and pamoate (i.e., 1,1′-methylene-bis-(2-hydroxy-3-naphthoate)). In some embodiments, the pharmaceutical acceptable counter ion is selected from chloride, bromide, iodide, nitrate, sulfate, bisulfate, phosphate, acid phosphate, citrate, matate, acetate, oxalate, acetate, lactate, stearate and sodium bis(2-ethylhexyl) sulfosuccinate. In particular embodiments, the pharmaceutical acceptable counter ion is selected from chloride, bromide, iodide, nitrate, sulfate, bisulfate, and phosphate.

The term “pharmaceutically acceptable salt(s)” refers to salts of acidic or basic groups that may be present in compounds used in the present compositions. Compounds included in the present compositions that are basic in nature are capable of forming a wide variety of salts with various inorganic and organic acids. The acids that may be used to prepare pharmaceutically acceptable acid addition salts of such basic compounds are those that form non-toxic acid addition salts, i.e., salts containing pharmacologically acceptable anions, including but not limited to sulfate, citrate, matate, acetate, oxalate, chloride, bromide, iodide, nitrate, sulfate, bisulfate, phosphate, acid phosphate, isonicotinate, acetate, lactate, salicylate, citrate, tartrate, oleate, tannate, pantothenate, bitartrate, ascorbate, succinate, maleate, gentisinate, fumarate, gluconate, glucaronate, saccharate, formate, benzoate, glutamate, methanesulfonate, ethanesulfonate, benzenesulfonate, p-toluenesulfonate and pamoate (i.e., 1,1′-methylene-bis-(2-hydroxy-3-naphthoate)) salts. Compounds included in the present compositions that include an amino moiety may form pharmaceutically acceptable salts with various amino acids, in addition to the acids mentioned above. Compounds included in the present compositions, that are acidic in nature are capable of forming base salts with various pharmacologically acceptable cations. Examples of such salts include alkali metal or alkaline earth metal salts and, particularly, calcium, magnesium, sodium, lithium, zinc, potassium, and iron salts.

In addition, if the compounds described herein are obtained as an acid addition salt, the free base can be obtained by basifying a solution of the acid salt. Conversely, if the product is a free base, an addition salt, particularly a pharmaceutically acceptable addition salt, may be produced by dissolving the free base in a suitable organic solvent and treating the solution with an acid, in accordance with conventional procedures for preparing acid addition salts from base compounds. Those skilled in the art will recognize various synthetic methodologies that may be used to prepare non-toxic pharmaceutically acceptable addition salts.

A pharmaceutically acceptable salt can be derived from an acid selected from 1-hydroxy-2-naphthoic acid, 2,2-dichloroacetic acid, 2-hydroxyethanesulfonic acid, 2-oxoglutaric acid, 4-acetamidobenzoic acid, 4-aminosalicylic acid, acetic acid, adipic acid, ascorbic acid, aspartic acid, benzenesulfonic acid, benzoic acid, camphoric acid, camphor-10-sulfonic acid, capric acid (decanoic acid), caproic acid (hexanoic acid), caprylic acid (octanoic acid), carbonic acid, cinnamic acid, citric acid, cyclamic acid, dodecylsulfuric acid, ethane-1,2-disulfonic acid, ethanesulfonic acid, formic acid, fumaric acid, galactaric acid, gentisic acid, glucoheptonic acid, gluconic acid, glucuronic acid, glutamic acid, glutaric acid, glycerophosphoric acid, glycolic acid, hippuric acid, hydrobromic acid, hydrochloric acid, isethionic, isobutyric acid, lactic acid, lactobionic acid, lauric acid, maleic acid, malic acid, malonic acid, mandelic acid, methanesulfonic acid, mucic, naphthalene-1,5-disulfonic acid, naphthalene-2-sulfonic acid, nicotinic acid, nitric acid, oleic acid, oxalic acid, palmitic acid, pamoic acid, pantothenic, phosphoric acid, proprionic acid, pyroglutamic acid, salicylic acid, sebacic acid, stearic acid, succinic acid, sulfuric acid, tartaric acid, thiocyanic acid, toluenesulfonic acid, trifluoroacetic, and undecylenic acid.

The term “bioavailable” is art-recognized and refers to a form of the subject invention that allows for it, or a portion of the amount administered, to be absorbed by, incorporated to, or otherwise physiologically available to a subject or patient to whom it is administered.

The term “pharmaceutically acceptable carrier” is art-recognized and refers to a pharmaceutically-acceptable material, composition or vehicle, such as a liquid or solid filler, diluent, excipient, solvent or encapsulating material, involved in carrying or transporting any supplement or composition, or component thereof, from one organ, or portion of the body, to another organ, or portion of the body. Each carrier must be “acceptable” in the sense of being compatible with the other ingredients of the formulation and not injurious to the patient.

### II. PLATINUM COMPOUNDS

In general, the compounds disclosed herein may be prepared by the methods illustrated in the general reaction scheme described below, or by modifications thereof, using readily available starting materials, reagents and conventional synthesis procedures. In these reactions, it is also possible to make use of variants which are in themselves known, but are not mentioned here.

The generic scheme for the synthesis of platinum compounds is described below as Scheme I:

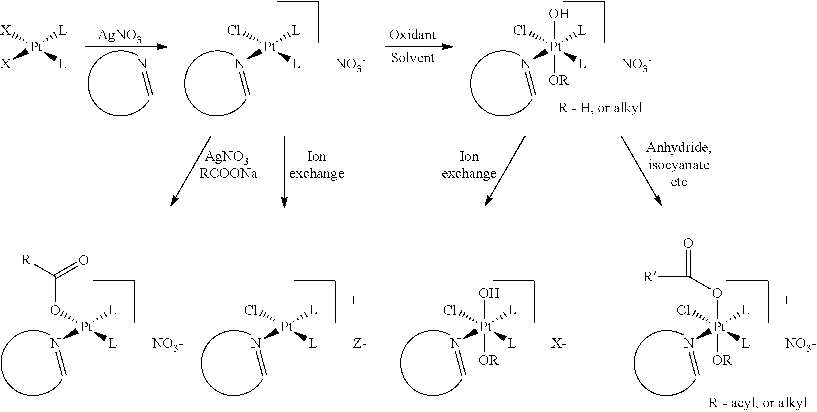

In various embodiments, the compounds of the present teachings include platinum compounds each having at least one heterocycle ligand. For example, the compound of the present teachings has Formula I:

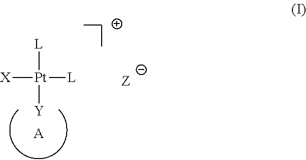

wherein:
X is a halide, carboxylate, sulfonate, sulfate, or phosphate;
L each is independently ammonia or an amine;
Y is selected from N, P, and S;
A together with Y form a heteroaromatic optionally substituted with one or more substituents each independently selected from halogen, cyano, nitro, hydroxyl, ester, ether, alkoxy, aryloxy, amino, amide, carbamate, alkyl, alkenyl, alkynyl, aryl, arylalkyl, cycloalkyl, heteroaryl, heterocyclyl, phosphono, phosphate, sulfide, sulfinyl, sulfino, sulfonyl, sulfo, and sulfonamide, wherein each of the ester, ether, alkoxy, aryloxy, amino, amide, carbamate, alkyl, alkenyl, alkynyl, aryl, arylalkyl, cycloalkyl, heteroaryl, heterocyclyl, phosphono, phosphate, sulfide, sulfinyl, sulfino, sulfonyl, sulfo, and sulfonamide is optionally substituted with one or more suitable substituents; and
Z is a pharmaceutically acceptable counter ion.

In some embodiments, two of the adjacent X and Ls form a bidentate ligand, or two Ls form a bidentate ligand, or X and two Ls form a tridentate, or A, together with Y, and X form a bidentate ligand.

In some embodiments, the compound is not cis-[Pt(NH₃)₂ (phenanthridine)Cl]NO₃.

In some embodiments, X is a halogen. In some embodiments, X is Cl.

In some embodiments, X is —O(C═O)R^{a}, and R^{a} is hydrogen, alkyl, aryl, arylalkyl, or cycloalkyl, wherein each of the alkyl, aryl, arylalkyl, and cycloalkyl is optionally substituted with one or more suitable substituents. In some embodiments, X is formyl, acetate, propionate, butyrate, or benzoate, wherein each of the acetate, propionate, butyrate, and benzoate optionally is substituted with one or more suitable substituents (e.g., halogen, hydroxyl, alkoxy, aroxyl, ester, amino, alkyl, aryl, cycloalkyl, heteroaryl, or cycloheteroalkyl). For example, X is acetate or 4-cyclohexylbutyrate. In some embodiments, X is a sulfonate, phosphate, or sulfate. For example, X can be tosylate.

In some embodiments, L each is ammonia. In some embodiments, at least one L is an amine. In some embodiments, Y is N. In some embodiments, the heteroaromatic is selected from a monocyclic heteroaromatic, a bicyclic heteroaromatic, or a tricyclic heteroaromatic.

In various embodiments, the present teachings provide a compound of Formula III or Formula IV:

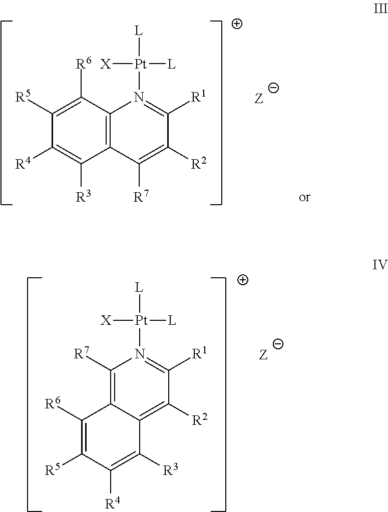

wherein R¹, R², R³, R⁴, R⁵, R⁶, and R⁷ each is independently selected from hydrogen, halogen, cyano, nitro, hydroxyl, ester, ether, alkoxy, aryloxy, amino, amide, carbamate, alkyl, alkenyl, alkynyl, aryl, arylalkyl, cycloalkyl, heteroaryl, heterocyclyl, phosphono, phosphate, sulfide, sulfinyl, sulfino, sulfonyl, sulfo, and sulfonamide, wherein each of the ester, ether, alkoxy, aryloxy, amino, amide, carbamate, alkyl, alkenyl, alkynyl, aryl, arylalkyl, cycloalkyl, heteroaryl, heterocyclyl, phosphono, phosphate, sulfide, sulfinyl, sulfino, sulfonyl, sulfo, and sulfonamide is optionally substituted with one or more suitable substituents; or optionally, two adjacent substituents selected from R¹, R², R³, R⁴, R⁵, R⁶, and R⁷ are connected to form an optionally substituted 5 or 6-membered ring; and L, X, and Z are as defined herein.

In some embodiments, R¹, R², R³, R⁴, R⁵, R⁶, and R⁷ each is independently selected from hydrogen, halogen, and aryl.

In some embodiments, the compound has Formula IIIa:

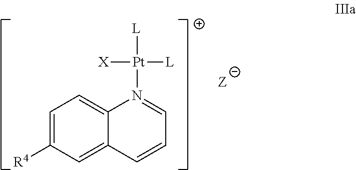

wherein R⁴ is selected from hydrogen, halogen, cyano, nitro, hydroxyl, ester, ether, alkoxy, aryloxy, amino, amide, carbamate, alkyl, alkenyl, alkynyl, aryl, arylalkyl, cycloalkyl, heteroaryl, heterocyclyl, phosphono, phosphate, sulfide, sulfinyl, sulfino, sulfonyl, sulfo, and sulfonamide, wherein each of the ester, ether, alkoxy, aryloxy, amino, amide, carbamate, alkyl, alkenyl, alkynyl, aryl, arylalkyl, cycloalkyl, heteroaryl, heterocyclyl, phosphono, phosphate, sulfide, sulfinyl, sulfino, sulfonyl, sulfo, and sulfonamide is optionally substituted with one or more suitable substituents; and
L, X, and Z are as defined herein.

In some embodiments, R⁴ is halogen or aryl.

In some embodiments, the compound has Formula Mb:

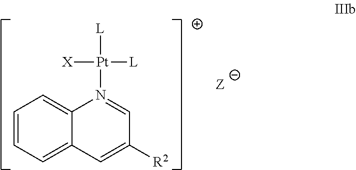

wherein R² is selected from hydrogen, halogen, cyano, nitro, hydroxyl, ester, ether, alkoxy, aryloxy, amino, amide, carbamate, alkyl, alkenyl, alkynyl, aryl, arylalkyl, cycloalkyl, heteroaryl, heterocyclyl, phosphono, phosphate, sulfide, sulfinyl, sulfino, sulfonyl, sulfo, and sulfonamide, wherein each of the ester, ether, alkoxy, aryloxy, amino, amide, carbamate, alkyl, alkenyl, alkynyl, aryl, arylalkyl, cycloalkyl, heteroaryl, heterocyclyl, phosphono, phosphate, sulfide, sulfinyl, sulfino, sulfonyl, sulfo, and sulfonamide is optionally substituted with one or more suitable substituents; and
L, X, and Z are as defined herein.

In some embodiments, R² is halogen or aryl.

In some embodiments, the compound has Formula IIIc:

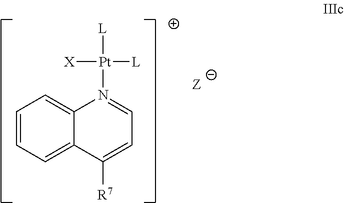

wherein R⁷ is selected from hydrogen, halogen, cyano, nitro, hydroxyl, ester, ether, alkoxy, aryloxy, amino, amide, carbamate, alkyl, alkenyl, alkynyl, aryl, arylalkyl, cycloalkyl, heteroaryl, heterocyclyl, phosphono, phosphate, sulfide, sulfinyl, sulfino, sulfonyl, sulfo, and sulfonamide, wherein each of the ester, ether, alkoxy, aryloxy, amino, amide, carbamate, alkyl, alkenyl, alkynyl, aryl, arylalkyl, cycloalkyl, heteroaryl, heterocyclyl, phosphono, phosphate, sulfide, sulfinyl, sulfino, sulfonyl, sulfo, and sulfonamide is optionally substituted with one or more suitable substituents; and
L, X, and Z are as defined herein.

In some embodiments, R⁷ is halogen or aryl.

In some embodiments, the compound has Formula IIId:

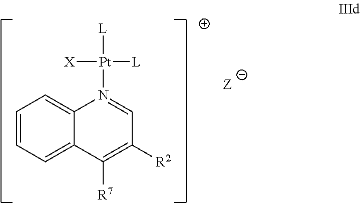

wherein R² and R⁷ are connected to form an optionally substituted 5 or 6-membered ring selected from cycloalkyl, aryl, heteroaryl, and heterocyclyl, wherein each of the cycloalkyl, aryl, heteroaryl, and heterocyclyl is optionally substituted with one or more suitable substituents; and
L, X, and Z are as defined herein.

In some embodiments, R² and R⁷ are connected to form an optionally substituted cycloalkyl.

In some embodiments, the compound has Formula IVa:

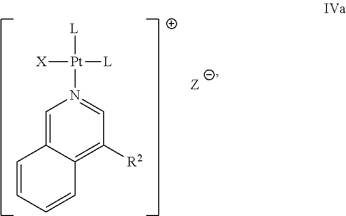

wherein R² is selected from hydrogen, halogen, cyano, nitro, hydroxyl, ester, ether, alkoxy, aryloxy, amino, amide, carbamate, alkyl, alkenyl, alkynyl, aryl, arylalkyl, cycloalkyl, heteroaryl, heterocyclyl, phosphono, phosphate, sulfide, sulfinyl, sulfino, sulfonyl, sulfo, and sulfonamide, wherein each of the ester, ether, alkoxy, aryloxy, amino, amide, carbamate, alkyl, alkenyl, alkynyl, aryl, arylalkyl, cycloalkyl, heteroaryl, heterocyclyl, phosphono, phosphate, sulfide, sulfinyl, sulfino, sulfonyl, sulfo, and sulfonamide is optionally substituted with one or more suitable substituents; and
L, X, and Z are as defined herein.

In some embodiments, R² is halogen or aryl.

In some embodiments, the compound has Formula IVb:

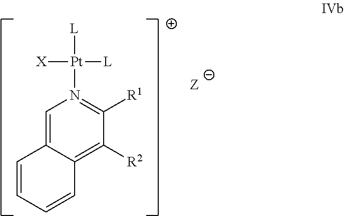

wherein R¹ and R² are connected to form an optionally substituted 5 or 6-membered ring selected from cycloalkyl, aryl, heteroaryl, and heterocyclyl, wherein each of the cycloalkyl, aryl, heteroaryl, and heterocyclyl is optionally substituted with one or more suitable substituents; and
L, X, and Z are as defined herein.

In some embodiments, R¹ and R² are connected to form an optionally substituted cycloalkyl. For example, R¹ and R² can be connected to form cyclohexyl.

In some embodiments, the compound has Formula V:

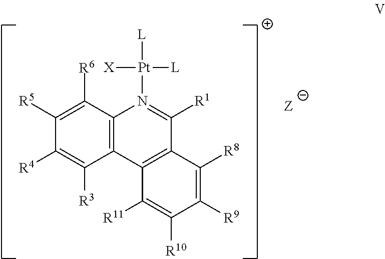

wherein R¹, R³, R⁴, R⁵, R⁶, R⁸, R⁹, R¹⁰, and R¹¹ each is independently selected from hydrogen, halogen, cyano, nitro, hydroxyl, ester, ether, alkoxy, aryloxy, amino, amide, carbamate, alkyl, alkenyl, alkynyl, aryl, arylalkyl, cycloalkyl, heteroaryl, heterocyclyl, phosphono, phosphate, sulfide, sulfinyl, sulfino, sulfonyl, sulfo, and sulfonamide, wherein each of the ester, ether, alkoxy, aryloxy, amino, amide, carbamate, alkyl, alkenyl, alkynyl, aryl, arylalkyl, cycloalkyl, heteroaryl, heterocyclyl, phosphono, phosphate, sulfide, sulfinyl, sulfino, sulfonyl, sulfo, and sulfonamide is optionally substituted with one or more suitable substituents; or optionally, two adjacent substituents selected from R¹, R³, R⁴, R⁵, R⁶, R⁸, R⁹, R¹⁰, and R¹¹ are connected to form an optionally substituted 5 or 6-membered ring; and
L, X, and Z are as defined herein

In some embodiments, R¹, R³, R⁴, R⁵, R⁶, R⁸, R⁹, R¹⁰ and R¹¹ each is independently selected from hydrogen, halogen, cyano, nitro, hydroxyl, ester, ether, alkoxy, aryloxy, amino, amide, alkyl, aryl, cycloalkyl, and heteroaryl, wherein each of the ester, ether, alkoxy, aryloxy, amino, amide, alkyl, aryl, cycloalkyl, and heteroaryl is optionally substituted with one or more suitable substituents. For example, R¹, R³, R⁴, R⁵, R⁶, R⁸, R⁹, R¹⁰, and R¹¹ each can be hydrogen, halogen, hydroxyl, alkoxy, amino, alkyl, or aryl, wherein each of the alkoxy, amino, alkyl, and aryl optionally is substituted with one or more suitable substituents.

In certain embodiments, R¹, R³, R⁵, R⁶, R⁸, and R¹¹ each is hydrogen, halogen, or alkyl optionally substituted with one or more suitable substituents. In other embodiments, R¹ is hydrogen, methyl, ethyl, propyl, isopropyl, or t-butyl. In some embodiments, R³ is hydrogen. In some embodiment, R⁵ is hydrogen, F, Cl, Br, methyl, ethyl, propyl, isopropyl, or t-butyl. In some embodiment, R⁸ is hydrogen, F, Cl, Br, methyl, ethyl, propyl, isopropyl, or t-butyl. In some embodiments, R⁶ is hydrogen. In some embodiments, R¹¹ is hydrogen.

In certain embodiments, R⁴ is hydrogen, halogen, hydroxyl, alkoxy, alkyl, or aryl, wherein each of alkoxy, alkyl, and aryl optionally is substituted with one or more suitable substituents. In some embodiments, R⁴ is hydrogen, F, Cl, Br, methyl, ethyl, propyl, isopropyl, t-butyl, hydroxyl, methoxy, ethoxy, propoxy, isopropoxy, t-butoxy, 2-methoxyethoxy, 2-ethoxyethoxy, —COOH, phenyl, or a substituted phenyl.

In certain embodiments, R⁹ is hydrogen, halogen, alkyl, or aryl, wherein each of alkyl and aryl optionally is substituted with one or more suitable substituents. In some embodiments, R⁹ is hydrogen, F, Cl, Br, methyl, ethyl, propyl, isopropyl, t-butyl, phenyl, or a substituted phenyl.

In certain embodiments, R¹⁰ is hydrogen, amino, alkyl, or aryl, wherein each of amino, alkyl, and aryl optionally is substituted with one or more suitable substituents. In some embodiments, R¹⁰ is hydrogen, F, Cl, Br, methylamino, ethylamino, propylamino, isopropylamino, t-butylamino, dimethylamino, diethylamino, diisopropylamino, methyl, ethyl, propyl, isopropyl, t-butyl, phenyl, or a substituted phenyl.

In some embodiments, the compound is selected from Formula VI

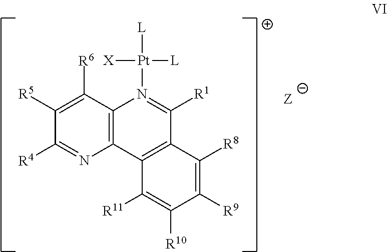

wherein R¹, R⁴, R⁵, R⁶, R⁸, R⁹, R¹⁰, and R¹¹ each is independently selected from hydrogen, halogen, cyano, nitro, hydroxyl, ester, ether, alkoxy, aryloxy, amino, amide, carbamate, alkyl, alkenyl, alkynyl, aryl, arylalkyl, cycloalkyl, heteroaryl, heterocyclyl, phosphono, phosphate, sulfide, sulfinyl, sulfino, sulfonyl, sulfo, and sulfonamide, wherein each of the ester, ether, alkoxy, aryloxy, amino, amide, carbamate, alkyl, alkenyl, alkynyl, aryl, arylalkyl, cycloalkyl, heteroaryl, heterocyclyl, phosphono, phosphate, sulfide, sulfinyl, sulfino, sulfonyl, sulfo, and sulfonamide is optionally substituted with one or more suitable substituents; or optionally, two adjacent substituents selected from R¹, R⁴, R⁵, R⁶, R⁸, R⁹, R¹⁰, and R¹¹ are connected to form an optionally substituted 5 or 6-membered ring; and L, X, and Z are as defined herein

In some embodiments, R¹, R⁴, R⁵, R⁶, R⁸, R⁹, R¹⁰, and R¹¹ are as defined herein.

In some embodiments, the compound is selected from Formula VII

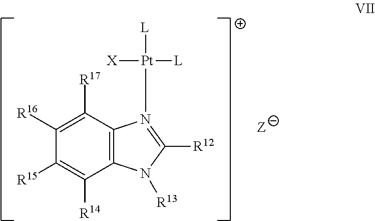

wherein R¹², R¹³, R¹⁴, R¹⁵, R¹⁶, and R¹⁷ each is independently selected from hydrogen, halogen, cyano, nitro, hydroxyl, ester, ether, alkoxy, aryloxy, amino, amide, carbamate, alkyl, alkenyl, alkynyl, aryl, arylalkyl, cycloalkyl, heteroaryl, heterocyclyl, phosphono, phosphate, sulfide, sulfinyl, sulfino, sulfonyl, sulfo, and sulfonamide, wherein each of the ester, ether, alkoxy, aryloxy, amino, amide, carbamate, alkyl, alkenyl, alkynyl, aryl, arylalkyl, cycloalkyl, heteroaryl, heterocyclyl, phosphono, phosphate, sulfide, sulfinyl, sulfino, sulfonyl, sulfo, and sulfonamide is optionally substituted with one or more suitable substituents; or optionally, two adjacent substituents selected from R¹², R¹³, R¹⁴, R¹⁵, R¹⁶, and R¹⁷ are connected to form an optionally substituted 5 or 6-membered ring; and
L, X, and Z are as defined herein.

In some embodiments, R¹², R¹³, R¹⁴, R¹⁵, R¹⁶, and R¹⁷ each is independently selected from hydrogen, halogen, alkyl, and aryl, wherein each of the alkyl and aryl is optionally substituted with one or more suitable substituents. For example, R¹², R¹³, R¹⁴, R¹⁵, R¹⁶, and R¹⁷ each can independently be hydrogen. In particular embodiments, R¹³ is selected from optionally substituted alkyl or optionally substituted aryl. For example, R¹³ can be methyl, ethyl, propyl, isopropyl, butyl, t-butyl, phenyl, or substituted phenyl.

In some embodiments, R¹² and R¹³ are connected to form an optionally substituted 5 or 6-membered ring. For example, R¹² and R¹³, along with atoms that R¹² and R¹³ are respectively connected, form

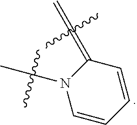 [SMILES: *N1C=CC=CC1=*]

In some embodiments, the compound is selected from:

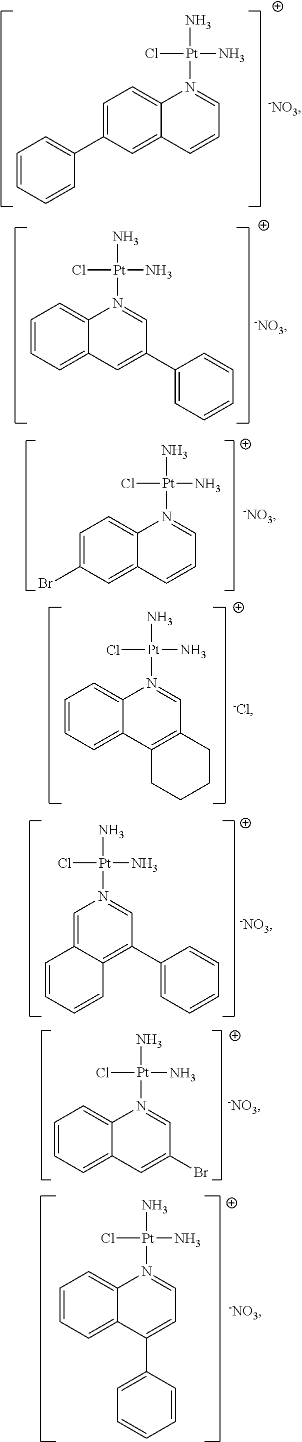

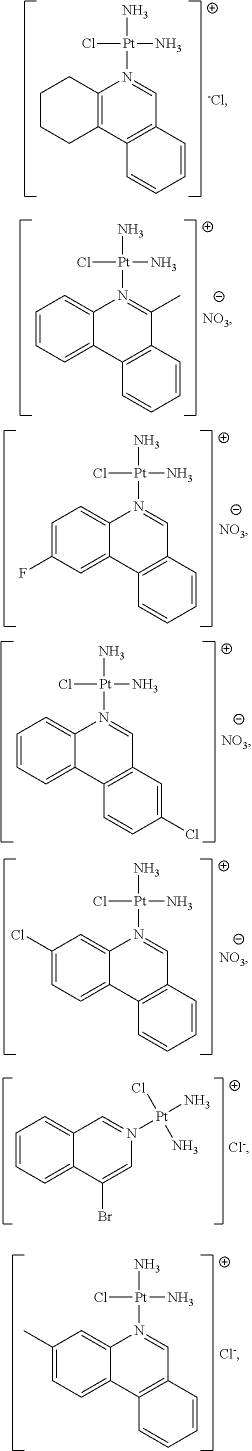

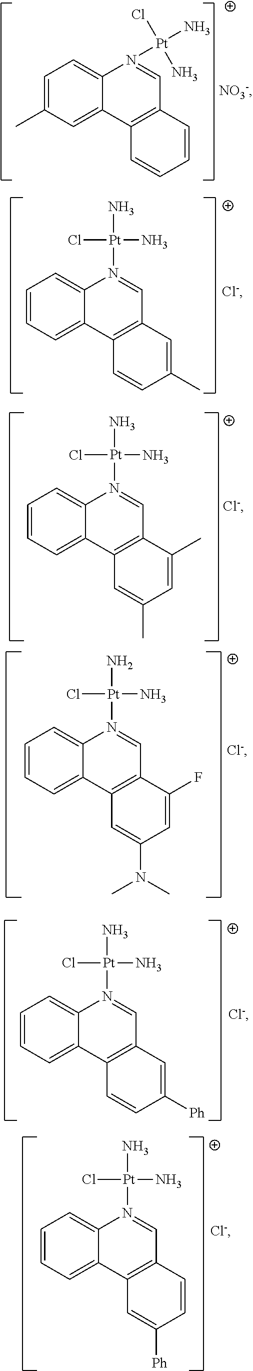

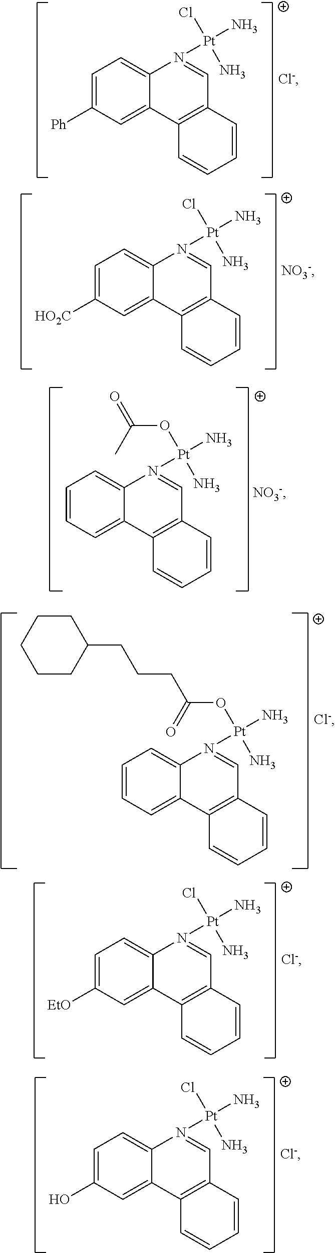

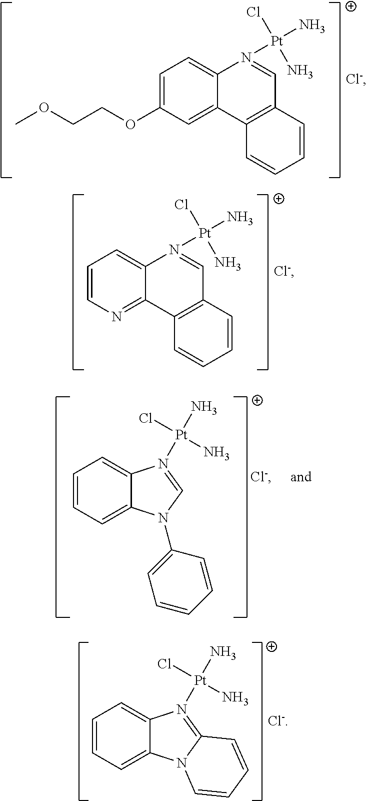

Some embodiments comprise compounds having two ligands (e.g., X and each of L) positioned in a cis configuration, i.e., the compound may be a cis isomer. However, it should be understood that compounds of the present teachings may also have two ligands (e.g., X and each of L) positioned in a trans configuration, i.e., the compound may be a trans isomer. Those of ordinary skill in the art would understand the meaning of these terms.

In some embodiments, any two ligands (e.g., X and each of L) may be joined together to form a bidentate or tridentate ligand, respectively. As will be known to those of ordinary skill in the art, a bidentate ligand, as used herein, when bound to a metal center, forms a metallacycle structure with the metal center, also known as a chelate ring. Bidentate ligands suitable for use in the present teachings include species that have at least two sites capable of binding to a metal center. For example, the bidentate ligand may comprise at least two heteroatoms that coordinate the metal center, or a heteroatom and an anionic carbon atom that coordinate the metal center. Examples of bidentate ligands suitable for use in the present teachings include, but are not limited to, alkyl and aryl derivatives of moieties such as amines, phosphines, phosphites, phosphates, imines, oximes, ethers, alcohols, thiolates, thioethers, hybrids thereof, substituted derivatives thereof, aryl groups (e.g., bis-aryl, heteroaryl-substituted aryl), heteroaryl groups, and the like. Specific examples of bidentate ligands include ethylenediamine, 2,2′-bipyridine, acetylacetonate, oxalate, and the like. Other non-limiting examples of bidentate ligands include diimines, pyridylimines, diamines, imineamines, iminethioether, iminephosphines, bisoxazoline, bisphosphineimines, diphosphines, phosphineamine, salen and other alkoxy imine ligands, amidoamines, imidothioether fragments and alkoxyamide fragments, and combinations of the above ligands.

In various embodiments, the compounds of the present teachings include platinum compounds each having at least one heterocycle ligand. For example, the compound of the present teachings has Formula II:

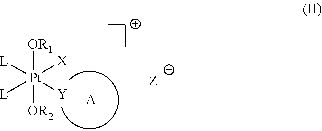

or a salt thereof,
X is a halide, sulfonate, sulfate, phosphate, or carboxylate such as stearate;
L each is independently ammonia or an amine;
Y is selected from N, P, and S;
A together with Y form a heteroaromatic optionally substituted with one or more substituents each independently selected from halogen, cyano, nitro, hydroxyl, ester, ether, alkoxy, aryloxy, amino, amide, carbamate, alkyl, alkenyl, alkynyl, aryl, arylalkyl, cycloalkyl, heteroaryl, heterocyclyl, phosphono, phosphate, sulfide, sulfinyl, sulfino, sulfonyl, sulfo, and sulfonamide, wherein each of the ester, ether, alkoxy, aryloxy, amino, amide, carbamate, alkyl, alkenyl, alkynyl, aryl, arylalkyl, cycloalkyl, heteroaryl, heterocyclyl, phosphono, phosphate, sulfide, sulfinyl, sulfino, sulfonyl, sulfo, and sulfonamide is optionally substituted with one or more suitable substituents; and
Z is a pharmaceutically acceptable counter ion;
wherein two of the adjacent X and Ls form a bidentate ligand, or
X and two Ls form a tridentate ligand, or
A, together with Y, and X form a bidentate ligand.
wherein each hydrogen atom of the aryl ring system is optionally replaced with a halide; and R¹ and R² individually is a hydrogen, alkyl, alkenyl, alkynyl, heteroalkyl, heteroalkenyl, heteroalkynyl, aryl, heteroalkyl, carbamoyl, and carbonyl, each optionally substituted, or are absent.

In some cases, a least one of R¹ or R² may be functionalized such that it may be associated with a nanoparticle or particle and/or another solid support (e.g., via a covalent bond), and/or may be associated with a nanoparticle. For example, the nanoparticle may comprise a polymeric material (e.g., poly[(lactic)co-glycolic] acid or similar construct) and may optionally be functionalized with a targeting moiety such as an aptamer directed against a cancer cell target, as described herein. In some embodiments, the platinum compound may be dispersed or encapsulated within a polymeric material. The platinum compound may or might not be associated with the polymeric material via a covalent bond. Without wishing to be bound by theory, the association of a nanoparticle or particle with a platinum compound and/or encapsulation of the platinum compound (e.g., in an emulsion, in a particle) may aid in protecting the platinum atom from being reduced (e.g., when exposed to blood and/or another biological reducing environment) prior to entry into a cancer cell and/or may reduce the toxicity of the platinum compound.

In some cases, A together with Y is:

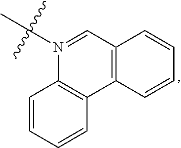

wherein each hydrogen atom of the aryl ring system is optionally replaced with a suitable substituent.

In some cases, the compound of Formula (I) comprises a compound of Formula (VIII)

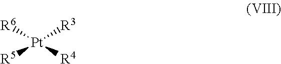

wherein R³-R⁶ are as described herein.

In other cases, the compound of Formula (II) comprises a compound of Formula (IX)

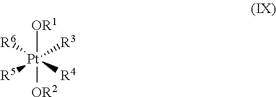

wherein R¹-R⁶ are as described herein.

The following descriptions may be applied to any one of the compounds of formulae (I), (II), (VIII) and/or (IX) shown above.

In some embodiments, X is a leaving group. As used herein, a “leaving group” is given its ordinary meaning in the art and refers to an atom or a group capable of being displaced by a nucleophile. Examples of suitable leaving groups include, but are not limited to, halides (such as chloride, bromide, and iodide), alkanesulfonyloxy, arenesulfonyloxy, alkyl-carbonyloxy (e.g., acetoxy, carboxylate), arylcarbonyloxy, mesyloxy, tosyloxy, trifluoromethane-sulfonyloxy, aryloxy, methoxy, N,O-dimethylhydroxylamino, pixyl, oxalato, malonato, and the like. A leaving group may also be a bidentate, tridentate, or other multidentate ligand. In some embodiments, the leaving group is a halide or carboxylate. In some embodiments, the leaving group is chloride.

In some embodiments, the ligands associated with the platinum center in the platinum compound may include functional groups capable of interaction with a metal center, e.g., heteroatoms such as nitrogen, oxygen, sulfur, and phosphorus. Non-limiting examples of compounds which the ligands may include amines (primary, secondary, and tertiary), aromatic amines, amino groups, amido groups, nitro groups, nitroso groups, amino alcohols, nitriles, imino groups, isonitriles, cyanates, isocynates, phosphates, phosphonates, phosphites, (substituted) phosphines, phosphine oxides, phosphorothioates, phosphoramidates, phosphonamidites, hydroxyls, carbonyls (e.g., carboxyl, ester and formyl groups), aldehydes, ketones, ethers, carbamoyl groups, thiols, sulfides, thiocarbonyls (e.g., thiolcarboxyl, thiolester and thiolformyl groups), thioethers, mercaptans, sulfonic acids, sulfoxides, sulfates, sulfonates, sulfones, sulfonamides, sulfamoyls, and sulfinyls. In other cases, at least some of the ligands may be aryl group, alkenyl group, alkynyl group, or other moiety, which may bind the metal atom in either a sigma- or pi-coordinated fashion.

Some embodiments of the invention comprise compounds having two leaving groups positioned in a cis configuration, i.e., the compound may be a cis isomer. However, it should be understood that compounds of the invention may also have two leaving groups positioned in a trans configuration, i.e., the compound may be a trans isomer. Those of ordinary skill in the art would understand the meaning of these terms.

As noted above, in some cases, any two or three L or Y may be joined together to form a bidentate or tridentate ligand, respectively. As will be known by those of ordinary skill in the art, a bidentate ligand, when bound to a metal center, forms a metallacycle structure with the metal center, also known as a chelate ring. Bidentate ligands suitable for use in the present invention include species that have at least two sites capable of binding to a metal center. For example, the bidentate ligand may comprise at least two heteroatoms that coordinate the metal center, or a heteroatom and an anionic carbon atom that coordinate the metal center. Examples of bidentate ligands suitable for use in the invention include, but are not limited to, alkyl and aryl derivatives of moieties such as amines, phosphines, phosphites, phosphates, imines, oximes, ethers, thiolates, thioethers, hybrids thereof, substituted derivatives thereof, aryl groups (e.g., bis-aryl, heteroaryl-substituted aryl), heteroaryl groups, and the like. Specific examples of bidentate ligands include ethylenediamine, 2,2′-bipyridine, acetylacetonate, oxalate, and the like. Other non-limiting examples of bidentate ligands include diimines, pyridylimines, diamines, imineamines, iminethioether, iminephosphines, bisoxazoline, bisphosphineimines, diphosphines, phosphineamine, salen and other alkoxy imine ligands, amidoamines, imidothioether fragments and alkoxyamide fragments, and combinations of the above ligands.

As will be known to those of ordinary skill in the art, a tridentate ligand generally includes species which have at least three sites capable of binding to a metal center. For example, the tridentate ligand may comprise at least three heteroatoms that coordinate the metal center, or a combination of heteroatom(s) and anionic carbon atom(s) that coordinate the metal center. Non-limiting examples of tridentate ligands include 2,5-diiminopyridyl ligands, tripyridyl moieties, triimidazoyl moieties, tris pyrazoyl moieties, and combinations of the above ligands.

As noted above, in some cases, the phenanthridine ligand is optionally substituted wherein any hydrogen atom of the phenanthridine ligand may be optionally substituted with a suitable substituent. For example, the phenanthridine ligand (e.g., R⁴ of compound of Formulae (VIII) or (IX)) may comprise the formula:

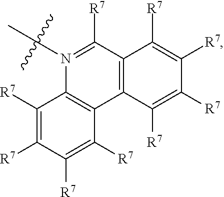

wherein each R⁷ may be H or another suitable substituent. In some cases, at least one R⁷ is not hydrogen. In some cases, each R⁷ may be H or a halide (e.g., F, Cl, Br, I). In some cases, at least one R⁷ is halide. In some cases, at least one R⁷ is fluorine. In some cases, each R⁷ is a halide. In some cases, each R⁷ is fluorine. Other non-limiting examples of suitable R⁷ groups include alkyl, aryl, heteroalkyl, heteroaryl, hydroxyl, amino, cyano, etc., each optionally substituted. In some embodiments, R⁴ is not phenanthridine-1,9-diamine.

In some embodiments, release of OR¹ and OR² from the platinum(IV) compound may form a platinum(II) compound, wherein the platinum (IV) compound may not be therapeutically active and the platinum (II) compound may be therapeutically active (e.g., useful for the treatment of disease, for example, cancer). In some cases, the release of OR¹ and OR² from the platinum center may be facilitated by a redox change of the platinum(IV) center. In some cases, the redox change may be caused by the release of OR¹ and OR² from the platinum(IV) center. In other cases, a redox change of the platinum(IV) center may promote the release of OR¹ and OR². For example, a redox change of the platinum(IV) center may cause a change in coordination geometry for the platinum center that reduces the number of ligands, thereby causing OR¹ and OR² to dissociate from the platinum center. In some embodiments, wherein the platinum compound is associated with a particle via at least one covalent bond (e.g., formed between any one of X, L, OR¹ or OR² and the particle), release of ligand, which is covalently associated with the particle may result in dissociation of the platinum compound with the particle. In some embodiments, wherein X, L, OR¹ or OR² form a covalent bond with the particle, release of OR¹ and OR² from a platinum(IV) compound results in dissociation of the platinum compound with the particle. As another example, the redox change of a platinum(IV) center may promote the lability of OR¹ and OR² and make it more likely that OR¹ and OR² may be replaced by other ligands.

In some embodiments, OR¹ and OR² are selected such that, upon exposure to a cellular environment, a therapeutically active platinum(II) compound forms. For example, OR¹ and OR² may be essential groups for the formation of a therapeutically active platinum agent (e.g., groups which are required for a platinum compound to be therapeutically active compound, wherein OR¹ and OR² may be any variety of ligands. In some cases, OR¹ and OR² may be the same or different, and each may be a leaving group or a precursor to a second therapeutically active compound. In some embodiments, upon exposure to a cellular environment, R³, R⁴, (OR¹)⁻, and (OR²)⁻ may dissociate from the platinum center, and at least two new ligands may associate with the platinum center (e.g., R⁷ and R⁸, as shown in Equation 1) to form a therapeutically active platinum compound (e.g., [Pt(R⁵)(R⁶)(R⁷)(R⁸)]).

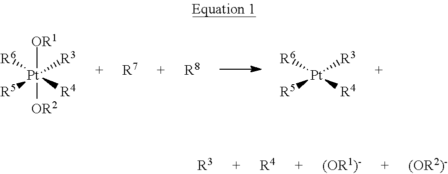

As described herein, some compounds may be provided as a salt comprising a positively charged platinum compound and a counterion (e.g., “Z”). The counterion Z may be a weak or non-nucleophilic stabilizing ion. Z may have a charge of (−1), (−2), (−3), etc. In some embodiments, Z has a charge of (−1). In other embodiments, Z has a charge of (−2). In some embodiments, the counterion is a negatively charged and/or non-coordinating ion. Z may be any suitable counterion, including, but not limited to, halide (e.g., chloride, bromide, iodide), nitrate, nitrite, sulfate, sulfite, triflate and bis(2-ethlhexyl) sulfosuccinate (AOT). In some embodiments, Z is NO₃⁻, or AOT⁻.

In one embodiment, the compound of Formula (II) is a compound of the Formula (X) provided as follows:

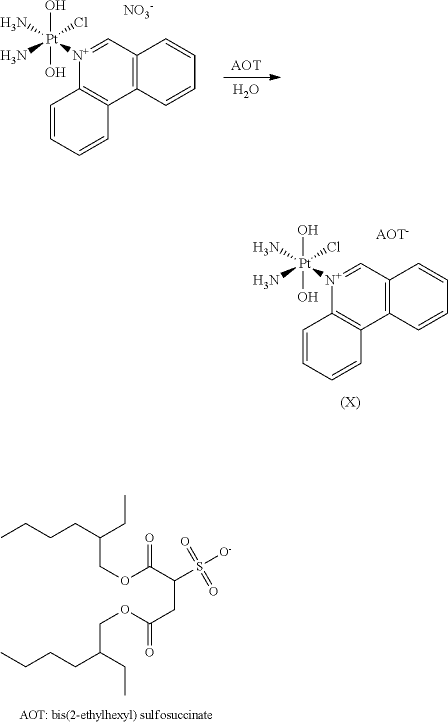

In another embodiment, the compound of Formula (II) is a compound of the formula (XI):

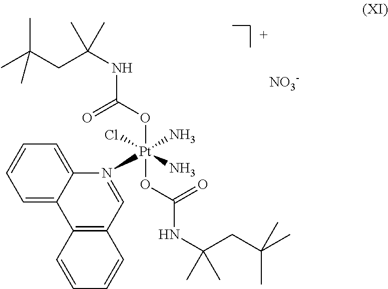

In yet another embodiment, the compound of Formula (II) is a compound of formula (XII):

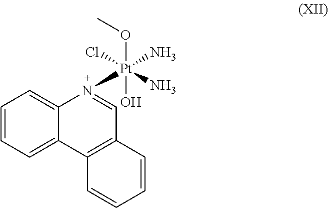

In a further embodiment, the compound of Formula (II) is a compound of formula (XIII):

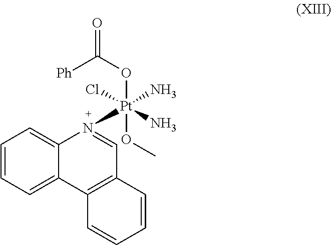

In another embodiment, the compound of Formula (II) is a compound of formula (XIV):

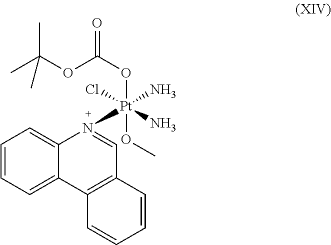

In another embodiment, the compound of Formula (II) is a compound of formula (XV):

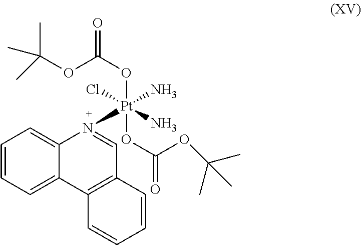

In a further embodiment, the compound of Formula (II) is a compound of formula (XVI):

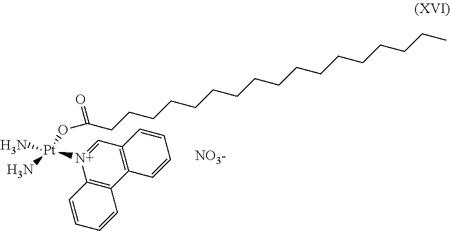

In some embodiments, the compound has a molecular weight of 1000 g/mol or less (e.g., 1000 Da or less).

The invention also comprises homologs, analogs, derivatives, enantiomers, diastereomers, tautomers, cis- and trans-isomers, and functionally equivalent compositions of compounds described herein. “Functionally equivalent” generally refers to a composition capable of treatment of patients having a disease (e.g., cancer), or of patients susceptible to a disease. It will be understood that the skilled artisan will be able to manipulate the conditions in a manner to prepare such homologs, analogs, derivatives, enantiomers, diastereomers, tautomers, cis- and trans-isomers, and functionally equivalent compositions. Homologs, analogs, derivatives, enantiomers, diastereomers, tautomers, cis- and trans-isomers, and functionally equivalent compositions which are about as effective or more effective than the parent compound are also intended for use in the method of the invention. Such compositions may also be screened by the assays described herein for increased potency and specificity towards a disease (e.g., cancer), preferably with limited side effects. Synthesis of such compositions may be accomplished through typical chemical modification methods such as those routinely practiced in the art. Another aspect of the present invention provides any of the above-mentioned compounds as being useful for the treatment of a disease (e.g., cancer).

In one embodiment, the compound is phenanthriplatin, a compound having the structure:

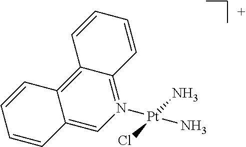

In another embodiment, the platinum compounds disclosed herein are encapsulated in, tethered to or otherwise associated with a nanoparticle.

The compounds of the present teachings may be synthesized according to methods known in the art, including various methods described herein. For example, the method may comprise the reaction of cisplatin with one or more ligand sources.

Once formed, the platinum complex may be formulated into nanoparticles for delivery to a patient as described further below. The platinum complexes may be delivered alone or in combination with the conjugates described herein. The compounds of the present teachings may be synthesized according to methods known in the art, including various methods described herein. The present teachings therefore comprise compositions (including pharmaceutical compositions) comprising one or more of the compounds as described herein. In various embodiments, a composition of the present teachings comprises a particle and a conjugate described herein. In some embodiments, as described further in the sections below, the particle comprises a base component forming an inner portion and an exterior portion. In certain embodiments, the interior of the particle is more hydrophobic than the exterior of the particle. In certain other embodiments, the interior is more hydrophilic than the exterior.

### III. FORMULATION OF NANOPARTICLES

The platinum compounds or complexes taught herein may be formulated as nanoparticles. In some embodiments they are encapsulated, in whole or in part, in the inner portion of the nanoparticles, or tethered to or otherwise associated with the nanoparticles. The nanoparticles may have a substantially spherical or non-spherical configuration (e.g., upon swelling or shrinkage). The nanoparticles may include polymer blends. In various embodiments, the base component of the nanoparticles comprises a polymer, a small molecule, or a mixture thereof. The base component can be biologically derived. For example, the small molecule can be, for example, a lipid. A “lipid,” as used herein, refers to a hydrophobic or amphiphilic small molecule. Without attempting to limit the scope of the present teachings, lipids, because of their amphiphilicity, can form particles, including liposomes and micelles.

In some embodiments, the base component comprises a polymer. For example, the polymer can be a biopolymer. Non-limiting examples include peptides or proteins (i.e., polymers of various amino acids), nucleic acids such as DNA or RNA. In certain embodiments, the polymer is amphiphilic, i.e., having a hydrophilic portion and a hydrophobic portion, or a relatively hydrophilic portion and a relatively hydrophobic portion.

In various embodiments, the base component is biocompatible, i.e., it does not typically induce an adverse response when inserted or injected into a subject. The adverse response can include significant inflammation and/or acute rejection of the polymer by the immune system, for instance, via a T-cell response. It will be recognized, of course, that “biocompatibility” is a relative term, and some degree of immune response is to be expected even for polymers that are highly compatible with living tissue. However, as used herein, “biocompatibility” refers to the acute rejection of material by at least a portion of the immune system, i.e., a non-biocompatible material implanted into a subject provokes an immune response in the subject that is severe enough such that the rejection of the material by the immune system cannot be adequately controlled, and often is of a degree such that the material must be removed from the subject.

Non-limiting examples of biocompatible polymers that may be useful in various embodiments of the present invention include polydioxanone (PDO), polyhydroxyalkanoate, polyhydroxybutyrate, poly(glycerol sebacate), polyglycolide, polylactide, polycaprolactone, or copolymers or derivatives including these and/or other polymers. In other embodiments, the base component may comprise liposomes, cyclodextrins or inorganic platforms as known generally in the art.

In various embodiments, the base component is biodegradable, i.e., the polymer is able to degrade, chemically and/or biologically, within a physiological environment, such as within the body. For instance, the polymer may be one that hydrolyzes spontaneously upon exposure to water (e.g., within a subject), the polymer may degrade upon exposure to heat (e.g., at temperatures of about 37° C.). Degradation of a polymer may occur at varying rates, depending on the polymer or copolymer used. For example, the half-life of the polymer (the time at which 50% of the polymer is degraded into monomers and/or other nonpolymeric moieties) may be on the order of days, weeks, months, or years, depending on the polymer. The polymers may be biologically degraded, e.g., by enzymatic activity or cellular machinery, in some cases, for example, through exposure to a lysozyme (e.g., having relatively low pH). In some cases, the polymers may be broken down into monomers and/or other nonpolymeric moieties that cells can either reuse or dispose of without significant toxic effect on the cells (for example, polylactide may be hydrolyzed to form lactic acid, polyglycolide may be hydrolyzed to form glycolic acid, etc.).

Examples of biodegradable polymers include, but are not limited to, poly(lactide) (or poly(lactic acid)), poly(glycolide) (or poly(glycolic acid)), poly(orthoesters), poly(caprolactones), polylysine, poly(ethylene imine), poly(acrylic acid), poly(urethanes), poly(anhydrides), poly(esters), poly(trimethylene carbonate), poly(ethyleneimine), poly(acrylic acid), poly(urethane), poly(beta amino esters) or the like, and copolymers or derivatives of these and/or other polymers, for example, poly(lactide-co-glycolide) (PLGA).

In various embodiments, the base component comprises polylactide or poly(lactic acid). In various embodiments, the base component comprises poly(glycolide). In various embodiments, the base component comprises poly(lactide-co-glycolide).

A person with ordinary skill in the art can choose polylactide, polyglycolide, or poly(lactide-co-glycolide) of different molecular weights according to various applications. In some embodiments, the polylactide, polyglycolide, or poly(lactide-co-glycolide) has a number average molecular weight of about 5 kDa to about 250 kDa. For example, the polylactide, polyglycolide, or poly(lactide-co-glycolide) has a number average molecular weight of about 5 kDa to about 150 kDa. In certain embodiments, the polylactide, polyglycolide, or poly(lactide-co-glycolide) has a number average molecular weight of about 5 kDa to about 10 kDa, about 10 kDa to about 20 kDa, about 20 kDa to about 30 kDa, about 30 kDa to about 40 kDa, about 40 kDa to about 50 kDa, about 50 kDa to about 60 kDa, about 60 kDa to about 70 kDa, about 70 kDa to about 80 kDa, about 80 kDa to about 90 kDa, about 90 kDa to about 100 kDa, about 100 kDa to about 110 kDa, about 110 kDa to about 120 kDa, about 120 kDa to about 130 kDa, about 130 kDa to about 140 kDa, or about 140 kDa to about 150 kDa. In certain embodiments, the polylactide, polyglycolide, or poly(lactide-co-glycolide) has a number average molecular weight of about 10 kDa to about 150 kDa, about 20 kDa to about 125 kDa, about 30 kDa to about 110 kDa, about 40 kDa to about 90 kDa, or about 50 kDa to about 80 kDa. For example, the polylactide, polyglycolide, or poly(lactide-co-glycolide) can have a number average molecular weight of about 15 kDa, about 35 kDa, about 50 kDa, about 60 kDa, about 80 kDa, about 90 kDa, about 100 kDa, or about 110 kDa. In particular embodiments, the polylactide, polyglycolide, or poly(lactide-co-glycolide) has a number average molecular weight of about 15 kDa.

In various embodiments, the base component has the capability of controlling immunogenicity. Nonexclusive examples of a polymeric base component include a poly(alkylene glycol) (also known as poly(alkylene oxide)), such as poly(propylene glycol), or poly(ethylene oxide), also known as poly(ethylene glycol) (“PEG”), having the formula —(CH₂—CH₂—O)ₙ—, where n is any positive integer. The poly(ethylene glycol) units may be present within the polymeric base component in any suitable form. For instance, the polymeric base component may be a block copolymer where one of the blocks is poly(ethylene glycol). A polymer comprising poly(ethylene glycol) repeating units is also referred to as a “PEGylated” polymer. Such polymers can control inflammation and/or immunogenicity (i.e., the ability to provoke an immune response), due to the presence of the poly(ethylene glycol) groups.

PEGylation may also be used, in some cases, to decrease charge interaction between a polymer and a biological moiety, e.g., by creating a hydrophilic layer on the surface of the polymer, which may shield the polymer from interacting with the biological moiety. For example, PEGylation may be used to create particles which comprise an interior which is more hydrophobic than the exterior of the particles. In some cases, the addition of poly(ethylene glycol) repeating units may increase plasma half-life of the polymeric conjugate, for instance, by decreasing the uptake of the polymer by the phagocytic system while decreasing transfection/uptake efficiency by cells.

In various embodiments, the PEG unit has a number average molecular weight of about 1 kDa to about 20 kDa. For example, the PEG unit can have a number average molecular weight of about 1 kDa to about 2 kDa, about 2 kDa to about 3 kDa, about 3 kDa to about 4 kDa, about 4 kDa to about 5 kDa, about 5 kDa to about 6 kDa, about 6 kDa to about 7 kDa, about 7 kDa to about 8 kDa, about 8 kDa to about 9 kDa, about 9 kDa to about 10 kDa, about 10 kDa to about 12 kDa, about 12 kDa to about 14 kDa, about 14 kDa to about 16 kDa, about 16 kDa to about 18 kDa, or about 18 kDa to about 20 kDa. In some embodiments, the PEG unit has a number average molecular weight of about 1 kDa to about 10 kDa. In certain embodiments, the PEG unit has a number average molecular weight of about 2 kDa to about 8 kDa, or about 3 kDa to about 7 kDa, or about 4 kDa to about 6 kDa. For example, the PEG unit has a number average molecular weight of about 2 kDa to about 6 kDa or about 3 kDa to about 5 kDa. In particular embodiments, the PEG unit has a number average molecular weight of about 3 KDa, 4 kDa, 5 kDa, or 6 kDa.

In various embodiments, the base component comprises a polylactide, a polyglycolide, or poly(lactide-co-glycolide) and a PEGylated polylactide, a PEGylated polyglycolide, or a PEGylated poly(lactide-co-glycolide). The weight percentage of the PEGylated polymer in the base component can be from 0% to 100%, including about 5% to about 95%, about 10% to about 90%, about 20% to about 80%, about 30% to about 70%, or about 40% to about 60%. In some embodiments, the weight percentage of the PEGylated polymer in the base component is about 30% to about 95% or about 40% to about 90%. In particular embodiments, the weight percentage of the PEGylated polymer in the base component is about 40%, 50%, 60%, 70%, 80%, 90%, or 100%. For example, the weight percentage of the PEGylated polymer in the base component is about 60%.

Those of ordinary skill in the art will know of methods and techniques for PEGylating a polymer, for example, by using EDC (1-ethyl-3-(3-dimethylaminopropyl) carbodiimide hydrochloride) and NHS (N-hydroxysuccinimide) to react a polymer to a PEG group terminating in an amine, for example, by ring opening polymerization techniques, or the like. In addition, certain embodiments are directed towards copolymers containing poly(ester-ether)s, e.g., polymers having repeating units joined by ester bonds (e.g., R—C(O)—O—R′ bonds) and ether bonds (e.g., R—O—R′ bonds).

In various embodiments, the particle comprises one or more compounds of the present teachings. In some embodiments, at least one of the compounds is contained within a particle of the present teachings. The term “contained within” may mean “located in a cavity of,” “entirely embedded in,” or “partially embedded in.” For example, at least one of the compounds can be located in a cavity formed in a particle of the present teachings or otherwise embedded in a particle of the present teachings. In certain embodiments, at least one of the compounds is located in the cavity of a particle. In certain embodiments, at least one of the compounds is entirely embedded in a particle. In certain embodiments, at least one of the compounds is partially embedded in a particle.

In various embodiments, a substantial amount of at least one of the compounds is contained within particles of the present teachings. In some embodiments, about 90% or greater, about 80% or greater, about 70% or greater, or about 60% or greater of the total amount of at least one of the compounds included in the particles is contained within the particles. In certain embodiments, about 80% or greater of the total amount of at least one of the compounds included in the particles is contained within the particles. In certain embodiments, about 90% or greater of the total amount of at least one of the compounds included in the particles is contained within the particles. In certain embodiments, about 95% or greater of the total amount of at least one of the compounds included in the particles is contained within the particles.

In various embodiments, about 50% and greater, about 40% or greater, about 30% or greater, about 20% or greater, or about 10% or greater of the total amount of at least one of the compounds included in particles of the present teachings is contained within the particles. In some embodiments, about 10% or greater of the total amount of at least one of the compounds included in the particles is contained within the particles. In some embodiments, about 20% or greater of the total amount of at least one of the compounds included in the particles is contained within the particles. In some embodiments, about 30% or greater of the total amount of at least one of the compounds included in the particles is contained within the particles. In some embodiments, about 40% or greater of the total amount of at least one of the compounds included in the particles is contained within the particles. In some embodiments, about 50% or greater of the total amount of at least one of the compounds included in the particles is contained within the particles.

In various embodiments, the ratio of the compound to the base component in a solution prior to formation of a plurality of particles may affect the percent loading of the compound in the particle and/or the mean size of the particle. For example, an increase in the percent weight of the compound to the percent weight of the base component may increase the percent loading of the compound within the particle. However, the percent loading of the compound in the particles formed may or may not be related to the weight percent of the compound provided during formation of the particles.

In some embodiments, the percent weight of the compound provided in a mixture comprising the compound and the base component is at least about 5%, at least about 10%, at least about 20%, at least about 30%, at least about 40%, at least about 50%, at least about 60%, at least about 70%, at least about 80%, at least about 90%, or at least about 100%. In certain embodiments, the percent weight is between about 5% and about 90%, between about 10% and about 80%, between about 10% and about 50%, between about 50% and about 90%, or any range therein. In particular embodiments, the weight percentage is about 5% to about 30% or about 5% to about 20%. For example, the weight percentage can be about 10%.

In some embodiments, the total percent loading of the compound in the plurality of particles is greater than about 0.01%, greater than about 0.05%, greater than about 0.1%, greater than about 0.5%, greater than about 1%, greater than about 2%, greater than about 5%, greater than about 10%, greater than about 15%, greater than about 20%, greater than about 25%, greater than about 30%, greater than about 35%, greater than about 40%, greater than about 45%, greater than about 50%, greater than about 55%, or greater. In some embodiments, the percent loading is between about 0.01% and about 50%, between about 0.05% and about 30%, between about 0.1% and about 10%, between about 1% and about 10%, between about 0.05% and about 30%, between about 0.05% and about 10%, between about 0.1% and about 50%, or any range therein. In certain embodiments, the percentage loading is about 2%, about 3%, about 4%, about 5%, about 6%, about 7%, or about 8%. In particular embodiments, the percentage loading is about 5%, about 6%, about 7%, about 8%, about 9%, or about 10%.

Without wishing to be bound by theory, the size of a particle may alter the delivery (e.g., loss of payload, drug efflux, aggregations, delivery to desired location, etc.) of a compound of the present teachings from the particles. The size of the particles used in a delivery system may be selected based on the application, and will be readily known to those of ordinary skill in the art. For example, particles of smaller size (e.g., <200 nm) may be selected if systematic delivery of the particles throughout a patient's bloodstream is desired. As another example, particles of larger size (e.g., >200 nm) may be selected if sequestering of the particles by a patient's reticuloendothelial system upon injection is desired (e.g., sequestering of the particles in the liver, spleen, etc.). The desired length of time of delivery may also be considered when selecting particle size. For example, smaller particles may circulate in the blood stream for longer periods of time than larger particles.

In some embodiments, the particles may substantially accumulate at the site of a tumor. Without attempting to limit the scope of the present teaching, the accumulation may be due, at least in part, to the presence of a targeting moiety associated with the particle, as described herein; or, at least in part, due to an enhanced permeability and retention (EPR) effect, which allows for particles to accumulate specifically at a tumor site. The EPR effect will be known to those of ordinary skill in the art and refers to the property by which certain sizes of material (e.g., particles) tend to accumulate in tumor tissue much more than they do in normal tissues.

In various embodiments, a particle may be a nanoparticle, i.e., the particle has a characteristic dimension of less than about 1 micrometer, where the characteristic dimension of a particle is the diameter of a perfect sphere having the same volume as the particle. The plurality of particles can be characterized by an average diameter (e.g., the average diameter for the plurality of particles). In some embodiments, the diameter of the particles may have a Gaussian-type distribution. In some embodiments, the plurality of particles have an average diameter of less than about 300 nm, less than about 250 nm, less than about 200 nm, less than about 150 nm, less than about 100 nm, less than about 50 nm, less than about 30 nm, less than about 10 nm, less than about 3 nm, or less than about 1 nm. In some embodiments, the particles have an average diameter of at least about 5 nm, at least about 10 nm, at least about 30 nm, at least about 50 nm, at least about 100 nm, at least about 150 nm, or greater. In certain embodiments, the plurality of the particles have an average diameter of about 10 nm, about 25 nm, about 50 nm, about 100 nm, about 150 nm, about 200 nm, about 250 nm, about 300 nm, about 500 nm, or the like. In some embodiments, the plurality of particles have an average diameter between about 10 nm and about 500 nm, between about 50 nm and about 400 nm, between about 100 nm and about 300 nm, between about 150 nm and about 250 nm, between about 175 nm and about 225 nm, or the like. In some embodiments, the plurality of particles have an average diameter between about 10 nm and about 500 nm, between about 20 nm and about 400 nm, between about 30 nm and about 300 nm, between about 40 nm and about 200 nm, between about 50 nm and about 175 nm, between about 60 nm and about 150 nm, between about 70 nm and about 120 nm, or the like. For example, the average diameter can be between about 70 nm and 120 nm.

Another aspect of the present teachings relates to systems and methods of making the disclosed particles, including nanoparticles. In various embodiments, a method of making the particles comprises providing a compound disclosed herein; providing a base component (e.g., PLA-PEG or PLGA-PEG); combining the compound and the base component in an organic solution to form a first organic phase; and combining the first organic phase with a first aqueous solution to form a second phase; emulsifying the second phase to form an emulsion phase; and recovering particles. In various embodiments, the emulsion phase is further homogenized.

In some embodiments, the first phase includes about 5 to about 50% weight, e.g., about 1 to about 40% weight, or about 5 to about 30% weight, e.g., about 5%, 10%, 15%, and 20%, of the compound and the base component. In certain embodiments, the first phase includes about 5% weight of the compound and the base component. In various embodiments, the organic phase comprises acetonitrile, tetrahydrofuran, ethyl acetate, isopropyl alcohol, isopropyl acetate, dimethylformamide, methylene chloride, dichloromethane, chloroform, acetone, benzyl alcohol, Tween 80, Span 80, or a combination thereof. In some embodiments, the organic phase includes benzyl alcohol, ethyl acetate, or a combination thereof.

In various embodiments, the aqueous solution comprises a water, sodium cholate, ethyl acetate, or benzyl alcohol. In some embodiments, the aqueous solution also comprises an emulsifier, including a polysorbate. For example, the aqueous solution can include polysorbate 80.

Emulsifying the second phase to form an emulsion phase may be performed in one or two emulsification steps. For example, a primary emulsion may be prepared, and then emulsified to form a fine emulsion. The primary emulsion can be formed, for example, using simple mixing, a high pressure homogenizer, probe sonicator, stir bar, or a rotor stator homogenizer. The primary emulsion may be formed into a fine emulsion through the use of e.g., probe sonicator or a high pressure homogenizer, e.g., by using 1, 2, 3 or more passes through a homogenizer. For example, when a high pressure homogenizer is used, the pressure used may be about 4000 to about 8000 psi, or about 4000 to about 5000 psi, e.g., 4000 or 5000 psi.

Either solvent evaporation or dilution may be needed to complete the extraction of the solvent and solidify the particles. For better control over the kinetics of extraction and a more scalable process, a solvent dilution via aqueous quench may be used. For example, the emulsion can be diluted into cold water to a concentration sufficient to dissolve all of the organic solvent to form a quenched phase. Quenching may be performed at least partially at a temperature of about 5° C. or less. For example, water used in the quenching may be at a temperature that is less that room temperature (e.g., about 0 to about 10° C., or about 0 to about 5° C.).

In various embodiments, the particles are recovered by filtration. For example, ultrafiltration membranes can be used. Exemplary filtration may be performed using a tangential flow filtration system. For example, by using a membrane with a pore size suitable to retain nanoparticles while allowing solutes, micelles, and organic solvent to pass, nanoparticles can be selectively separated. Exemplary membranes with molecular weight cut-offs of about 300-500 kDa (−5-25 nm) may be used.

In various embodiments, a compound of the present teachings contained within a particle is released in a controlled manner. The release can be in vitro or in vivo. For example, particles of the present teachings can be subject to a release test under certain conditions, including those specified in the U.S. Pharmacopeia and variations thereof.

In various embodiments, less than about 90%, less than about 80%, less than about 70%, less than about 60%, less than about 50%, less than about 40%, less than about 30%, less than about 20% of the compound of the present teachings contained within particles is released in the first hour after the particles are exposed to the conditions of a release test. In some embodiments, less that about 90%, less than about 80%, less than about 70%, less than about 60%, less than about 50% of the compound of the present teachings contained within particles is released in the first hour after the particles are exposed to the conditions of a release test. In certain embodiments, less than about 50% of the compound contained within particles is released in the first hour after the particles are exposed to the conditions of a release test.

With respect to a compound of the present teachings being released in vivo, for instance, the compound contained within a particle administered to a subject may be protected from a subject's body, and the body may also be isolated from the compound until the compound is released from the particle.

Thus, in some embodiments, the compound may be substantially contained within the particle until the particle is delivered into the body of a subject. For example, less than about 90%, less than about 80%, less than about 70%, less than about 60%, less than about 50%, less than about 40%, less than about 30%, less than about 20%, less than about 15%, less than about 10%, less than about 5%, or less than about 1% of the total compound is released from the particle prior to the particle being delivered into the body, for example, a treatment site, of a subject. In some embodiments, the compound may be released over an extended period of time or by bursts (e.g., amounts of the compound are released in a short period of time, followed by a periods of time where substantially no compound is released). For example, the compound can be released over 6 hours, 12 hours, 24 hours, or 48 hours. In certain embodiments, the compound is released over 1 week or 1 month.

The compound(s) may thus be contained, in large part or essentially completely within the interior of the particle, which may thus shelter it from the external environment surrounding the particle (or vice versa). For instance, a compound of the present teachings contained within a particle administered to a subject may be protected from a subject's body, and the body may also be isolated from the compound until the compound is released from the particle.

In further embodiments, the particle is a microparticle, nanoparticle or picoparticle. In still other embodiments, the particle is a liposome, polymeric micelle, lipoplex or polyplex, or a cyclodextrin. In some embodiments, the particle comprises one or more lipids. In some embodiments, the one or more lipids are lipidoids. In other embodiments, the particle further comprises one or more polymers. In still other embodiments, one or more of the lipids are conjugated to one or more of the polymers. In some embodiments, the particle comprises one or more polymers. In some embodiments, one or more of the lipids or polymers are degradable.

In some embodiments, the particle has an average characteristic dimension of less than about 500 nm, 400 nm, 300 nm, 250 nm, 200 nm, 180 nm, 150 nm, 120 nm, 100 nm, 90 nm, 80 nm, 70 nm, 60 nm, 50 nm, 40 nm, 30 nm, or 20 nm. In other embodiments, the particle has an average characteristic dimension of 10 nm, 20 nm, 30 nm, 40 nm, 50 nm, 60 nm, 70 nm, 80 nm, 90 nm, 100 nm, 120 nm, 150 nm, 180 nm, 200 nm, 250 nm, or 300 nm. In further embodiments, the particle has an average characteristic dimension of 10-500 nm, 10-400 nm, 10-300 nm, 10-250 nm, 10-200 nm, 10-150 nm, 10-100 nm, 10-75 nm, 10-50 nm, 50-500 nm, 50-400 nm, 50-300 nm, 50-200 nm, 50-150 nm, 50-100 nm, 50-75 nm, 100-500 nm, 100-400 nm, 100-300 nm, 100-250 nm, 100-200 nm, 100-150 nm, 150-500 nm, 150-400 nm, 150-300 nm, 150-250 nm, 150-200 nm, 200-500 nm, 200-400 nm, 200-300 nm, 200-250 nm, 200-500 nm, 200-400 nm, or 200-300 nm.

### IV. PHARMACEUTICAL PREPARATIONS

In another embodiment, a pharmaceutical composition is provided comprising the platinum compounds, complexes and/or conjugates described above, or a pharmaceutically acceptable salt thereof, in a pharmaceutically acceptable vehicle. The amount of a platinum complex or conjugate that may be combined with a pharmaceutically acceptable carrier to produce a dosage form will vary depending upon the host treated. The nanoparticulate compound may be formulated for parenteral administration by injection, e.g., by bolus injection or continuous infusion. Formulations for injection may be presented in unit dosage form in ampoules or in multi-dose containers with an optional preservative added. The parenteral preparation can be enclosed in ampoules, disposable syringes, or multiple dose vials made of glass, plastic or the like. The formulation may take such forms as suspensions, solutions, or emulsions in oily or aqueous vehicles, and may contain formulatory agents such as suspending, stabilizing, and/or dispersing agents.

For example, a parenteral preparation may be a sterile injectable solution or suspension in a nontoxic parenterally acceptable diluent or solvent (e.g., as a solution in 1,3-butanediol). Among the acceptable vehicles and solvents that may be employed are water, Ringer's solution, and isotonic sodium chloride solution. In addition, sterile, fixed oils are conventionally employed as a solvent or suspending medium. For this purpose any bland fixed oil may be employed including synthetic mono- or diglycerides. In addition, fatty acids such as oleic acid may be used in the parenteral preparation.

Alternatively, the compositions taught herein may be formulated in powder form for reconstitution with a suitable vehicle, such as sterile pyrogen-free water, before use. For example, a compound suitable for parenteral administration may comprise a sterile isotonic saline solution containing between 0.1 percent and 90 percent weight per volume of the compound. By way of example, a solution may contain from about 5 percent to about 20 percent, more preferably from about 5 percent to about 17 percent, more preferably from about 8 to about 14 percent, and still more preferably about 10 percent of the compound.

### V. METHODS OF TREATING DISEASES AND CONDITIONS

In additional aspects, the invention features methods of treating a disorder, e.g., a cancer or other disorder disclosed herein, in a subject in need thereof, the method comprising administering to the subject an effective amount of a platinum complex described above.

The pharmaceutical composition may comprise a plurality of particles disclosed herein that include a platinum complex in, tether to, or associated with a nanoparticle.

These and other embodiments of the present teachings may also involve the treatment of cancer or tumor according to any of the techniques and compositions and combinations of compositions described herein. In various embodiments, methods for treating a subject having a cancer are provided, wherein the method comprises administering a therapeutically-effective amount of a compound, as described herein, to a subject having a cancer or suspected of having cancer. In some embodiments, the subject may be otherwise free of indications for treatment with said compound. In some embodiments, methods include use of a therapeutically-effective amount of a compound against cancer cells, including but not limited to mammalian cancer cells. In some instances, the mammalian cancer cells are human cancer cells.

The platinum compounds comprising a phenanthridine ligand have substantially greater cytotoxicity as compared to other commonly employed platinum compounds (e.g., cisplatin) used for the treatment of cancer.

In some embodiments, the compounds of the present teachings have been found to inhibit cancer growth, including proliferation, invasiveness, and metastasis, thereby rendering them particularly desirable for the treatment of cancer. In some embodiments, the compounds of the present teachings may be used to prevent the growth of a tumor or cancer, and/or to prevent the metastasis of a tumor or cancer. In some embodiments, compositions of the present teachings may be used to shrink or destroy a cancer.

It should be appreciated that compositions of the invention may be used alone or in combination with one or more additional anti-cancer agents or treatments (e.g., chemotherapeutic agents, targeted therapeutic agents, pseudo-targeted therapeutic agents, hormones, radiation, surgery, etc., or any combination of two or more thereof). In some embodiments, a composition of the invention may be administered to a patient who has undergone a treatment involving surgery, radiation, and/or chemotherapy. In certain embodiments, a composition of the invention may be administered chronically to prevent, or reduce the risk of, a cancer recurrence.

The cancers treatable by methods of the present teachings preferably occur in mammals. Mammals include, for example, humans and other primates, as well as pet or companion animals, such as dogs and cats, laboratory animals, such as rats, mice and rabbits, and farm animals, such as horses, pigs, sheep, and cattle. In some embodiments, the compounds disclosed herein may be used to treat or affect cancers including, but not limited to lymphatic metastases, squamous cell carcinoma, particularly of the head and neck, esophageal squamous cell carcinoma, oral carcinoma, blood cell malignancies, including multiple myeloma, leukemias, including acute lymphocytic leukemia, acute nonlymphocytic leukemia, chronic lymphocytic leukemia, chronic myelocytic leukemia, and hairy cell leukemia, effusion lymphomas (body cavity based lymphomas), thymic lymphoma lung cancer, including small cell carcinoma, cutaneous T cell lymphoma, Hodgkin's lymphoma, non-Hodgkin's lymphoma, cancer of the adrenal cortex, ACTH-producing tumors, nonsmall cell cancers, breast cancer, including small cell carcinoma and ductal carcinoma, gastrointestinal cancers, including stomach cancer, colon cancer, colorectal cancer, polyps associated with colorectal neoplasia, pancreatic cancer, liver cancer, urological cancers, including bladder cancer, including primary superficial bladder tumors, invasive transitional cell carcinoma of the bladder, and muscle-invasive bladder cancer, prostate cancer, malignancies of the female genital tract, including ovarian carcinoma, primary peritoneal epithelial neoplasms, cervical carcinoma, uterine endometrial cancers, vaginal cancer, cancer of the vulva, uterine cancer and solid tumors in the ovarian follicle, malignancies of the male genital tract, including testicular cancer and penile cancer, kidney cancer, including renal cell carcinoma, brain cancer, including intrinsic brain tumors, neuroblastoma, astrocytic brain tumors, gliomas, metastatic tumor cell invasion in the central nervous system, bone cancers, including osteomas and osteosarcomas, skin cancers, including malignant melanoma, tumor progression of human skin keratinocytes, squamous cell cancer, thyroid cancer, retinoblastoma, neuroblastoma, peritoneal effusion, malignant pleural effusion, mesothelioma, gall bladder cancer, trophoblastic neoplasms, and hemangiopericytoma. In various embodiments, the cancer is lung cancer, bone cancer, breast cancer, colorectal cancer, ovarian cancer, bladder cancer, prostate cancer, cervical cancer, renal cancer, leukemia, central nerve system cancers, myeloma, and melanoma. In some cases, the cancer is lung cancer. In some cases, the cancer is human lung carcinoma and/or normal lung fibroblast.

In certain embodiments, the nanoparticles containing the platinum complexes of the present disclosure, or pharmaceutically acceptable counter ions or salts thereof, are administered in a therapeutically effective amount based on calculation of the body surface area (BSA). Such amount ranges from about 10 m g/m² BSA to about 50 mg/m² BSA administered IV wherein the mg corresponds to the total amount of platinum compound delivered per dose. In one embodiment, the therapeutically effective amount is 25 mg/m² BSA administered as a one-hour IV infusion.

The present teachings further comprise compositions (including pharmaceutical compositions) comprising any of the compounds as described herein. In some embodiments, a pharmaceutical composition is provided comprising a composition as described herein. These and other embodiments of the present teachings may also involve promotion of the treatment of cancer or tumor according to any of the techniques and compositions and combinations of compositions described herein.

### VI. EXAMPLES

The following examples are intended to illustrate certain embodiments of the present teachings, do not exemplify the full scope of the present teachings, and therefore should not be construed to limit the scope of the present teachings.

### Example 1

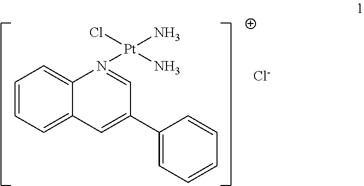

A vessel was charged with 3-bromoquinoline (2.08 g, 10 mmol), and ethanol (10 mL), water (20 mL), toluene (40 mL), phenylboronic acid (1.83 g, 15 mmol, 1.5 equiv), K₂CO₃ (5.52 g, 40 mmol, 4.0 equiv), and Pd(PPh₃)₄ (0.6 g, 0.5 mmol, 5 mol %) were added. The reaction mixture was heated at 95° C. for 16 hours. After cooling to room temperature, the biphasic solution was diluted with saturated aqueous NH₄Cl (30 mL) and CH₂Cl₂ (30 mL). The aqueous phase was extracted with CH₂Cl₂ (2×30 mL) and the combined organic layers were washed with water (30 mL) and saturated aqueous NaHCO₃ (30 mL). The organic phase was dried over MgSO₄ and filtered. The filtrate was concentrated in vacuo and purified by flash column chromatography to afford 3-phenylquinoline (1.5 g, 73%).

To a solution of cisplatin (0.2 g, 0.67 mmol) in dimethylformamide (DMF, 15 mL) was added AgNO₃ (0.11 g, 0.67 mmol), and the reaction was stirred under protection from light at room temperature. After 16 hours, AgCl precipitate was removed by filtration. 3-phenylquinoline (0.11 g, 0.54 mmol) was added to the filtrate and the reaction was stirred for 16 hours at room temperature. The reaction was concentrated under reduced pressure, and the resulting residue was dissolved in 30 mL methanol. Unreacted yellow cisplatin was removed by filtration. The filtrate was purified by prep-HPLC (eluting with CH₃CN/dilute HCl) to afford compound 1 as a white solid (120 mg, 24% yield). ¹H NMR (500 MHz, DMSO): δ 9.60-9.58 (m, 2H), 9.01 (s, 1H), 8.20 (d, J=8.0 Hz, 1H), 8.02 (t, J=7.5 Hz, 1H), 7.99 (d, J=8.0 Hz, 2H), 7.82 (t, J=7.5 Hz, 1H), 7.62 (t, J=7.5 Hz, 2H), 7.56-7.54 (m, 1H), 4.83 (s, 3H), 4.57 (s, 3H). LC-MS m/z: 469 (M⁺).

### Example 2

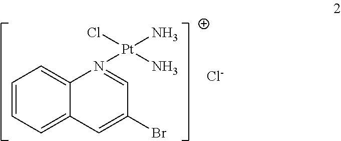

To a solution of cisplatin (0.15 g, 0.5 mmol) in DMF (15 mL) was added AgNO₃ (0.085 g, 0.5 mmol), and the reaction was stirred under protection from light at room temperature. After 16 hours, AgCl precipitate was removed by filtration. 3-bromoquinoline (0.1 g, 0.5 mmol) was added to the filtrate, and the reaction was stirred for 16 hours at room temperature. The reaction was concentrated under reduced pressure, and the resulting residue was dissolved in 30 mL methanol. Unreacted yellow cisplatin was removed by filtration. The filtrate was purified by prep-HPLC (eluting with CH₃CN/dilute HCl) to afford compound 2 as a white solid (150 mg, 60% yield). ¹H NMR (500 MHz, DMSO): δ 9.53 (d, J=8.5 Hz, 1H), 9.42 (d, J=2.0 Hz, 1H), 9.09 (s, 1H), 8.12-8.07 (m, 2H), 7.86 (d, J=8.5 Hz, 1H), 4.56 (s, 3H), 4.47 (s, 3H). LC-MS m/z: 472 (M⁺).

### Example 3

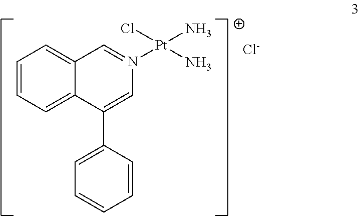

A vessel was charged with 4-bromoisoquinoline (2.08 g, 10 mmol), and ethanol (10 mL), water (20 mL), toluene (40 mL), phenylboronic acid (1.83 g, 15 mmol, 1.5 equiv), K₂CO₃ (5.52 g, 40 mmol, 4.0 equiv), and Pd(PPh₃)₄ (0.6 g, 0.5 mmol, 5 mol %) were added. The resulting mixture was heated at 95° C. for 16 hours. After cooling to room temperature, the biphasic solution was diluted with saturated aqueous NH₄Cl (30 mL) and CH₂Cl₂ (30 mL). The aqueous phase was extracted with CH₂Cl₂ (2×30 mL) and the combined organic layers were washed with water (30 mL) and saturated aqueous NaHCO₃ (30 mL). The organic phase was dried over MgSO₄ and filtered. The filtrate was concentrated in vacuo and purified by flash column chromatography to afford 4-phenylisoquinoline (1.64 g, 80%).

To a solution of cisplatin (0.15 g, 0.5 mmol) in DMF (5 mL) was added AgNO₃ (0.085 g, 0.5 mmol), and the reaction was stirred under protection from light at room temperature. After 16 hours, AgCl precipitate was removed by filtration. 4-phenylisoquinoline (0.1 g, 0.5 mmol) was added to the filtrate, and the reaction was stirred for 16 hours at room temperature. The reaction was concentrated under reduced pressure, and the resulting residue was dissolved in 30 mL methanol. Unreacted yellow cisplatin was removed by filtration. The filtrate was purified by prep-HPLC (eluting with CH₃CN/dilute HCl) to afford compound 3 as a white solid (90 mg, 40% yield). ¹H NMR (500 MHz, DMSO): δ 9.68 (s, 1H), 8.51 (s, 1H), 8.41 (d, J=8.5 Hz, 1H), 8.00 (d, J=8.5 Hz, 1H), 7.93-7.90 (m, 2H), 7.64-7.58 (m, 5H), 4.82 (s, 3H), 4.42 (s, 3H). LC-MS m/z: 469 (M⁺).

### Example 4

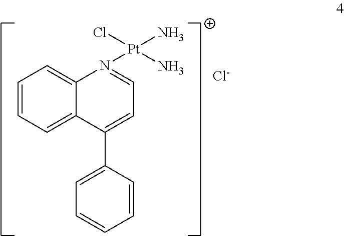

A vessel was charged with 4-bromoquinoline (2.08 g, 10 mmol), and ethanol (10 mL), water (20 mL), toluene (40 mL), phenylboronic acid (1.83 g, 15 mmol, 1.5 equiv), K₂CO₃ (5.52 g, 40 mmol, 4.0 equiv), and Pd(PPh₃)₄ (0.6 g, 0.5 mmol, 5 mol %) were added. The reaction mixture was heated at 95° C. for 16 hours. After cooling to room temperature, the biphasic solution was diluted with saturated aqueous NH₄Cl (30 mL) and CH₂Cl₂ (30 mL). The aqueous phase was extracted with CH₂Cl₂ (2×30 mL) and the combined organic layers were washed with water (30 mL) and saturated aqueous NaHCO₃ (30 mL). The organic phase was dried over MgSO₄ and filtered. The filtrate was concentrated in vacuo and purified by flash column chromatography to afford 4-phenylquinoline (1.64 g, 80%).

To a solution of cisplatin (0.15 g, 0.5 mmol) in DMF (5 mL) was added AgNO₃ (0.085 g, 0.5 mmol), and the reaction was stirred under protection from light at room temperature. After 16 hours, AgCl precipitate was removed by filtration. 4-phenylquinoline (0.1 g, 0.5 mmol) was added to the filtrate, and the reaction was stirred for 16 hours at room temperature. The reaction mixture was concentrated under reduced pressure, and the resulting residue was dissolved in 30 mL methanol. Unreacted yellow cisplatin was removed by filtration. The filtrate was purified by prep-HPLC (eluting with CH₃CN/dilute HCl) to afford compound 4 as a white solid (120 mg, 60% yield). ¹H NMR (500 MHz, DMSO): δ 9.72 (d, J=8.0 Hz, 1H), 9.30 (d, J=6.0 Hz, 1H), 8.09 (t, J=8.0 Hz, 1H), 7.96 (d, J=8.0 Hz, 1H), 7.80 (t, J=8.0 Hz, 1H), 7.65-7.58 (m, 6H), 4.60 (s, 3H), 4.44 (s, 3H). LC-MS m/z: 468 (M⁺).

### Example 5

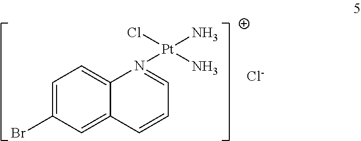

To a solution of cisplatin (0.15 g, 0.5 mmol) in DMF (5 mL) was added AgNO₃ (0.085 g, 0.5 mmol), and the reaction was stirred under protection from light at room temperature. After 16 hours, AgCl precipitate was removed by filtration. 6-Bromoquinoline (0.1 g, 0.5 mmol) was added to the filtrate, and the reaction was stirred for 16 hours at room temperature. The reaction mixture was concentrated under reduced pressure, and the resulting residue was dissolved in 30 mL methanol. Unreacted yellow cisplatin was removed by filtration. The filtrate was purified by prep-HPLC (eluting with CH₃CN/dilute HCl) to afford compound 5 as a white solid (150 mg, 60% yield). ¹H NMR (500 MHz, DMSO): δ 9.49 (d, J=8.5 Hz, 1H), 9.32 (d, J=5.0 Hz, 1H), 8.64 (d, J=8.5 Hz, 1H), 8.49 (d, J=2.0 Hz, 1H), 8.21 (dd, J=8.5 Hz, 2.0 Hz, 1H), 7.74 (dd, J=8.5 Hz, 5.0 Hz, 1H), 7.59-7.56 (m, 2H), 7.50-7.49 (m, 1H), 4.68 (s, 3H), 4.51 (s, 3H). LC-MS m/z: 471 (M⁺).

### Example 6

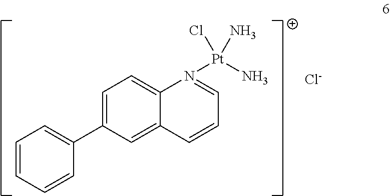

A vessel was charged with 6-bromoquinoline (2.08 g, 10 mmol), and ethanol (10 mL), water (20 mL), toluene (40 mL), phenylboronic acid (1.83 g, 15 mmol, 1.5 equiv), K₂CO₃ (5.52 g, 40 mmol, 4.0 equiv), and Pd(PPh₃)₄ (1.15 g, 1 mmol, 0.1 equiv) were added. The resulting mixture was heated at 95° C. for 16 hours. After cooling to room temperature, the biphasic solution was diluted with saturated aqueous NH₄Cl (30 mL) and CH₂Cl₂ (30 mL). The aqueous phase was extracted with CH₂Cl₂ (2×30 mL) and the combined organic layers were washed with water (30 mL) and saturated aqueous NaHCO₃ (30 mL). The organic phase was dried over MgSO₄ and filtered. The filtrate was concentrated in vacuo and purified by flash column chromatography to afford 6-phenylquinoline (1.68 g, 82%).

To a solution of cisplatin (0.15 g, 0.5 mmol) in DMF (5 mL) was added AgNO₃ (0.085 g, 0.5 mmol), and the reaction was stirred under protection from light at room temperature. After 16 hours, AgCl precipitate was removed by filtration. 6-phenylquinoline (0.1 g, 0.5 mmol) was added to the filtrate, and the reaction was stirred for 16 hours at room temperature. The reaction mixture was concentrated under reduced pressure, and the resulting residue was dissolved in 30 mL methanol. Unreacted yellow cisplatin was removed by filtration. The filtrate was purified by prep-HPLC (eluting with CH₃CN/dilute HCl) to afford compound 6 as a white solid (150 mg, 60% yield). ¹H NMR (500 MHz, DMSO): δ 9.62 (d, J=8.5 Hz, 1H), 9.26 (d, J=5.0 Hz, 1H), 8.71 (d, J=8.5 Hz, 1H), 8.46 (d, J=1.5 Hz, 1H), 8.39 (dd, J=8.5 Hz, 1.5 Hz, 1H), 7.89 (d, J=8.5 Hz, 2H), 7.71 (dd, J=8.5 Hz, 5.0 Hz, 1H), 7.59-7.56 (m, 2H), 7.50-7.49 (m, 1H), 4.70 (s, 3H), 4.50 (s, 3H). LC-MS m/z: 469 (M⁺).

### Example 7

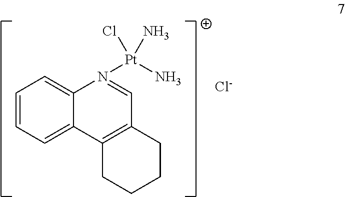

To a solution of DMF (12.9 mL, 167.9 mmol) in chloroform (80 mL), PBr₃ (15.4 mL, 152.8 mmol) was added dropwise at 0° C. The mixture was stirred for 60 minutes, and then a solution of cyclohexanone (5.0 g, 50.9 mmol) was added. The solution was stirred for 8 hours, and the content was poured into 300 mL water, neutralized with solid NaHCO₃ and extracted with dichloromethane (3×). The combined extracts were washed with a saturated NaCl solution, dried over anhydrous Na₂SO₄, and concentrated under reduced pressure. The residue was purified by passing through a short silica gel column to afford 2-bromo-1-cyclohexene-1-carboxaldehyde (7.6 g, 80%).

A vessel was charged with 2-bromo-1-cyclohexene-1-carboxaldehyde (0.56 g, 3 mmol), N-(2-bromophenyl)acetamide (0.64 g, 3 mmol), copper powder (1.7 g, 27 mmol) and Pd(PPh₃)₄ (0.35 g, 10 mol %) and dimethylsulfoxide (DMSO, 9 mL) and was degassed for 15 minutes, then heated at 85° C. under an argon atmosphere overnight. Anhydrous K₂CO₃ (2.8 g, 16.5 mmol) was added to the reaction mixture and stirring continued at 80-85° C. for a further 2 hours. The reaction mixture was cooled to room temperature and diluted with ethyl acetate and filtered. The filtrate was washed with water, dried over Na₂SO₄, filtered, and concentrated under reduced pressure. The crude material was purified by Combi-flash (C18 reverse column, CH₃CN/dilute NH₄HCO₃) to afford 7,8,9,10-tetrahydrophenanthridine (0.13 g, 24% yield).

To a solution of cisplatin (0.15 g, 0.5 mmol) in DMF (5 mL) was added AgNO₃ (0.085 g, 0.5 mmol), and the reaction was stirred under protection from light at room temperature. After 16 hours, AgCl precipitate was removed by filtration. 7,8,9,10-tetrahydrophenanthridine (0.091 g, 0.5 mmol) was added to the filtrate, and the reaction was stirred for 16 hours at room temperature. The reaction mixture was concentrated under reduced pressure, and the resulting residue was dissolved in 20 mL methanol. Unreacted yellow cisplatin was removed by filtration. The filtrate was purified by prep-HPLC (eluting with CH₃CN/dilute HCl) to afford compound 7 as a white solid (110 mg, 45% yield). ¹H NMR (500 MHz, DMSO): δ 9.53 (d, J=8.0 Hz, 1H), 9.04 (s, 1H), 8.13 (d, J=8.0 Hz, 1H), 7.92 (t, J=8.0 Hz, 1H), 7.75 (t, J=8.0 Hz, 1H), 4.64 (s, 3H), 4.44 (s, 3H), 3.23-3.14 (m, 2H), 2.99-2.87 (m, 2H), 1.93-1.85 (m, 4H). LC-MS m/z: 447 (M⁺).

### Example 8

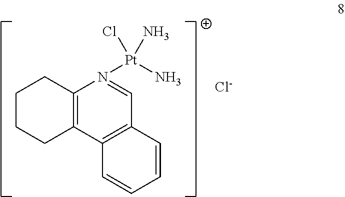

To a solution of cisplatin (0.15 g, 0.5 mmol) in DMF (5 mL) was added AgNO₃ (0.085 g, 0.5 mmol), and the reaction was stirred under protection from light at room temperature. After 16 hours, AgCl precipitate was removed by filtration. 1,2,3,4-Tetrahydrophenanthridine (0.091 g, 0.5 mmol) was added to the filtrate, and the reaction was stirred for 16 hours at room temperature. The reaction mixture was concentrated under reduced pressure, and the resulting residue was dissolved in 20 mL methanol. Unreacted yellow cisplatin was removed by filtration. The filtrate was purified by prep-HPLC (eluting with CH₃CN/dilute HCl) to afford compound 8 as a white solid (140 mg, 56% yield). ¹H NMR (500 MHz, DMSO): δ 9.62 (s, 1H), 8.25 (d, J=8.0 Hz, 1H), 8.08 (d, J=8.0 Hz, 1H), 7.94 (t, J=8.0 Hz, 1H), 7.77 (t, J=8.0 Hz, 1H), 4.64 (s, 3H), 4.37 (s, 3H), 3.81-3.70 (m, 2H), 3.13-3.08 (m, 2H), 1.96-1.85 (m, 4H). LC-MS m/z: 447 (M⁺).

### Example 9

An exemplary synthesis of substituted phenanthridine complexes is shown below:

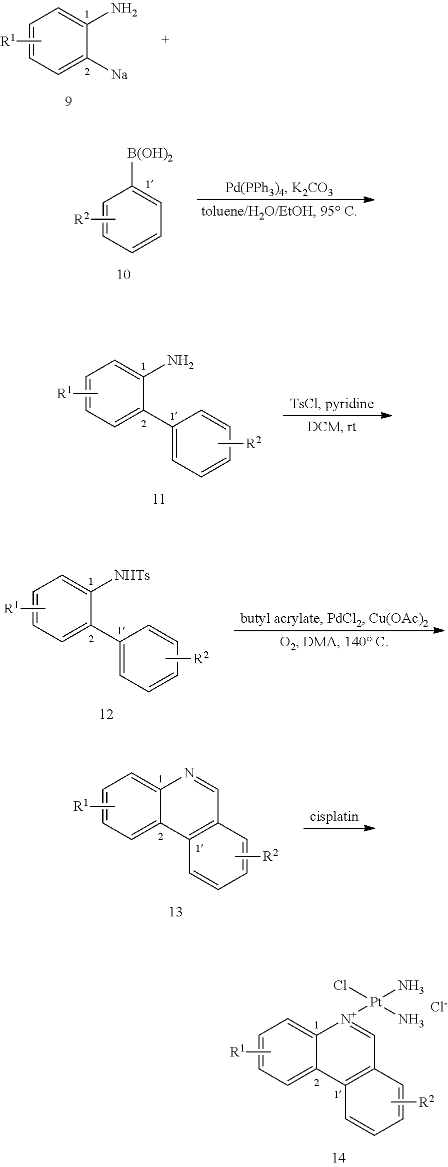

### Synthesis of 11

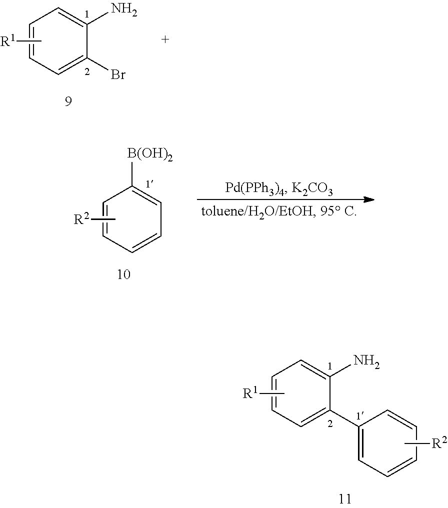

To a solution of 9 (20 mmol) in ethanol (10 mL), water (30 mL), toluene (60 mL), 10 (30 mmol, 1.5 equiv), K₂CO₃ (80 mmol, 4.0 equiv), and Pd(PPh₃)₄ (1 mmol, 0.05 equiv) were added and the resulting mixture was heated at 95° C. for 16 hours. After cooling to room temperature, the biphasic solution was diluted with 30 mL of saturated aqueous NH₄Cl and 30 mL of CH₂Cl₂. The aqueous phase was extracted with an additional 2×30 mL of CH₂Cl₂, and the combined organic layers were washed with 30 mL of water and 30 mL of saturated aqueous NaHCO₃. The organic phase was dried over Na₂SO₄ and filtered. The filtrate was concentrated in vacuo and purified by column chromatography to afford 11.

| 11 | R¹ | R² | LC-MS (m/z: M + H⁺) |
|---|---|---|---|
| 11-1 | 4-F | H | 204 |
| 11-2 | H | 4′-Cl | 188 |
| 11-3 | 5-Cl | H | 204 |
| 11-4 | 5-Me | H | 184 |
| 11-5 | 4-Me | H | 184 |
| 11-6 | H | 4′-Me | 184 |

### Synthesis of 12

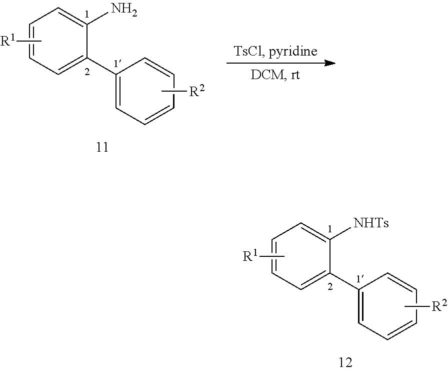

To an oven-dried 100 mL round bottom flask, equipped with a magnetic stir bar, above obtained 11 was added followed by CH₂Cl₂ and pyridine (2 equiv) under N₂. To this mixture, tosylsulfonyl chloride (1.2 equiv) was added and stirred for 16 hours at room temperature. The solution was diluted with 10 mL CH₂Cl₂ and 1 M HCl solution (20 mL). The aqueous phase was extracted with an additional 2×30 mL of CH₂Cl₂, and the combined organic phase was dried over Na₂SO₄ and filtered. The filtrate was concentrated in vacuo and purified by column chromatography to afford 12.

| 12 | R¹ | R² | LC-MS (m/z: M + H⁺) |
|---|---|---|---|
| 12-1 | 4-F | H | 358 |
| 12-2 | H | 4′-Cl | 342 |
| 12-3 | 5-Cl | H | 358 |
| 12-4 | 5-Me | H | 338 |
| 12-5 | 4-Me | H | 338 |
| 12-5 | H | 4′-Me | 338 |

### Synthesis of 13

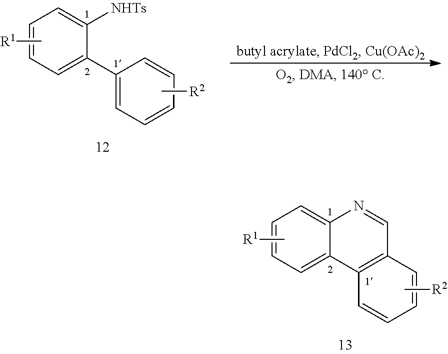

To a schlenk tube were added 12, alkene (3 equiv), PdCl₂ (0.05 equiv), Cu(OAc)₂ (1.5 equiv), and DMA. Then the tube was recharged with O₂ (1 atm), and the mixture was stirred at 140° C. (oil bath temperature) until complete consumption of starting material and monitored by LC-MS analysis. After the reaction was finished, the reaction mixture was diluted in ethyl acetate, and washed with brine. The aqueous phase was re-extracted with ethyl acetate. The combined organic extracts were dried over Na₂SO₄ and concentrated under vacuum, and the resulting residue was purified by column chromatography to afford 13.

| 13 | R¹ | R² | LC-MS (m/z: M + H⁺) |
|---|---|---|---|
| 13-1 | 4-F | H | 477 |
| 13-2 | H | 4′-Cl | 461 |
| 13-3 | 5-Cl | H | 477 |
| 13-4 | 5-Me | H | 457 |
| 13-5 | 4-Me | H | 457 |
| 13-6 | H | 4′-Me | 457 |
| 13-7 | H | 3′,5′-2Me | 471 |
| 13-8 | H | 3′-NMe2, 5′-F | 504 |
| 13-9 | H | 4′-Ph | 519 |
| 13-10 | H | 3′-Ph | 519 |
| 13-11 | 4-Ph | H | 519 |

13-7: ¹H NMR (500 MHz, DMSO): δ 9.82 (s, 1H), 9.78 (d, J=8.5 Hz, 1H), 8.87 (d, J=8.5 Hz, 2H), 8.63 (s, 1H), 7.98 (t, J=8.5 Hz, 1H), 7.86 (t, J=8.5 Hz, 1H), 7.60 (s, 1H), 4.83 (s, 3H), 4.56 (s, 3H), 2.90 (s, 3H), 2.62 (s, 3H).

13-8: ¹H NMR (500 MHz, DMSO): δ 9.60 (d, J=8.5 Hz, 1H), 9.37 (s, 1H), 8.81 (d, J=8.5 Hz, 1H), 7.92 (t, J=8.5 Hz, 1H), 7.76 (t, J=8.5 Hz, 1H), 7.55 (s, 1H), 7.24 (s, 1H), 4.68 (s, 3H), 4.45 (s, 3H), 3.24 (s, 6H).

13-9: ¹H NMR (500 MHz, DMSO): δ 10.05 (s, 1H), 9.79 (d, J=8.5 Hz, 1H), 9.03 (d, J=8.5 Hz, 1H), 8.95 (d, J=8.5 Hz, 1H), 8.80 (d, J=1.0 Hz, 1H), 8.48 (dd, J=8.5 Hz, 1.0 Hz, 1H), 8.02 (s, 1H), 7.95-7.92 (m, 3H), 7.60 (t, J=8.5 Hz, 2H), 7.50 (t, J=8.5 Hz, 1H), 4.78 (s, 3H), 4.59 (s, 3H).

13-10: ¹H NMR (500 MHz, DMSO): δ 9.98 (s, 1H), 9.79 (d, J=8.5 Hz, 1H), 9.20 (s, 1H), 9.15 (d, J=8.5 Hz, 1H), 8.54 (d, J=8.5 Hz, 1H), 8.28 (d, J=8.5 Hz, 1H), 8.08-8.03 (m, 3H), 7.91 (t, J=8.5 Hz, 1H), 7.61 (t, J=8.5 Hz, 2H), 7.55-7.53 (m, 1H), 4.73 (s, 3H), 4.54 (s, 3H).

13-11: ¹H NMR (500 MHz, DMSO): δ 9.94 (s, 1H), 9.85 (d, J=8.5 Hz, 1H), 9.19 (d, J=8.5 Hz, 1H), 9.14 (d, J=2.0 Hz, 1H), 8.47 (d, J=8.5 Hz, 1H), 8.35 (dd, J=8.5 Hz, 2.0 Hz, 1H), 8.18-8.14 (m, 1H), 8.04 (d, J=8.5 Hz, 2H), 7.96 (t, J=8.5 Hz, 1H), 7.61 (t, J=8.5 Hz, 2H), 7.51 (t, J=8.5 Hz, 1H), 4.68 (s, 3H), 4.52 (s, 3H).

### Example 10

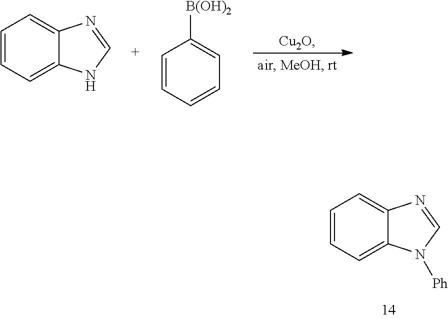 [SMILES: c1ccc2[nH]cnc2c1 ; OB(O)c1ccccc1 ; c1ccc(-n2cnc3ccccc32)cc1]

To a mixture of benzimidazole (0.6 g, 5 mmol) and phenylboronic acid (0.61 g, 1 mmol) in MeOH (10 mL) was added Cu₂O (36 mg, 5 mol %) at room temperature, and the mixture was stirred for 5 h under an atmosphere of air. The mixture was centrifuged and the centrifugate was concentrated under reduced pressure. The crude product was purified by column chromatography on silica gel (hexane/EtOAc: 70/30) to afford 14 as a colorless oil. LC-MS m/z 195 (M+1).

### Synthesis of 15

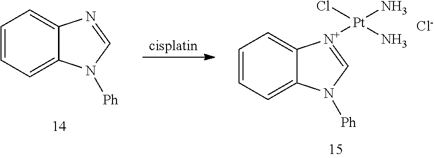

To a solution of cisplatin (0.15 g, 0.5 mmol) in 5 mL DMF was added AgNO₃ (0.085 g, 0.5 mmol), and the reaction was stirred under protection from light for 16 h at room temperature. The formed precipitate was removed by filtration, 14 (0.097 g, 0.5 mmol) was added to the above filtrate, and the mixture was stirred for 16 hours at room temperature. The reaction mixture was concentrated under reduced pressure, and the resulting residue was dispersed in 20 mL MeOH, the yellow solid was removed by filtration. The filtrate was purified by prep-HPLC (eluting with CH3CN/dilute HCl) to afford 15 as a white solid: ¹H NMR (500 MHz, DMSO): δ 9.20 (s, 1H), 8.21 (d, J=8.0 Hz, 1H), 7.76 (d, J=8.0 Hz, 2H), 7.73-7.68 (m, 3H), 7.63-7.62 (m, 1H), 7.54-7.50 (m, 2H), 4.59 (s, 3H), 4.41 (s, 3H). LC-MS m/z: 458 (M⁺). LC-MS Purity (254 nm): >97%; t_{R}=1.38 min.

### Example 11

### Synthesis of 16

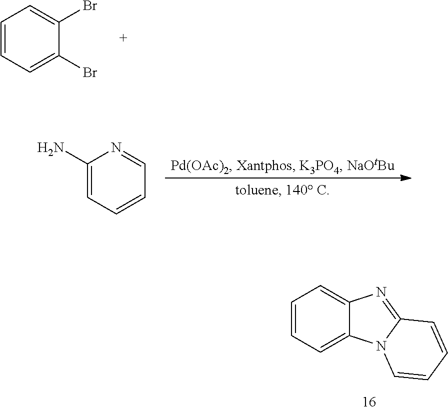 [SMILES: Brc1ccccc1Br ; Nc1ccccn1 ; c1ccc2c(c1)nc1ccccn12]

A mixture of 1,2-dibromobenzene (590 mg, 2.5 mmol), 2-aminopyridine (282 mg, 3.0 mmol), Pd(OAc)₂ (28 mg, 0.125 mmol), Xantphos (73 mg, 0.125 mmol), 4 Å sieve (100 mg), K₃PO₄ (1.06 g, 5 mmol), and t-BuONa (480 mg, 5 mmol) in toluene (10 mL) was stirred at 140° C. for 24 h. The mixture was concentrated to dryness, the residue was purified by flash column chromatography using petroleum ether/CH₂Cl₂/acetone to afford 16 as a white solid (86% yield). LC-MS m/z 169 (M+1).

### Synthesis of 17

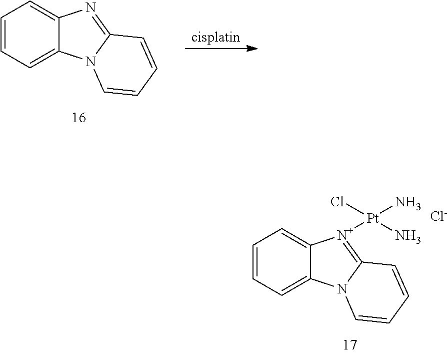

To a solution of cisplatin (0.15 g, 0.5 mmol) in 5 mL DMF was added AgNO₃ (0.085 g, 0.5 mmol), and the reaction mixture was stirred under protection from light for 16 hours at room temperature. The formed precipitate was removed by filtration. 16 (84 mg, 0.5 mmol) was added to the above filtrate, and the mixture was stirred for 16 hours at room temperature. The reaction mixture was concentrated to dryness under reduced pressure, and the resulting residue was dispersed in 30 mL MeOH, insoluble yellow solid was removed by filtration. The filtrate was concentrated and purified by prep-HPLC (eluting with CH₃CN/dilute HCl) to afford 17 as a white solid: ¹H NMR (500 MHz, DMSO): δ 9.32 (d, J=8.0 Hz, 1H), 8.45 (d, J=8.0 Hz, 1H), 8.29 (d, J=8.0 Hz, 1H), 8.23 (d, J=8.0 Hz, 1H), 7.97-7.93 (m, 1H), 7.72 (t, J=8.0 Hz, 1H), 7.54 (t, J=8.0 Hz, 1H), 7.32 (td, J=6.5 Hz, 1.0 Hz, 1H), 4.50 (s, 3H), 4.43 (s, 3H). LC-MS m/z: 432 (M⁺). LC-MS Purity (254 nm): >97%; t_{R}=1.21 min.

### Example 12

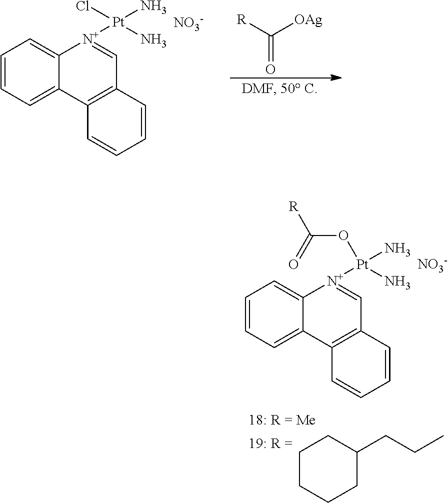

To a solution of phenanthriplatin (150 mg, 3 mmol) in DMF (4 mL) was added the silver salt (2 eq.) and the mixture was heated at 50° C. The reaction was monitored by LC-MS and more silver salt was added to the mixture if necessary. After the starting material disappeared, the solid was removed by filtration. The filtrate was concentrated, the residue was dissolved in MeOH, and the above solution was added to a well-stirred Et₂O solution. The formed solid was filtered and dried to give 18 as a white solid.

18: ¹H NMR (500 MHz, DMSO): δ 9.99 (s, 1H), 9.82 (d, J=8.0 Hz, 1H), 8.96 (d, J=8.0 Hz, 1H), 8.92 (d, J=8.0 Hz, 1H), 8.43 (d, J=8.0 Hz, 1H), 8.16 (t, J=8.0 Hz, 1H), 8.02 (t, J=8.0 Hz, 1H), 7.95 (t, J=8.0 Hz, 1H), 7.91 (t, J=8.0 Hz, 1H), 4.63 (s, 3H), 4.46 (s, 3H), 1.56 (s, 3H). LC-MS m/z: 467 (M⁺). LC-MS Purity (254 nm): >97%; t_{R}=1.31 min.

19: The filtrate was purified by reverse phase flash (eluting with CH₃CN/pure H₂O) to give the target as a white solid: ¹H NMR (400 MHz, DMSO): δ 9.98 (s, 1H), 9.82 (d, J=8.4 Hz, 1H), 9.96 (d, J=8.4 Hz, 1H), 8.92 (d, J=8.4 Hz, 1H), 8.43 (d, J=8.4 Hz, 1H), 8.13 (t, J=8.4 Hz, 1H), 8.01-7.90 (m, 3H), 4.653 (s, 3H), 4.48 (s, 3H), 1.79 (t, J=7.2 Hz, 2H), 1.44-1.33 (m, 3H), 1.13-0.81 (m, 7H), 0.61-0.53 (m, 1H), 0.51-0.48 (m, 2H), 0.25-0.14 (m, 2H). LC-MS m/z: 577 (M⁺). LC-MS Purity (254 nm): >97%; t_{R}=1.64 min.

TABLE 1
The following analogs were prepared analogously to compound 18 starting from common
intermediate phenanthriplatin by using the appropriate carboxylate:

| Compound | Structure | Retention time | Mass |
|---|---|---|---|
| 18-1 | 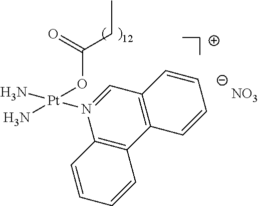 | 1.817 | 634.2, 635.3, 636.3 |
| 18-2 | 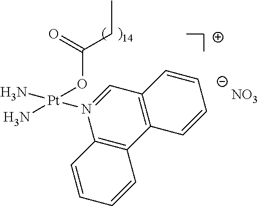 | 1.918 | 662.3, 663.3, 664.3 |
| 18-3 | 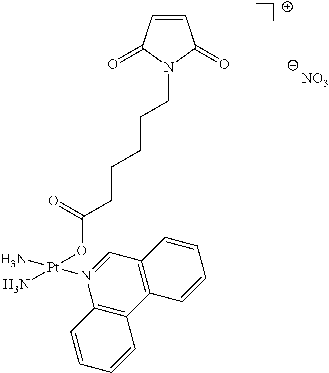 | 1.435 | 617., 618.2, 619.2 |
| 18-4 | 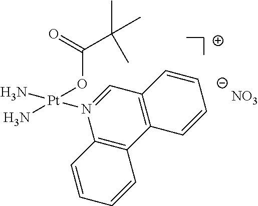 | 3.45 (B) | 491.6, 492.6, 493.6 |
| 18-5 | 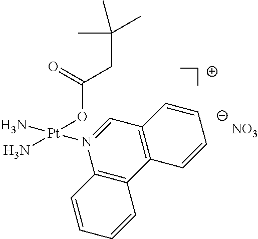 | 3.44 (B) | 505.6, 506.6, 507.6 |

Method A: Mobile Phase: A: water (0.01% TFA) B: ACN (0.01% TFA); Gradient: 5%-95% B in 1.4 min; Flow Rate: 2.3 ml/min, 3.2 min run; Column: SunFire C18, 4.6*50 mm, 3.5 um; Oven Temperature: 50° C.
Method B: Mobile Phase: A: water (0.01% TFA) B: ACN (0.01% TFA); Gradient: 5%-95% B in 6.0 min; Flow Rate: 2.3 ml/min, 7.0 min run; Column: SunFire C18, 4.6*50 mm, 3.5 um; Oven Temperature: 50° C.

### Example 13

### Synthesis of 20

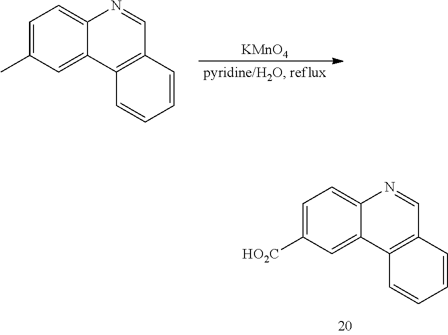 [SMILES: Cc1ccc2ncc3ccccc3c2c1 ; "KMnO4" ; O=C(O)c1ccc2ncc3ccccc3c2c1]

To a stirred solution of 2-methylphenanthridine (0.48 g, 2.5 mmol) in a mixture of 10 ml of pyridine and 10 ml of water at 90° C. to 95° C. was added potassium permanganate (0.79 g, 5 mmol) in portions, and the reaction mixture was further stirred at the same temperature. The reaction was monitored by LC-MS. More potassium permanganate was added to make sure the starting material was consumed. The mixture was filtered while hot, and the by-product manganese dioxide was washed thoroughly with hot water. The combined filtrates were concentrated under reduced pressure, and the residue was dissolved in water and extracted by ethyl acetate two times. The pH of the aqueous layer was adjusted with dilute HCl to pH=7. The precipitated white solid was collected by filtration and dried to give 20. LC-MS m/z 224 (M⁺+1).

### Synthesis of 21

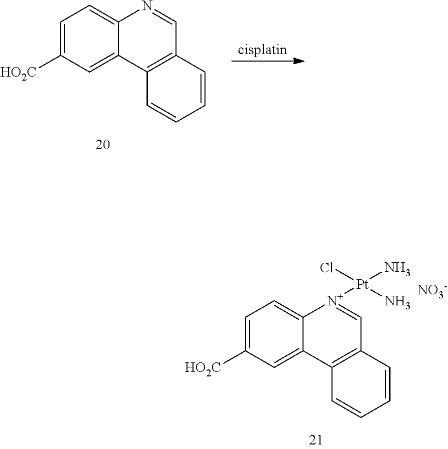

To a solution of cisplatin (0.15 g, 0.5 mmol) in 5 mL DMF was added AgNO₃ (0.085 g, 0.5 mmol), and the reaction was stirred for 16 hours under protection from light at room temperature. The formed precipitate was removed by filtration and 20 (0.5 mmol) was added to the above filtrate. The reaction was stirred for 16 hours at room temperature. The reaction mixture was concentrated under reduced pressure. The resulting residue was dispersed in 20 mL MeOH and the insoluble yellow solid cisplatin was removed by filtration. The filtrate was concentrated to about 5 mL of volume, and was added dropwise to a stirred solution of ether. The formed white solid was collected by filtration and dried thoroughly under reduced pressure to afford 21: ¹H NMR (500 MHz, DMSO): δ 13.60 (s, 1H), 10.06 (s, 1H), 9.85 (d, J=8.5 Hz, 1H), 9.37 (s, 1H), 9.03 (d, J=8.5 Hz, 1H), 8.52 (d, J=8.5 Hz, 1H), 8.48 (d, J=8.5 Hz, 1H), 8.20 (t, J=8.5 Hz, 1H), 8.00 (t, J=8.5 Hz, 1H), 4.58 (s, 3H), 4.47 (s, 3H). LC-MS m/z: 487 (M⁺). LC-MS Purity (214 nm): >97%; t_{R}=1.27 min.

### Example 14

Compound 22 of the Formula (X):

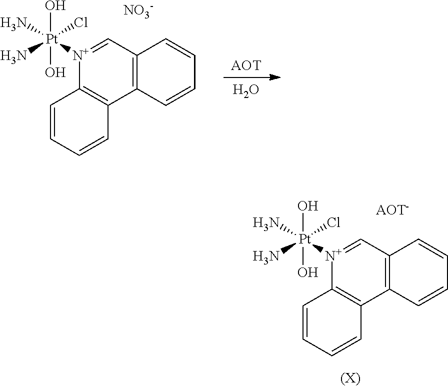

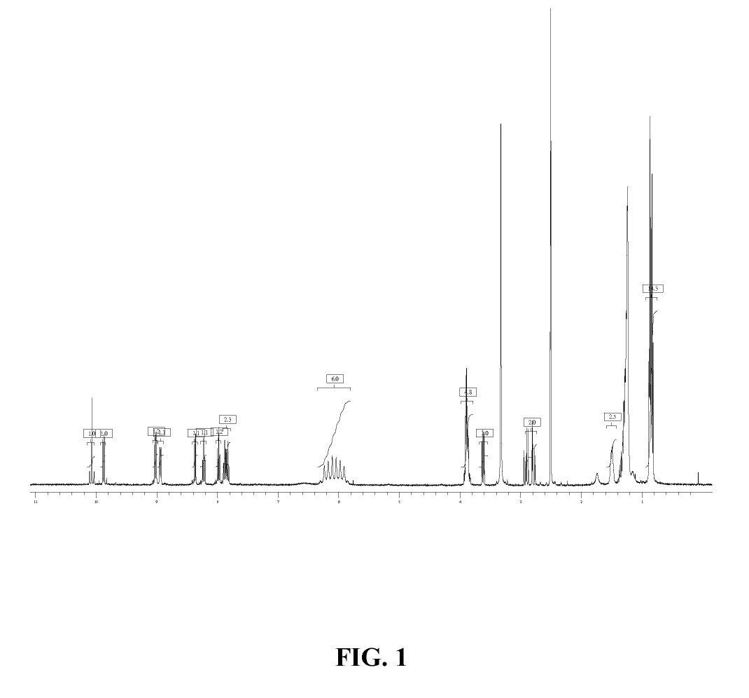

Dihydroxyphenanthriplatin (50 mg, 0.09 mmol) dissolved in water (10 mL) and sodium bis(2-ethylhexyl) sulfosuccinate (AOT, 41 mg, 0.09 mml) dissolved in water (4.5 mL) were combined and stored at 4° C. for 16 hours. A white precipitate was formed and the solution was centrifuged (5000 rpm) to yield a pellet. The liquid was decanted and the pellet washed with water (10 mL). The suspension was centrifuged to give a solid pellet. The solid material was then dried under high vacuum at 40° C. for 48 hours to yield the desired salt (76 mg, 0.08 mmol, 88% yield) (See FIG. 1). LCMS: Rt=2.56 minutes M⁺ (477), 425, 390, 180.

### Example 15

Compound 23 of the Formula (XI):

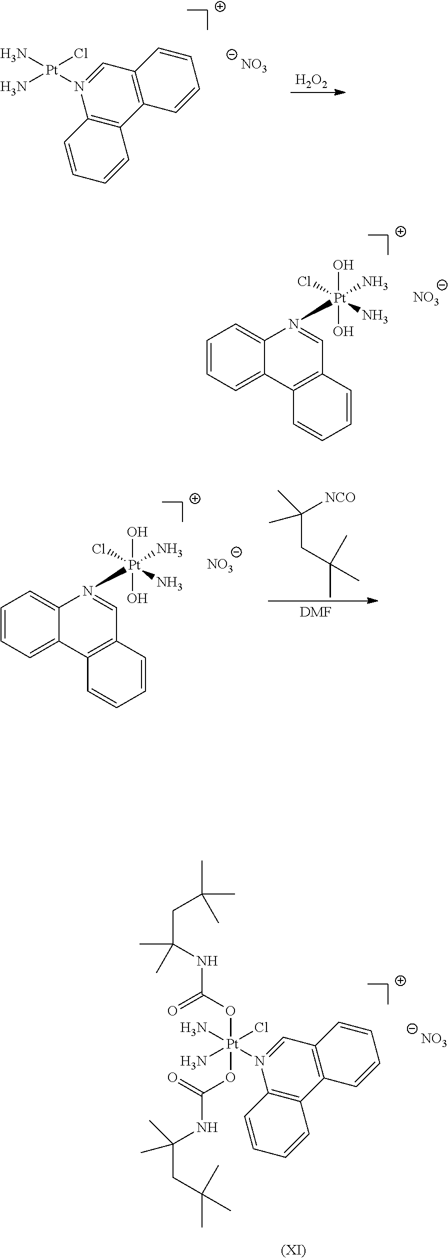

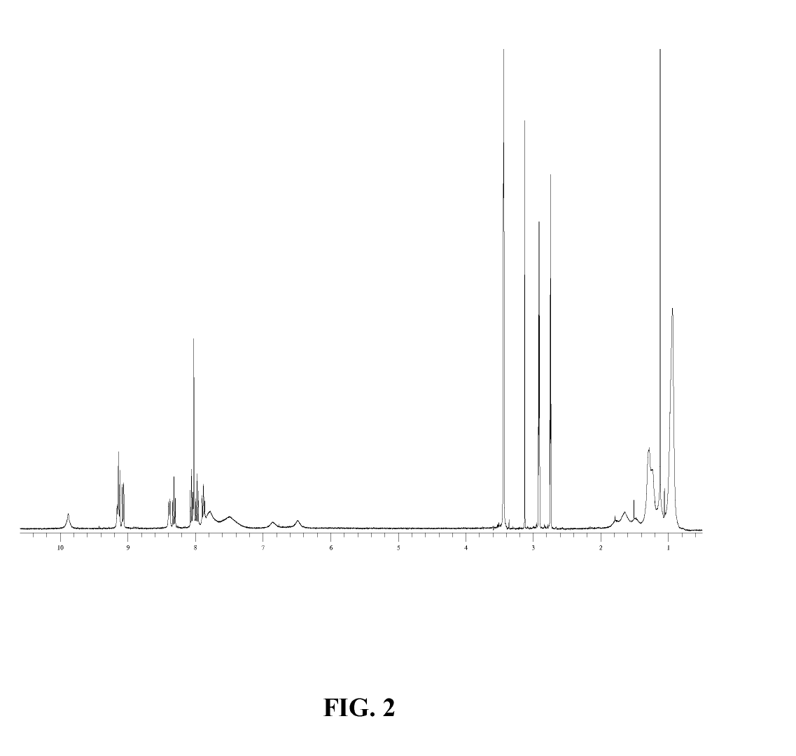

Phenanthriplatin (837 mg, 1.65 mmol) was suspended in hydrogen peroxide solution (30%, 5 mL) and warmed to 30° C. for 5 hours. An additional 0.5 mL of hydrogen peroxide (50%) was added and the suspension stirred for 16 hours. To the suspension was added isopropanol (8 mL) and the mixture was cooled to 4° C. for 20 hours. The solid material was isolated by filtration and dried under high vacuum at 40° C. for 16 hours to yield (700 mg, 1.3 mmol) of dihydroxyphenanthriplatin (LCMS: Rt 2.56° M⁺477). The dihydroxy product was suspended in dimethyl formamide (10 mL) and 2-isocyanato-2,4,4-trimethylpentane (0.5 mL, 2.74 mmol) was added. The solution was stirred for 16 hours and then an additional quantity of 2-isocyanato-2,4,4-trimethylpentane (0.25 mL, 1.37 mmol) was added and the reaction stirred for an additional 16 hours. The solvent was removed under vacuum and 0.5 mL of methanol was added to dissolve the residue and tert-butylmethylether (15 mL) was added. The mixture was stored at 4° C. for 3 days to give a solid that was isolated by filtration. The solid was dried at 40° C. under high vacuum for 2 days to give 660 mg of the desired product (0.8 mmol, 48% yield for 2 steps) (See FIG. 2). LCMS Rt 6.3° MH⁺ 788.

TABLE 2
The following analogs were prepared analogously to compound 23 starting from
common intermediate dihydroxyphenanthriplatin by using the appropriate isocyanate:

| Compound | Structure | Retention time | Mass |
|---|---|---|---|
| 23-1 | 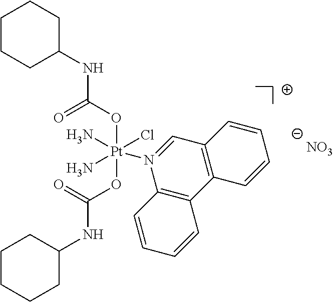 | 1.598 | 726.2, 727.2, 728.2 |
| 23-2 | 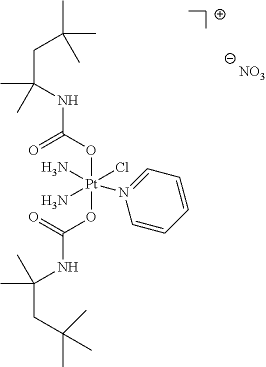 | 4.16 (B) | 686.8, 687.8, 688.8 |

Method A: Mobile Phase: A: water (0.01% TFA) B: ACN (0.01% TFA); Gradient: 5%-95% B in 1.4 min; Flow Rate: 2.3 ml/min, 3.2 min run; Column: SunFire C18, 4.6*50 mm, 3.5 um; Oven Temperature: 50° C.
Method B: Mobile Phase: A: water (0.01% TFA) B: ACN (0.01% TFA); Gradient: 5%-95% B in 6.0 min; Flow Rate: 2.3 ml/min, 7.0 min run; Column: SunFire C18, 4.6*50 mm, 3.5 um; Oven Temperature: 50° C.

### Example 16

Compound 24 of Formula (XII):

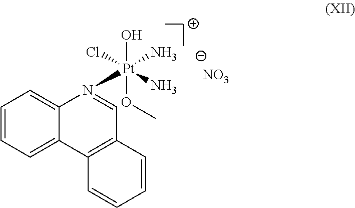

Phenanthriplatin nitrate (505 mg, 1.00 mmol) was weighed in a 50 mL round bottom flask and suspended in 15 mL of anhydrous MeOH. The solution was sonicated to provide a fine suspension and mCPBA (344 mg, 2.00 mmol, 2.00 equiv) was then added. The reaction mixture was stirred at room temperature for 1 h. Solvent was evaporated to dryness, then set under vacuum. The crude solid was suspended in MeOH (30 mL) and the precipitate was filtered using a glass frit (medium). The resulting filtrate was concentrated under reduced pressure and then put under high vacuum to provide the desired product as an off-white precipitate (251 mg). The precipitate was suspended in MeOH (30 mL), the suspension was sonicated and the precipitate was filtered off. The filtrate was concentrated under reduced pressure to provide an additional 47 mg of desired product. The two crops were combined (298 mg, 54% yield). Analyses: The product was characterized by ¹H NMR in d₇-DMF. Also LCMS was used and product gave a peak Rt of 3.11 minutes and (MH)⁺ at 492.

TABLE 3
The following analogs were prepared analogously to compound 24
starting from appropriate intermediate phenanthriplatin by using the appropriate alcohol:

| Compound | Structure | Retention time | Mass |
|---|---|---|---|
| 24-1 | 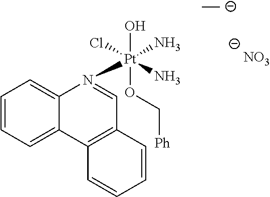 | 1.328 | 568.0, 569.0, 570.0 |
| 24-2 | 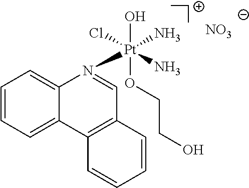 | 1.297 | 522.0, 523.0, 524.0 |

Mobile Phase: A: water (0.01% TFA) B: ACN (0.01% TFA); Gradient: 5%-95% B in 1.4 min; Flow Rate: 2.3 ml/min, 3.2 min run; Column: SunFire C18, 4.6*50 mm, 3.5 um; Oven Temperature: 50° C.

### Example 17

Compound 25 of Formula (XIII):

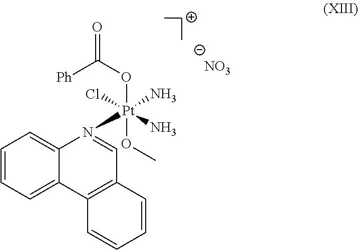

Hydroxy,methoxy-phenanthriplatin nitrate (55 mg, 0.10 mmol) was weighed in a 4 mL vial and dissolved in 1.0 mL of anhydrous DMF. Benzoic anhydride (45 mg, 0.20 mmol, 2 equiv) was added and the reaction mixture was stirred at room temperature for 2 h. The solution was added onto TBME (10 mL) and the resulting precipitate was filtered. The crude solid was dissolved in minimal amount of MeOH and the solution was added onto TBME (10 mL). The precipitate was filtered using a glass frit (medium) and dried under high vacuum to provide the desired product as an off-white precipitate (44 mg, 67% yield). Analyses: LCMS was used and product gave a peak Rt of 4.31 minutes and (MH)⁺ at 596.

TABLE 4
The following analogs were prepared analogously to compound 25 starting from appropriate
intermediate alkoxy, hydroxy-phenanthriplatin by using the appropriate anhydride or isocyanate:

| Compound | Structure | Retention time | Mass |
|---|---|---|---|
| 25-1 | 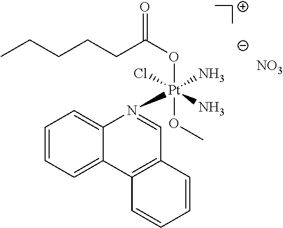 | 1.495 | 588.2, 589.2, 590.2 |
| 25-2 | 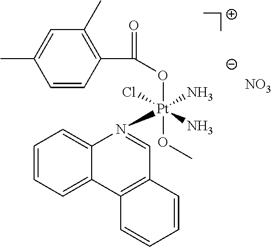 | 1.511 | 621.3, 622.3, 623.2 |
| 25-3 | 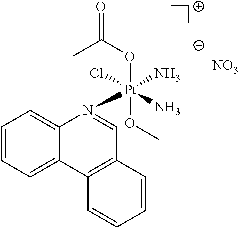 | 1.324 | 532.1, 533.1, 534.1 |
| 25-4 | 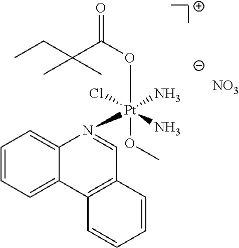 | 1.480 | 588.2, 589.2, 590.2 |
| 25-5 | 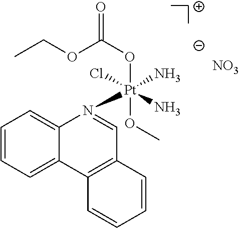 | 1.357 | 562.2, 563.2, 564.0 |
| 25-6 | 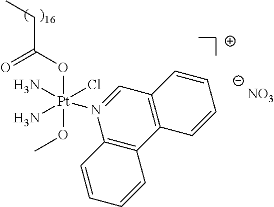 | 2.038 | 756.3, 757.3, 758.3 |
| 25-7 | 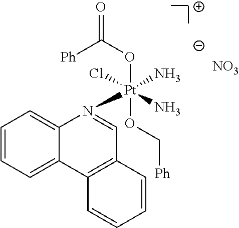 | 1.583 | 670.1, 671.1, 672.1 |
| 25-8 | 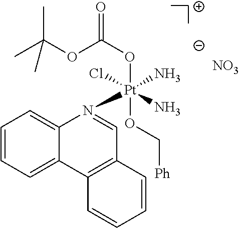 | 1.798 | 666.0, 667.0, 668.0 |
| 25-9 | 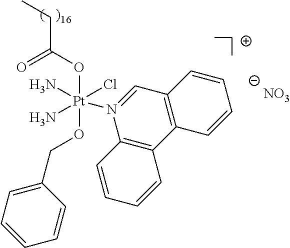 | 2.383 | 832.0, 833.0, 834.0 |
| 25-10 | 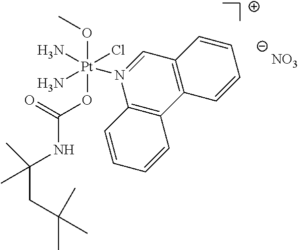 | 1.596 | 644.8, 645.8, 646.8 |
| 25-11 | 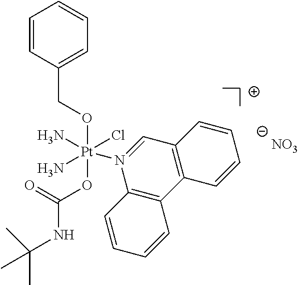 | 1.469 | 589.2, 590.2, 591.2 |
| 25-12 | 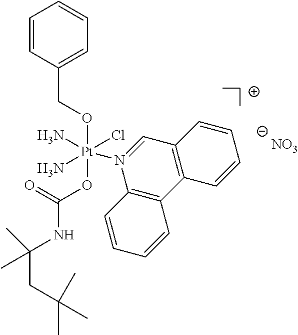 | 1.820 | 720.9, 721.9, 722.9 |
| 25-13 | 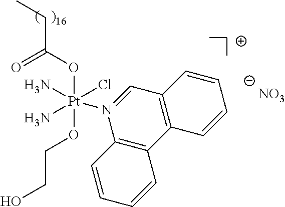 | 2.382 | 786.2, 787.2, 788.2 |
| 25-14 | 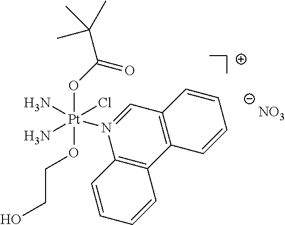 | 3.58 (B) | 604.5, 605.5, 606.5 |
| 25-15 | 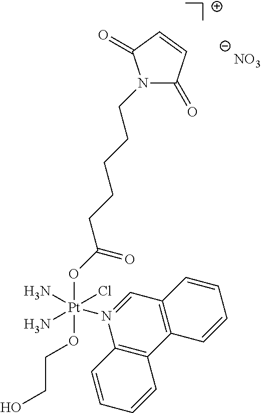 | 1.492 | — |

Method A: Mobile Phase: A: water (0.01% TFA) B: ACN (0.01% TFA); Gradient: 5%-95% B in 1.4 min; Flow Rate: 2.3 ml/min, 3.2 min run; Column: SunFire C18, 4.6*50 mm, 3.5 um; Oven Temperature: 50° C.
Method B: Mobile Phase: A: water (0.01% TFA) B: ACN (0.01% TFA); Gradient: 5%-95% B in 6.0 min; Flow Rate: 2.3 ml/min, 7.0 min run; Column: SunFire C18, 4.6*50 mm, 3.5 um; Oven Temperature: 50° C.

TABLE 5
The following analogs were prepared analogously to compound 25 starting from common
intermediate dihydroxy-phenanthriplatin by using the appropriate anhydride:

| Compound | Structure | Retention time | Mass |
|---|---|---|---|
| 25-16 | 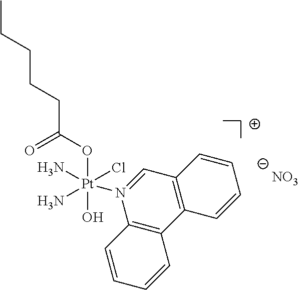 | 1.681 | 574.0, 571.0, 572.0 |
| 25-17 | 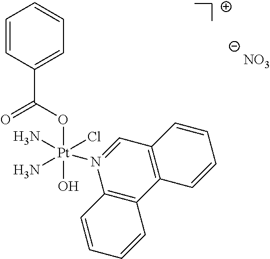 | 1.398 | 579.1, 580.1, 581.1 |
| 25-18 | 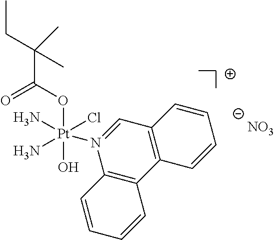 | 1.048 | 573.8, 574.8, 575.8 |
| 25-19 | 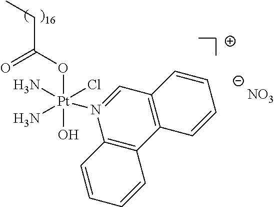 | 2.388 | 741.9, 742.9, 743.9 |

Method A: Mobile Phase: A: water (0.01% TFA) B: ACN (0.01% TFA); Gradient: 5%-95% B in 1.4 min; Flow Rate: 2.3 ml/min, 3.2 min run; Column: SunFire C18, 4.6*50 mm, 3.5 um; Oven Temperature: 50° C.

TABLE 6
The following analogs were prepared analogously to compound 25 starting from appropriate
intermediate carboxylate, hydroxy-phenanthriplatin by using the appropriate isocyanate:

| Compound | Structure | Retention time | Mass |
|---|---|---|---|
| 25-20 | 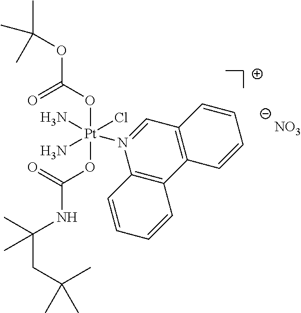 | 1.613 | 730.8, 731.8, 732.8 |
| 25-21 | 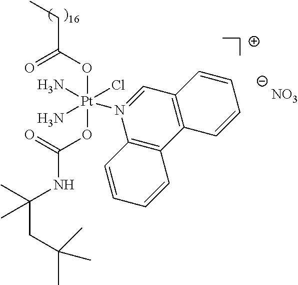 | 1.745 | — |
| 25-22 | 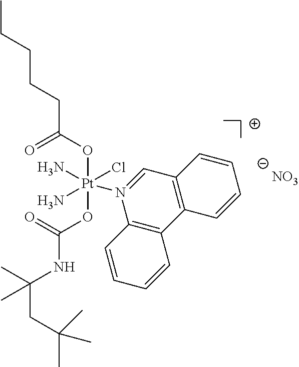 | 1.337 | 729.0, 729.9, 731.0 |
| 25-23 | 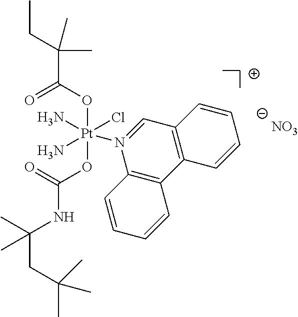 | 1.860 | 728.9, 729.9, 730.9 |
| 25-24 | 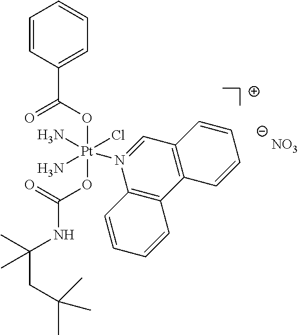 | 1.297 | 735.0, 735.9, 736.9 |
| 25-25 | 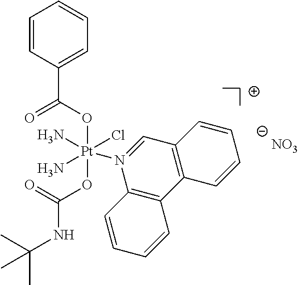 | 1.559 | 679.1, 680.1, 681.1 |
| 25-26 | 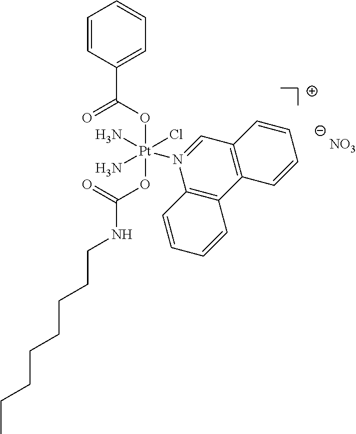 | 1.787 | 734.8, 735.8, 736.8 |

Method A: Mobile Phase: A: water (0.01% TFA) B: ACN (0.01% TFA); Gradient: 5%-95% B in 1.4 min; Flow Rate: 2.3 ml/min, 3.2 min run; Column: SunFire C18, 4.6*50 mm, 3.5 um; Oven Temperature: 50° C.

### Example 18

Compound 26 of Formula (XIV):

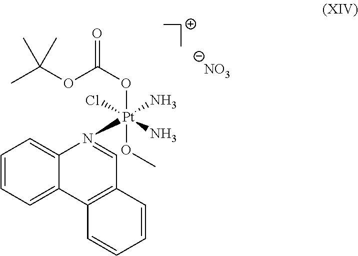

Methoxy, hydroxy-phenanthriplatin nitrate (194 mg, 0.350 mmol) was weighed in a 4 mL vial and dissolved in 2.0 mL of anhydrous DMF. Di-tert-butyl carbonate (153 mg, 0.700 mmol, 2.00 equiv) was added and the reaction mixture was stirred at 40° C. for 4 h. The solution was added onto TBME (25 mL) and the resulting precipitate was filtered. The crude solid was dissolved in minimal amount of MeOH and the solution was added onto TBME (25 mL). The precipitate was filtered using a glass frit (medium) and dried under high vacuum to provide the desired product as an off-white precipitate (160 mg, 70% yield). Analyses: LCMS was used and product gave a peak Rt of 4.15 minutes and (MH)⁺ at 592.

### Example 19

Compound 27 of Formula (XVI):

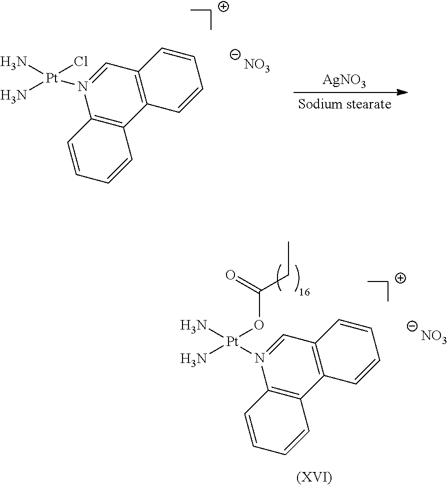

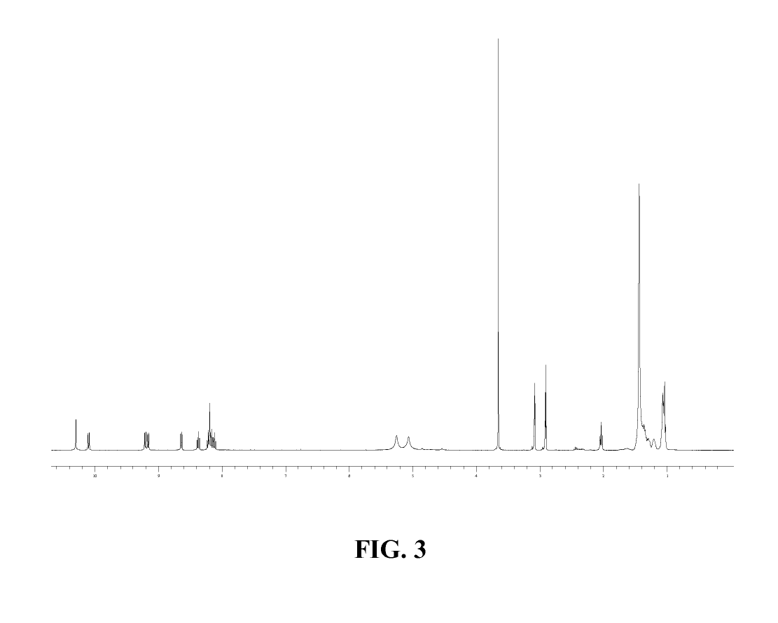

Phenanthriplatin (300 mg, 0.6 mmol) and silver nitrate (144 mg, 0.85 mmol, 1.4×) were suspended in DMF (10 mL) and stirred at 55° C. protected from light, under nitrogen, for 16 hours. The solution was filtered to remove AgCl using a 0.2 μm syringe filter. The vial and filter were washed with DMF (3 mL). The filtrate was added to solid sodium stearate (183 mg, 0.6 mmol) and the solution was heated at 55° C. for 16 hours overnight. The solvent was then removed under reduced pressure at 38° C. The residue was suspended in methanol (15 mL) and cooled to 4° C. The solid was filtered and dried under high vacuum at 40° C. for 16 hours to give 315 mg (0.45 mmol, 76% yield) of the desired product (See FIG. 3). LCMS: Rt=7.66 minutes M⁺ (692), 674, 391, 180.

### Example 20

For cell seeding, a complete medium was prepared by adding fetal bovine serum (FBS) and the appropriate additives and mixing gently. The culture medium was removed and discarded using a vacuum pump. The cell layer was briefly rinsed with 0.25% (w/v) trypsin-0.038% (w/v) EDTA solution to remove all traces of serum that contains trypsin inhibitor. A trypsin-EDTA solution (3.0 mL) was added to a flask and the cells were observed under an inverted microscope until the cell layer is dispersed. 8.0 mL of complete growth medium was added and cells were aspirated by gentle pipetting. The cell suspension was transferred to a centrifuge tube and centrifuged at 800-1000 rpm for 3-5 minutes. The supernatant was discarded using a vacuum pump. An appropriate volume of complete medium was added, and the cell pellet was suspended by gentle pipetting. The cell numbers were counted and the cells were adjusted to the appropriate concentration. 1004 of cell suspension was added to 96-well white-walled clear bottom plates and placed in the CO₂ incubator overnight.

For compound plate preparation and addition, compounds were prepared from 2 mM DMSO stock with 3-fold dilution (200-fold of the final concentration). About 0.5 to 1 uL of the compound was transferred from the compound plates to the cell plates. The plates were incubated for the indicated time at 37° C. To prepare the reagents, the CellTiter-Glo Buffer was thawed and equilibrated to room temperature prior to use. The lyophilized CellTiter-Glo substrate was equilibrated to room temperature prior to use. The appropriate volume of CellTiter-Glo Buffer was transferred into the amber bottle containing the CellTiter-Glo substrate to reconstitute the lyophilized enzyme/substrate mixture to form the CellTiter-Glo Reagent. The CellTiter-Glo Reagent was mixed by gently vortexing, swirling or by inverting the contents to obtain a homogeneous solution. The CellTiter-Glo Substrate went into solution easily in less than one minute.

For the luminescence measurement, the cell morphology was observed under an inverted microscope. The plate and its contents were equilibrated to room temperature for approximately 30 minutes. 100 μL of CellTiter-Glo Reagent was added to the assay plate. The contents were mixed for 2 minutes on an orbital shaker to induce cell lysis. The plate was allowed to incubate at room temperature for 10 minutes to stabilize luminescent signal. The clear bottom was pasted with white back seal and the luminescence was recorded with Flexstation3. The settings were: Luminescence, integration time 500 ms.

Each of the compounds below has an IC₅₀ (A549 CTG) value between 0.01 and 50 μM. Some of the compounds below each has an IC₅₀ (A549 CTG) value between 0.1 and 10 μm.

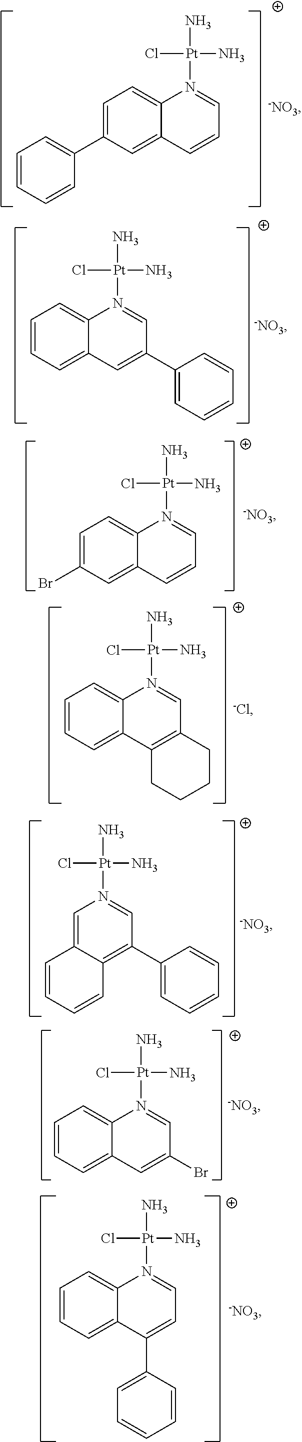

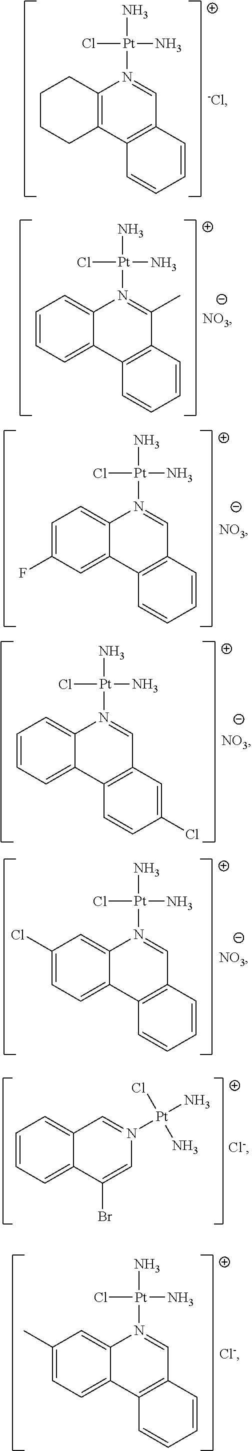

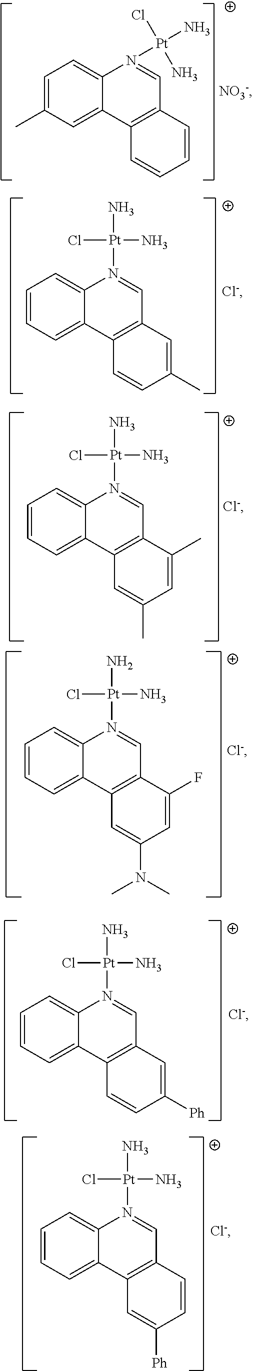

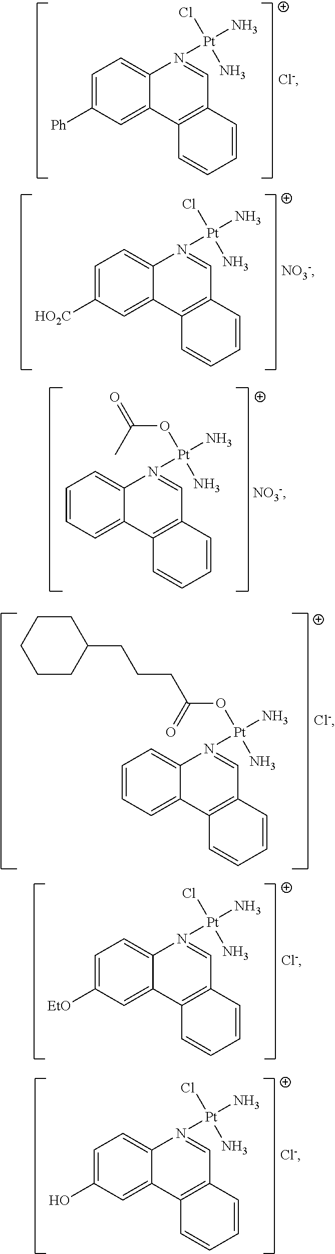

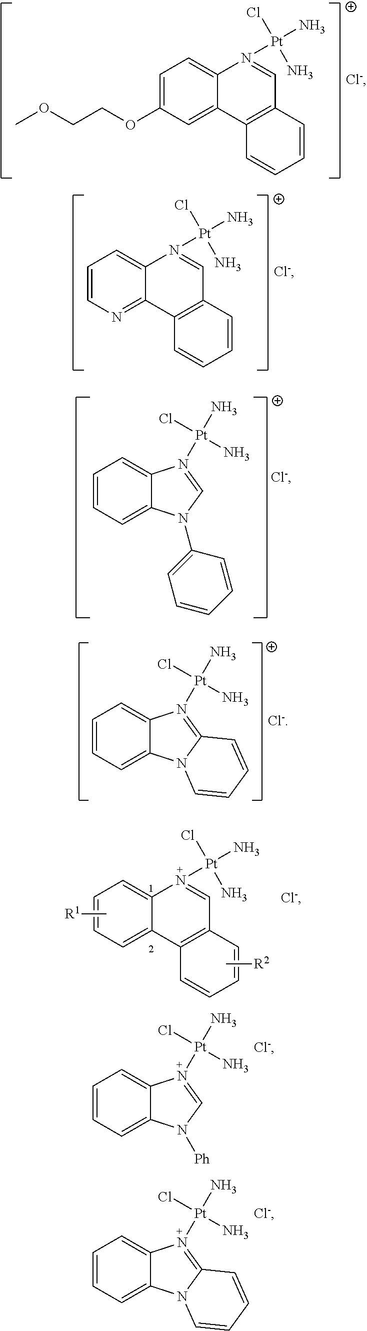

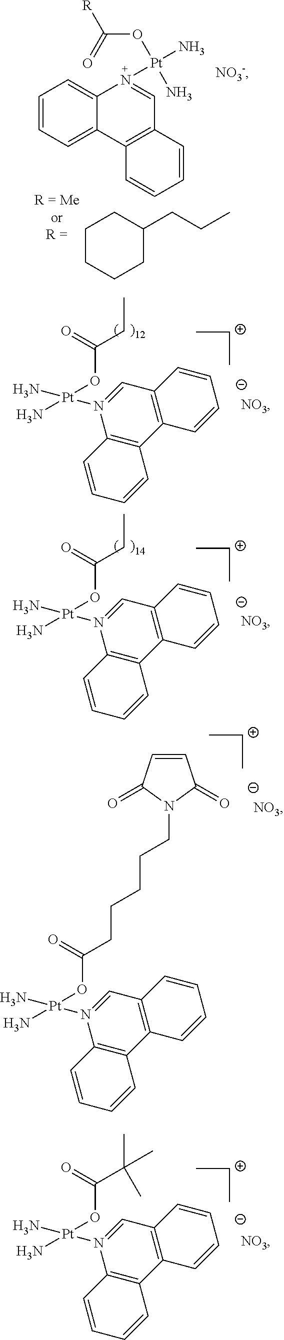

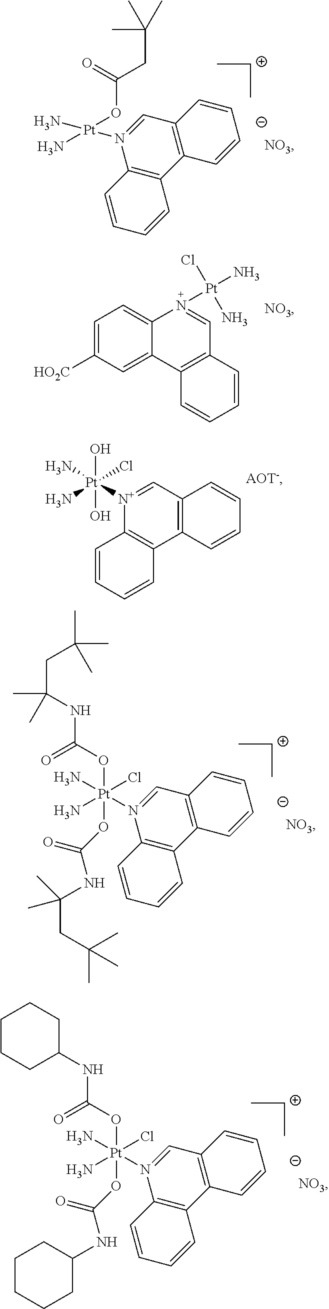

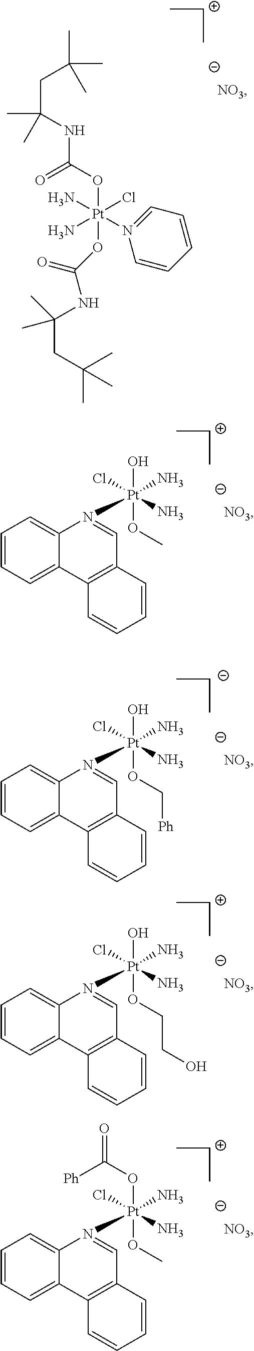

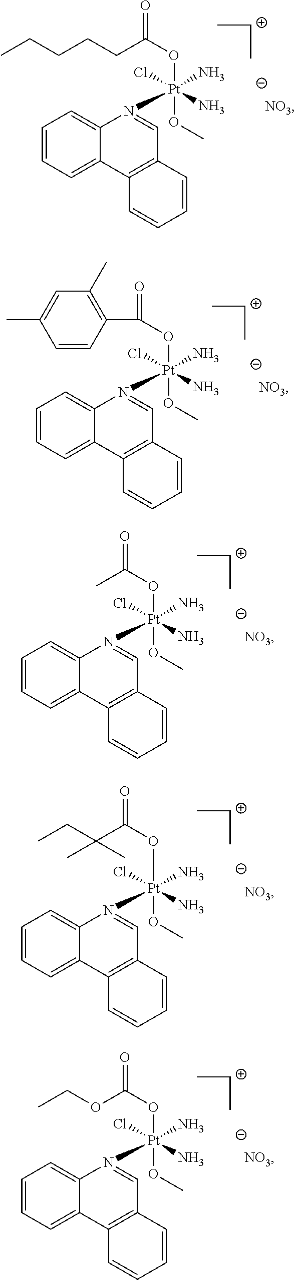

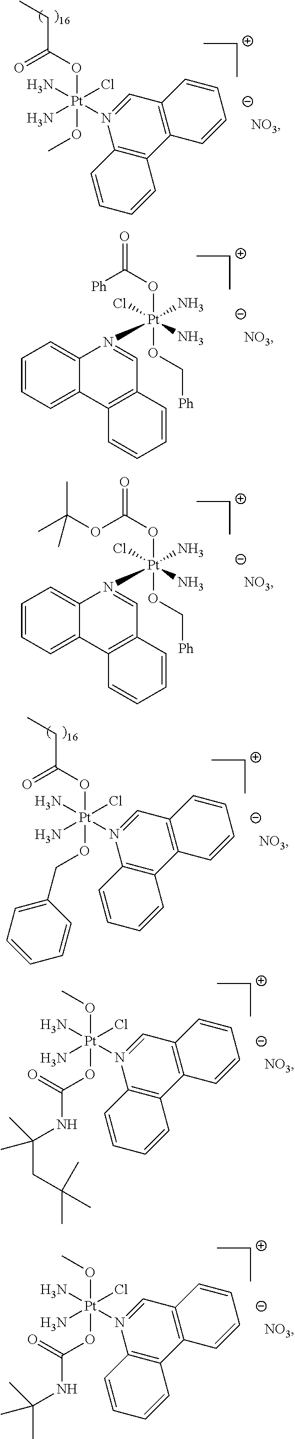

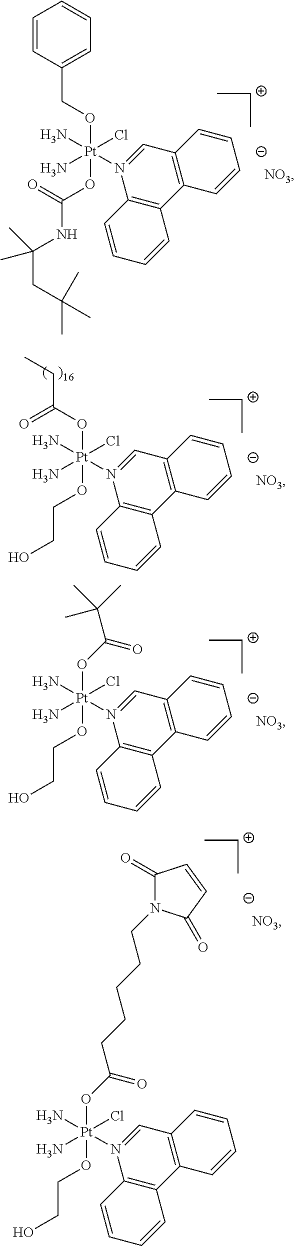

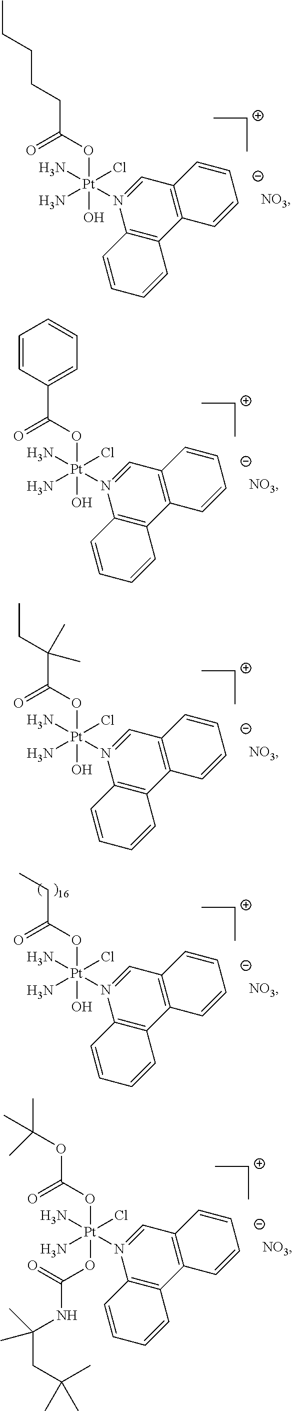

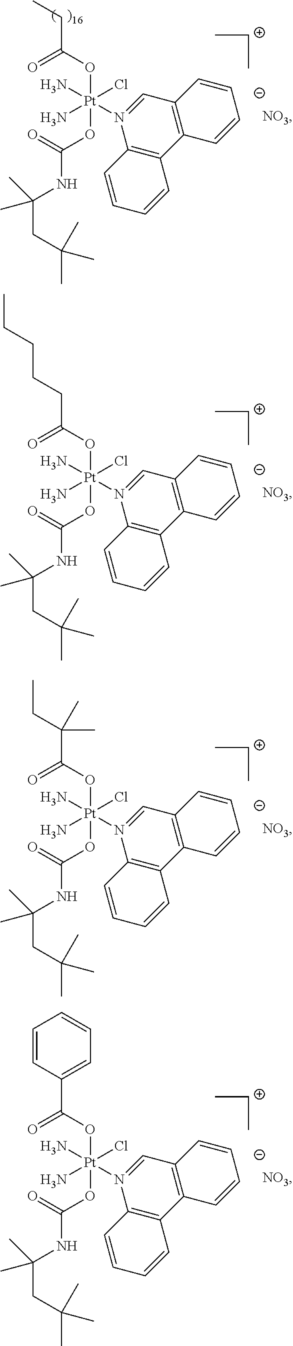

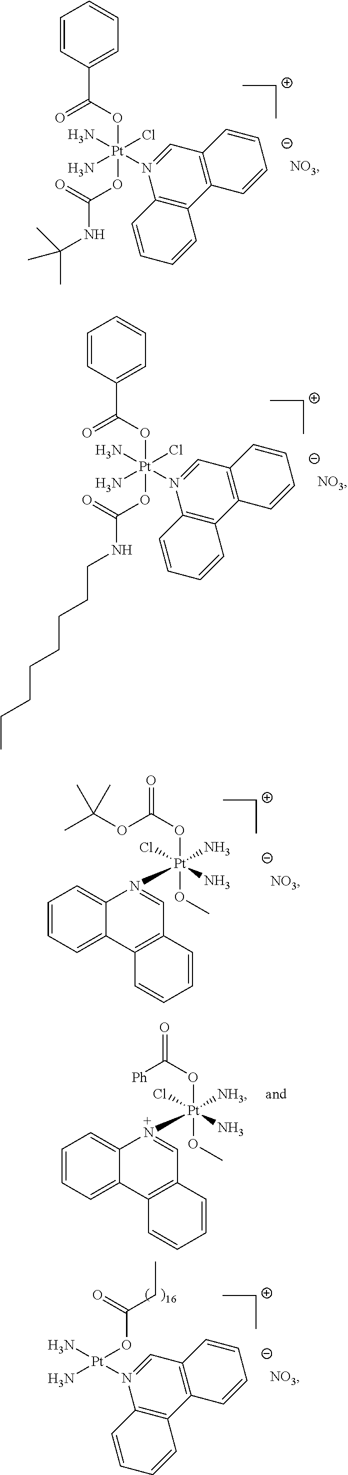

### Example 21

Nanoparticle formulation of compound of Formula XI. Nanoparticles were prepared by homogenizing oil in water emulsion which was subsequently purified via tangential flow filtration (TFF). The oil phase consisted of the drug and a mixture of 40% PLA and 60% PLAmPEG. The molecular weight (MW) of the non-PEGylated portion was 108 kD and the MW of the PEGylated component was 35 kD with a 5 kD PEG chain. The polymers were dissolved in ethyl acetate to achieve a total polymer concentration of 50 mg/mL and compound of Formula XI was added to achieve a 5.1% w/w compound of Formula XI content relative to the total solid content. The oil phase was then slowly added to the aqueous phase containing 0.1% w/v polysorbate 80 and mixed by a rotor-stator homogenizer to form a course emulsion (10/90% v/v oil/water). The course emulsion was then processed through a high-pressure homogenizer (operated at 10,000 psi for 2 passes) to form a nanoemulsion. The nanoemulsion was hardened by quenching (10-fold dilution in deionized water) to form a nanoparticle suspension, which was then concentrated and purified with deionized water using tangential flow filtration (500 kDa MWCO membrane).

In vitro properties of the nanoparticle suspension are summarized in Table 7. Particle size (Z-ave) and the polydispersity index (PDI) were characterized by dynamic light scattering. The actual drug load was determined by gravimetric analysis: 1 mL of the nanoparticle suspension was transferred to a 4 mL glass vial and dried under vacuum (rotary evaporator) to remove the dispersion medium (water and residual solvents from the process). The total amount of solids was determined based on the weights of the empty vial and the vial containing the dried sample. Drug content was then determined by graphite furnace atomic absorption spectroscopy. Encapsulation efficiency was calculated as the ratio between the actual and theoretical drug load.

TABLE 7

| | |
|---|---|
| Particle Size (Z-Ave) (nm) | 84 |
| PDI | 0.14 |
| Encapsulation Efficiency (%) | 60 |
| Drug Load (%) | 3 |

In another example, compound of Formula XI was emulsified in the same polymer solution (50 mg/ml 40% PLA₁₀₈: 60% PLA₃₅mPEG₅ in ethyl acetate) with varying aqueous phases. In these examples, small batches were made using a sonicating bath to mix the coarse emulsion and then subsequently forming the fine emulsion using an ultrasonic probe. The following Table 8 shows the characteristics of these nanosuspensions post-washing via centrifugal units.

TABLE 8

| | Aqueous phase (10%) | | | | | |
|---|---|---|---|---|---|---|
| | 0.1% | 0.2% | 0.1% | 1% Sodium | 0.1% | 0.1% Tween |
| | Tween 80 | PVA | Tween 80 | Cholate | Tween 80 | 80 in Saline |
| Z-ave, nm | 105 | 133 | 107 | 103 | 84 | 145 |
| PDI | 0.15 | 0.12 | 0.10 | 0.18 | 0.14 | 0.13 |
| Target drug load (TDL), % | 5.7 | 5.7 | 5.7 | 5.7 | 5.1 | 5.1 |
| Actual drug load (ADL) (%) | 4.3 | — | 2.1 | 3.1 | 3.3 | — |
| Encapsulation Efficiency, | 75 | — | 37 | 54 | 65 | — |
| EE2 (%) | | | | | | |

### Example 22

Nanoparticle formulation of compound of Formula XVI. Replacing the chloride ligand by stearate presents a new opportunity to encapsulate the phenantriplatin cation in a polymeric nanoparticle. The presence of the stearate increases the hydrophobicity of the molecule decreasing drastically its aqueous solubility from 5 mg/mL to below 0.1 mg/mL. The saturated solubility in ethyl acetate (EA) remains low which could be due to the formation of reverse self-associated structures or phase separation similar to the cloud point observed for nonionic surfactants due to the amphiphilic nature of the new molecule. However, the compound can be solubilized at 1.5 mg/mL in an organic phase containing up to 80-90% ethyl acetate and 40-80 mg/mL PL(G)A-PEG using dimethyl formamide (DMF) and benzyl alcohol (BA) as co-solvents separately or in a mixture. One way to prepare such oil phase is to presolubilize phenantriplatin stearate in 50/50 mixture of BA/DMF and mix with 50-100 mg/mL solution of the polymer in EA. Inorganic electrolyte and undissolved compound that may be present are removed by short centrifugation at 5000×g. The rest of the nanoparticle preparation process follows the procedure described in the examples above. In brief, the oil phase is premixed with an aqueous phase containing an emulsifier such as polysorbate 80 to form the coarse emulsion which is then subjected to ultrasound (2 mL scale) or high pressure homogenization (>20 mL scale) to prepare the nanoemulsion. The latter is quenched to harden the nanoparticles by 5 or 10 fold dilution with deionized cold water that may or may not contain surfactants. The nanoparticle suspension is then purified (washed)/concentrated by tangential flow filtration (TFF) at 4-8° C. (cold) or at 20-25° C. (warm) and stored refrigerated or frozen with 10% sucrose. Following this procedure phenantriplatin stearate was successfully encapsulated in the following polymers or polymer mixtures: (1) PLA₁₀₉mPEG₅; (2) 7525PLGA₁₅mPEG₅; (3) PLA₁₅mPEG₅; (4) 56% PLA₁₀₅:44% PLA₁₅mPEG₅; (5) PLA₅₇. The in-vitro and in-vivo properties of representative nanoparticle suspensions are summarized in Table 9 below. Particle size (z.ave) and the polydispersity index (PDI) were characterized by dynamic light scattering. The actual drug load was determined by gravimetric analysis: 1 mL of the nanoparticle suspension was transferred to a 4 mL glass vial and dried under vacuum at 40° C. to remove the dispersion medium (water and residual solvents from the process). The total amount of solids was determined based on the weights of the empty vial and the vial containing the dried sample. Total platinum content was determined using graphite furnace atomic absorption spectroscopy (GFAAS) and used to calculate the actual drug loading. The encapsulation efficiency (EE) was calculated as the ratio between the actual and theoretical drug load. The yield was calculated based on the ratio between the recovered drug and the amount used to prepare the emulsion. In-vitro drug release was characterized by dialysis of 1 mL of the nanoparticle suspension in water across a 1000 kDa MWCO membrane against 60 mL PBS (phosphate buffered saline) containing 0.1% CTAB (cetyl trimethyl ammonium bromide, cationic surfactant). The samples were continuously mixed in a shaking water bath for 48 h at 37° C. and analyzed for total platinum content using GFAAS. The in-vivo behavior of the nanoparticles was studied in a pharmacokinetic (PK) rat study. The nanoparticle suspensions in 10% sucrose were injected intravenously via a tail vein injection at 1 mg/kg and the total concentration of the drug (encapsulated and released drug) in the plasma was determined as a function of time. The area under the curve was extrapolated to infinity (AUC_{inf}) to determine the total exposure to the drug which is an integral measure of the nanoparticle circulation time and the decrease in the rate of drug release.

High encapsulation efficiency (>50%) was achieved in most of the cases. Particle size was varied between 40 and 90 nm depending on the polymer type and emulsion composition (presence or absence of emulsifier). The smallest particle size was achieved with 7525PLGA₁₅mPEG₅ in presence of 0.2% solution of polysorbate 80 (Tween 80). Based on preliminary observations, the oil phase (10% BA/10% DMF/80% EA) used to prepare 7525PLGA₁₅mPEG₅ has the tendency to disperse readily in the form of a nano-emulsion upon mixing with the aqueous phase which is 0.2% solution of polysorbate 80. In-vitro dissolution did not show significant differences between the drug release, however, the in-vivo exposure (AUC_{inf}) varied from 10 to 200 depending on the polymer type and the purification step (wash temperature and presence or absence of surfactant). Properties of polymeric nanoparticles with encapsulated phenantriplatin (stearate) nitrate:

TABLE 9

| | Polymer | | | | | |
|---|---|---|---|---|---|---|
| | | | | | | 56% PLA₁₀₅ |
| | | | 7525PLGA₁₅ | 7525PLGA₁₅ | 7525PLGA₁₅ | 44% PLA₁₅ |
| | PLA₁₀₉mPEG₅ | PLA₁₅mPEG₅ | mPEG₅ | mPEG₅ | mPEG₅ | mPEG₅ |
| z. ave (nm) | 78 | 77 | 40 | 64 | 77 | 88 |
| PDI | 0.11 | <0.2 | 0.15 | 0.14 | <0.2 | 0.19 |
| Target drug load (%) | 3.3 | 4.8 | 3.3 | 4.8 | 4.8 | 5.0 |
| Actual drug load (%) | 2.0 | 4.3 | 2.7 | 4.1 | 1.1 | 1.8 |
| Encapsulation | 60 | 90 | 82 | 88 | 22.9 | 36 |
| efficiency (%) | | | | | | |
| Emulsifier/Stabilizer | 0.2% Tween 80 | None | 0.2% Tween 80 | None | None | Phospholipid |
| Nanoparticle wash | Cold | Warm | Cold | Warm | Warm/ | Warm/ |
| | | | | | Surfactant | Surfactant |
| Release at 1 h (%) | 2 | 7.3 | NA | 7.3 | NA | 6.6 |
| Release at 24 h (%) | 66 | 81 | NA | 65 | NA | 85 |
| AUC_{inf} (μM/L · h) | 12 | 58 | 10 | 116 | 202 | NA |
| (Rat PK) | | | | | | |

*Exposure in rat PK study presented as the area under the plasma curve extrapolated to infinity (AUCinf).

### Example 23

Nanoparticle formulation of compound of Formula X. AOT was used to prepare a hydrophobic ion pair of dihydroxyphenantriplatin (PtIV) to explore the possibility of encapsulating phennatriplatin prodrug. Compound of Formula X nanoparticles were prepared with 60% PLA₃₅mPEG₅/40% PLA_{108 polymer} mixture using oil in water single emulsion approach, high pressure homogenization, and purification/concentration with ultrafiltration centrifugal filters. Compound of Formula X was mixed with polymer solutions in ethyl acetate at different target concentrations for at least two hours to prepare the oil phase. The compound dispersed readily in the presence of the polymer but the resulting sample was turbid without visible large particles at the end of the mixing. The sample was then filtered through 0.2 μm PTFE syringe filter to yield a transparent slightly yellow solution. The final concentration of drug was determined based on total platinum present as measured by GFAAS. The emulsion was prepared by slow addition of the oil phase (10%) into the aqueous phase (90%) comprising water containing 0.1% w/v polysorbate 80 or 0.2% w/v polyvinyl alcohol while mixed in an ultrasound bath or using a rotor-stator homogenizer to form a coarse emulsion. The coarse emulsion was then subjected to ultrasound (small scale, 2 mL batches) or passed through a high-pressure homogenizer operated at 10,000 psi for two passes (large scale, 20 mL batches) to form a nanoemulsion. The nanoemulsion droplets were hardened by quenching (5 or 10-fold dilution with cold or room temperature deionized water) to form a nanoparticle suspension, which was then concentrated and purified with deionized water using ultrafiltration centrifugal units (150 kDa MWCO). Target drug loading, polymer content, emulsifier type and concentration were evaluated as potential factors affecting the encapsulation efficiency.

In vitro properties of representative batches of compound of Formula X nanoparticles are summarized in Table 10 below. Particle size (z.ave) and the polydispersity index (PDI) were characterized by dynamic light scattering. The drug content was determined by determining the total platinum content using graphite furnace atomic absorption spectroscopy (GFAAS) and used to calculate the actual drug loading. The encapsulation efficiency was calculated using the actual drug concentrations in the nanosuspension and initial emulsion. The actual drug load was estimated using the calculated encapsulation efficiency and the target drug loading. Characteristics of representative compound of Formula X nanoparticles

TABLE 10

| | Polymer type | | | | | |
|---|---|---|---|---|---|---|
| | 40% PLA108, | | 40% PLA108, | 40% PLA108, | | |
| | 60% PLA35mPEG5 | | 60% PLA35mPEG5 | 60% PLA35mPEG5 | PLA35mPEG5 | |
| Oil | ethyl acetate | | ethyl acetate | ethyl acetate | ethyl acetate | |
| Oil phase fraction (%) | 10 | | 10 | 10 | 10 | |
| Polymer concentration | 50 | | 50 | 10 | 10 | |
| in oil phase, mg/mL | | | | | | |
| Aqueous phase | 0.1% Polysorbate 80 | | 0.2% Polysorbate 80 | 0.2% Polysorbate 80 | 0.2% polyvinyl | |
| (saturated with EA) | | | | | alcohol | |
| Quench with water | x5 | x10 | x5 | x5 | x5 | x10 |
| Target loading | 1.57 | | 0.54 | 7.41 | 7.41 | 7.41 |
| Particle size, z. ave (nm) | 125 | 127 | 98 | 70 | 174 | 173 |
| PDI | 0.12 | 0.06 | 0.06 | 0.1 | 0.023 | 0.019 |
| EE* | 14.9 | 9.9 | 34 | 1.7 | 3.8 | 2.7 |
| Estimated actual drug | 0.23 | 0.15 | 0.18 | 0.13 | 0.28 | 0.20 |
| loading based on EE | | | | | | |

*EE is calculated based on the actual active content in the nanosuspension and initial emulsion
**deionized water

### Example 24

Nanoparticle formulation of compound of Formula XVI. Following the procedure described in Example 22, another approach was developed to encapsulate phenanthriplatin in a composite nanoparticle comprising a mixture of the compound and pegylated phospholipids such as 1,2-distearoyl-sn-glycero-3-phosphoethanolamine-N-[methoxy(polyethylene glycol)-5000] (ammonium salt). It is believed that the anionic pegylated phospholipid and the cationic phenanthriplatin stearate interact with attractive (electrostatic and hydrophobic) interactions that lead to formation of composite nanoparticles. The compound and phospholipid can be solubilized in DMF to create the oil phase and nanoparticle preparation follows the procedure described in the examples above. In brief, the oil phase is premixed with an aqueous phase to form the coarse emulsion which is then subjected to ultrasound (2 mL scale) to prepare the nanoemulsion. The latter is quenched to harden the nanoparticles by 10 fold dilution with deionized cold water. The nanoparticle suspension is then purified/concentrated by 150 kDa Pierce Concentrators and stored refrigerated or frozen with 10% sucrose. Following this procedure phenanthriplatin stearate was successfully encapsulated in one phospholipid. The in-vitro properties of this nanoparticle suspension is summarized in Table 11. Particle size (z.ave) and the polydispersity index (PDI) were characterized by dynamic light scattering. The actual drug load was determined by gravimetric analysis: 0.5 mL of the nanoparticle suspension was transferred to a 4 mL glass vial and dried under vacuum at 40° C. to remove the dispersion medium (water and residual solvents from the process). The total amount of solids was determined based on the weight of the empty vial and the vial containing the dried sample. Total platinum content was determined using graphite furnace atomic absorption spectroscopy (GFAAS) and used to calculate the actual drug loading. The encapsulation efficiency (EE) was calculated as the ratio between the actual and theoretical drug load.

TABLE 11

| | 1,2-distearoyl-sn-glycero-3- |
|---|---|
| | phosphoethanolamine-N- |
| | [methoxy(polyethylene glycol)-5000] |
| | (ammonium salt) |
| z.ave (nm) | 24.3 |
| PDI | 0.21 |
| Target drug load (%) | 11.5 |
| Actual drug load (%) | 7.5 |
| EE (%) | 65 |

### Example 25

Nanoparticle Formulation of Compound 25-13.

Compound 25-13 was encapsulated in 7525PLGA₁₅mPEG₅, PLA₁₅mPEG₅, PLA₃₅mPEG₅, PLA₇₄mPEG₅ and 40% PLA₁₀₅/60% PLA₃₅mPEG₅, following the procedure described in Example 22. In brief, the compound was solubilized in dimethyl formamide (DMF) and mixed with ethyl acetate solution of the polymer to form the oil phase. The oil phase was emulsified in water saturated with ethylacetate in two steps by preparing a coarse emulsion followed by fine emulsion preparation via using an ultrasound probe or a high-pressure homogenizer (such as a microfluidizer). The emulsion was then quenched by 5 or 10 fold dilution with cold water and the nanoparticles were washed using tangential flow filtration and 500 kDa MWCO membranes to remove the residual solvent and the free drug as described in the examples above. The characteristics of the nanoparticles formed are listed in Table 12. Particle size <100 nm and high encapsulation efficiency was achieved.

TABLE 12
(25-13 Nanoparticles)

| | | | | 40% | |
|---|---|---|---|---|---|
| | | | | PLA₁₀₅/60% | |
| Polymer | PLA₁₅mPEG₅ | PLA₃₅mPEG₅ | PLA₁₀₅mPEG₅ | PLA₃₅mPEG₅ | 7525PLA₁₅mPEG₅ |
| z.ave (nm) | 53.5 | 66.9 | 89.2 | 82.8 | 45.1 |
| Target drug | 10 | 10 | 10 | 10 | 10 |
| loading (%) | | | | | |
| Active Drug | 7.5 | 7.7 | 7.8 | 8.5 | 8.5 |
| Loading, % | | | | | |
| EE, % | 75 | 77 | 78 | 85 | 85 |

### Example 26

Nanoparticle Formulation of Compound 25-13.

Compound 25-13 was encapsulated in 7525PLGA₁₅mPEG₅ using a modified nanoprecipitation process. The compound was dissolved in methanol and mixed with acetonitrile solution of the polymer to prepare the organic phase which was then added slowly to the aqueous phase (comprising water) mixed by ultrasound or on a stir plate. Because methanol and acetonitrile are miscible with water, the nanoparticles formed almost immediately after bringing the two phases in contact with each other. The average particle size achieved in the coarse nanosuspension was below 100 nm. To decrease the width of the particle size distribution and attempt reducing of the nanoparticle size the coarse nanosuspension was passed through a high pressure homogenizer. The nanoparticle suspension was diluted 5 or 10 fold with cold water and washed using tangential flow filtration as described in the examples (22-25) above. Small particle size (<50 nm) and high encapsulation efficiency were achieved. The characteristics of representative nanoparticle formulation are summarized in Table 13.

TABLE 13

| Polymer | 7525PLGA₁₅mPEG₅ |
|---|---|
| z.ave (nm) | 34.7 |
| PDI | <0.2 |
| Target drug load (%) | 10 |
| Actual drug load (%) | 8.8 |
| EE (%) | 88 |

While several embodiments of the present teachings have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present teachings. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present teachings is/are used. Those skilled in the art will recognize, or be able to ascertain using no more than routine experimentation, many equivalents to the specific embodiments of the present teachings described herein. It is, therefore, to be understood that the foregoing embodiments are presented by way of example only and that, within the scope of the appended claims and equivalents thereto, the present teachings may be practiced otherwise than as specifically described and claimed. The present teachings are directed to each individual feature and/or method described herein. In addition, any combination of two or more such features and/or methods, if such features and/or methods are not mutually inconsistent, is included within the scope of the present teachings.

The above description of the disclosed embodiments is provided to enable any person skilled in the art to make or use the invention disclosed herein. Various modifications to these embodiments will be readily apparent to those skilled in the art, and the generic principles described herein can be applied to other embodiments without departing from the spirit or scope of the invention. Thus, it is to be understood that the description and drawings presented herein are representative of the subject matter which is broadly contemplated by the present invention. It is further understood that the scope of the present invention is not intended to be limited to the embodiment shown herein but is to be accorded the widest scope consistent with the patent law and the principles and novel features disclosed herein.

Alternative embodiments of the claimed disclosure are described herein. Of these, variations of the disclosed embodiments will become apparent to those of ordinary skill in the art upon reading the foregoing disclosure. The inventors expect skilled artisans to employ such variations as appropriate (e.g., altering or combining features or embodiments), and the inventors intend for the invention to be practiced otherwise than as specifically described herein.

Accordingly, this invention includes all modifications and equivalents of the subject matter recited in the claims appended hereto as permitted by applicable law. Moreover, any combination of the above described elements in all possible variations thereof is encompassed by the invention unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A compound of Formula I: 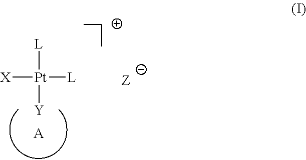
wherein:
X is a halide, sulfonate, sulfate, phosphate, or carboxylate such as stearate;
L each is independently ammonia or an amine;
Y is selected from N, P, and S;
A together with Y form a heteroaromatic optionally substituted with one or more substituents each independently selected from halogen, cyano, nitro, hydroxyl, ester, ether, alkoxy, aryloxy, amino, amide, carbamate, alkyl, alkenyl, alkynyl, aryl, arylalkyl, cycloalkyl, heteroaryl, heterocyclyl, phosphono, phosphate, sulfide, sulfinyl, sulfino, sulfonyl, sulfo, and sulfonamide, wherein each of the ester, ether, alkoxy, aryloxy, amino, amide, carbamate, alkyl, alkenyl, alkynyl, aryl, arylalkyl, cycloalkyl, heteroaryl, heterocyclyl, phosphono, phosphate, sulfide, sulfinyl, sulfino, sulfonyl, sulfo, and sulfonamide is optionally substituted with one or more suitable substituents; and
Z is a pharmaceutically acceptable counter ion.

2. The compound of claim 1, wherein X is a halogen.

3. The compound of claim 1 or claim 2, wherein X is Cl.

4. The compound of claim 1, wherein X is —O(C═O)R^{a} and R^{a} is hydrogen, alkyl, aryl, arylalkyl, or cycloalkyl, wherein each of the alkyl, aryl, arylalkyl, and cycloalkyl is optionally substituted with one or more suitable substituents.

5. The compound of claim 1, wherein X is formyl, acetate, propionate, butyrate, benzoate, or tosylate.

6. The compound of any one of claims 1 to 5, wherein L each is ammonia.

7. The compound of any one of claims 1 to 5, wherein at least one L is an amine.

8. The compound of any one of claims 1 to 7, wherein Y is N.

9. The compound of any one of claims 1 to 8, wherein the heteroaromatic is a monocyclic heteroaromatic, a bicyclic heteroaromatic, or a tricyclic heteroaromatic.

10. The compound of any one of claims 1 to 9 having Formula III or Formula IV: 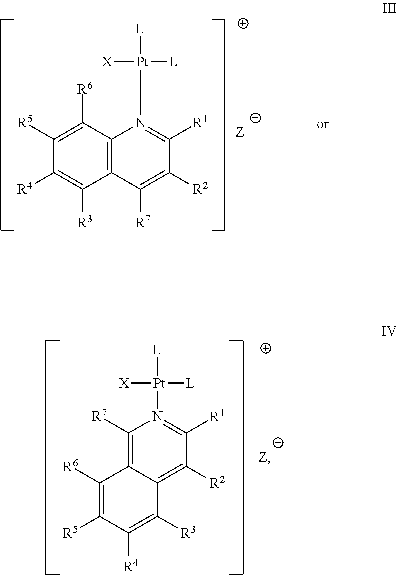
wherein R¹, R², R³, R⁴, R⁵, R⁶, and R⁷ each is independently selected from a group consisting of hydrogen, halogen, cyano, nitro, hydroxyl, ester, ether, alkoxy, aryloxy, amino, amide, carbamate, alkyl, alkenyl, alkynyl, aryl, arylalkyl, cycloalkyl, heteroaryl, heterocyclyl, phosphono, phosphate, sulfide, sulfinyl, sulfino, sulfonyl, sulfo, and sulfonamide, wherein each of the ester, ether, alkoxy, aryloxy, amino, amide, carbamate, alkyl, alkenyl, alkynyl, aryl, arylalkyl, cycloalkyl, heteroaryl, heterocyclyl, phosphono, phosphate, sulfide, sulfinyl, sulfino, sulfonyl, sulfo, and sulfonamide is optionally substituted with one or more suitable substituents; or optionally, two adjacent substituents selected from R¹, R², R³, R⁴, R⁵, R⁶, and R⁷ are connected to form an optionally substituted 5 or 6-membered ring.

11. The compound of claim 10, wherein R¹, R², R³, R⁴, R⁵, R⁶, and R⁷ each is independently selected from a group consisting of hydrogen, halogen, and aryl.

12. The compound of any one of claims 1 to 11 has Formula Ma: 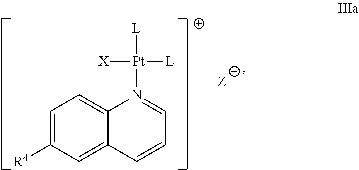
wherein R⁴ is selected from a group consisting of hydrogen, halogen, cyano, nitro, hydroxyl, ester, ether, alkoxy, aryloxy, amino, amide, carbamate, alkyl, alkenyl, alkynyl, aryl, arylalkyl, cycloalkyl, heteroaryl, heterocyclyl, phosphono, phosphate, sulfide, sulfinyl, sulfino, sulfonyl, sulfo, and sulfonamide, wherein each of the ester, ether, alkoxy, aryloxy, amino, amide, carbamate, alkyl, alkenyl, alkynyl, aryl, arylalkyl, cycloalkyl, heteroaryl, heterocyclyl, phosphono, phosphate, sulfide, sulfinyl, sulfino, sulfonyl, sulfo, and sulfonamide is optionally substituted with one or more suitable substituents.

13. The compound of claim 12, wherein R⁴ is halogen or aryl.

14. The compound of any one of claims 1 to 11 having Formula Mb: 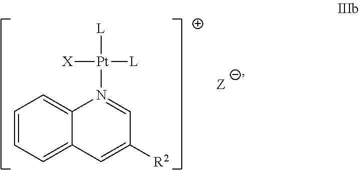
wherein R² is selected from a group consisting of hydrogen, halogen, cyano, nitro, hydroxyl, ester, ether, alkoxy, aryloxy, amino, amide, carbamate, alkyl, alkenyl, alkynyl, aryl, arylalkyl, cycloalkyl, heteroaryl, heterocyclyl, phosphono, phosphate, sulfide, sulfinyl, sulfino, sulfonyl, sulfo, and sulfonamide, wherein each of the ester, ether, alkoxy, aryloxy, amino, amide, carbamate, alkyl, alkenyl, alkynyl, aryl, arylalkyl, cycloalkyl, heteroaryl, heterocyclyl, phosphono, phosphate, sulfide, sulfinyl, sulfino, sulfonyl, sulfo, and sulfonamide is optionally substituted with one or more suitable substituents.

15. The compound of claim 14, wherein R² is halogen or aryl.

16. The compound of any one of claims 1 to 11 having Formula IIIc: 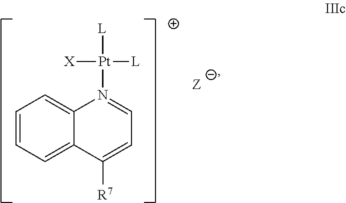
wherein R⁷ is selected from a group consisting of hydrogen, halogen, cyano, nitro, hydroxyl, ester, ether, alkoxy, aryloxy, amino, amide, carbamate, alkyl, alkenyl, alkynyl, aryl, arylalkyl, cycloalkyl, heteroaryl, heterocyclyl, phosphono, phosphate, sulfide, sulfinyl, sulfino, sulfonyl, sulfo, and sulfonamide, wherein each of the ester, ether, alkoxy, aryloxy, amino, amide, carbamate, alkyl, alkenyl, alkynyl, aryl, arylalkyl, cycloalkyl, heteroaryl, heterocyclyl, phosphono, phosphate, sulfide, sulfinyl, sulfino, sulfonyl, sulfo, and sulfonamide is optionally substituted with one or more suitable substituents.

17. The compound of claim 16, wherein R⁷ is halogen or aryl.

18. The compound of any one of claims 1 to 11 having Formula IIId: 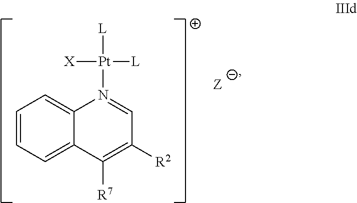
wherein R² and R⁷ are connected to form an optionally substituted 5 or 6-membered ring selected from a group consisting of cycloalkyl, aryl, heteroaryl, and heterocyclyl, wherein each of the cycloalkyl, aryl, heteroaryl, and heterocyclyl is optionally substituted with one or more suitable substituents.

19. The compound of claim 18, wherein R² and R⁷ are connected to form an optionally substituted cycloalkyl.

20. The compound of any one of claims 1 to 11 having Formula IVa: 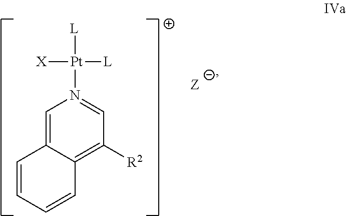
wherein R² is selected from a group consisting of hydrogen, halogen, cyano, nitro, hydroxyl, ester, ether, alkoxy, aryloxy, amino, amide, carbamate, alkyl, alkenyl, alkynyl, aryl, arylalkyl, cycloalkyl, heteroaryl, heterocyclyl, phosphono, phosphate, sulfide, sulfinyl, sulfino, sulfonyl, sulfo, and sulfonamide, wherein each of the ester, ether, alkoxy, aryloxy, amino, amide, carbamate, alkyl, alkenyl, alkynyl, aryl, arylalkyl, cycloalkyl, heteroaryl, heterocyclyl, phosphono, phosphate, sulfide, sulfinyl, sulfino, sulfonyl, sulfo, and sulfonamide is optionally substituted with one or more suitable substituents.

21. The compound of claim 20, wherein R² is halogen or aryl.

22. The compound of any one of claims 1 to 11 having Formula IVb: 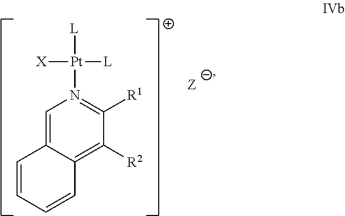
wherein R¹ and R² are connected to form an optionally substituted 5 or 6-membered ring selected from a group consisting of cycloalkyl, aryl, heteroaryl, and heterocyclyl, wherein each of the cycloalkyl, aryl, heteroaryl, and heterocyclyl is optionally substituted with one or more suitable substituents.

23. The compound of claim 22, wherein R¹ and R² are connected to form an optionally substituted cycloalkyl.

24. The compound of any one of claims 1 to 9 having Formula V: 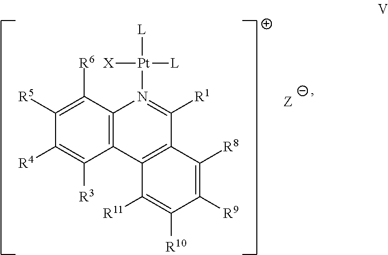
wherein R¹, R³, R⁴, R⁵, R⁶, R⁸, R⁹, R¹⁰, and R¹¹ each is independently selected from a group consisting of hydrogen, halogen, cyano, nitro, hydroxyl, ester, ether, alkoxy, aryloxy, amino, amide, carbamate, alkyl, alkenyl, alkynyl, aryl, arylalkyl, cycloalkyl, heteroaryl, heterocyclyl, phosphono, phosphate, sulfide, sulfinyl, sulfino, sulfonyl, sulfo, and sulfonamide, wherein each of the ester, ether, alkoxy, aryloxy, amino, amide, carbamate, alkyl, alkenyl, alkynyl, aryl, arylalkyl, cycloalkyl, heteroaryl, heterocyclyl, phosphono, phosphate, sulfide, sulfinyl, sulfino, sulfonyl, sulfo, and sulfonamide is optionally substituted with one or more suitable substituents; or optionally, two adjacent substituents selected from R¹, R³, R⁴, R⁵, R⁶, R⁸, R⁹, R¹⁰, and R¹¹ are connected to form an optionally substituted 5 or 6-membered ring.

25. A compound of Formula II, 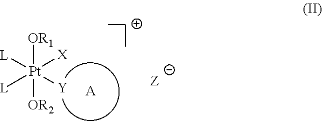
or a salt thereof,
X is a halide, sulfonate, sulfate, phosphate, or carboxylate such as stearate;
L each is independently ammonia or an amine;
Y is selected from N, P, and S;
A together with Y form a heteroaromatic optionally substituted with one or more substituents each independently selected from halogen, cyano, nitro, hydroxyl, ester, ether, alkoxy, aryloxy, amino, amide, carbamate, alkyl, alkenyl, alkynyl, aryl, arylalkyl, cycloalkyl, heteroaryl, heterocyclyl, phosphono, phosphate, sulfide, sulfinyl, sulfino, sulfonyl, sulfo, and sulfonamide, wherein each of the ester, ether, alkoxy, aryloxy, amino, amide, carbamate, alkyl, alkenyl, alkynyl, aryl, arylalkyl, cycloalkyl, heteroaryl, heterocyclyl, phosphono, phosphate, sulfide, sulfinyl, sulfino, sulfonyl, sulfo, and sulfonamide is optionally substituted with one or more suitable substituents;
Z is a pharmaceutically acceptable counter ion;
and R¹ and R² individually is a hydrogen, alkyl, alkenyl, alkynyl, heteroalkyl, heteroalkenyl, heteroalkynyl, aryl, heteroalkyl, carbamoyl, and carbonyl, each optionally substituted, or are absent.

26. A compound selected from a group consisting of:

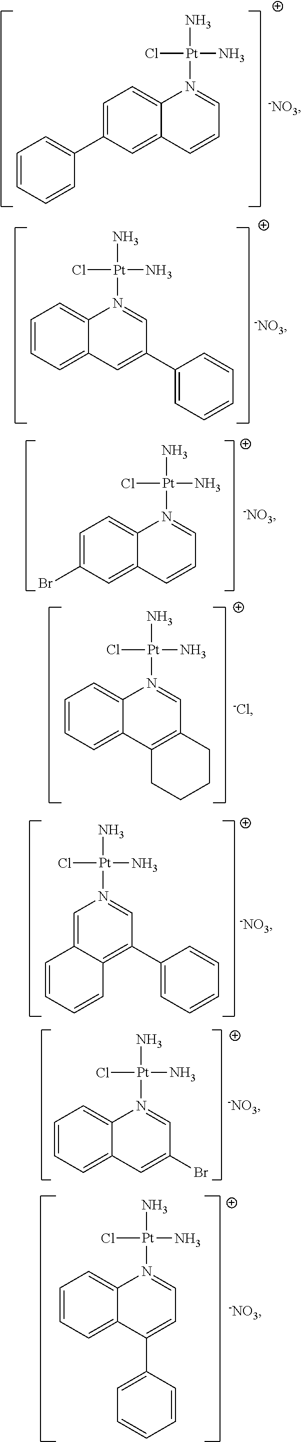

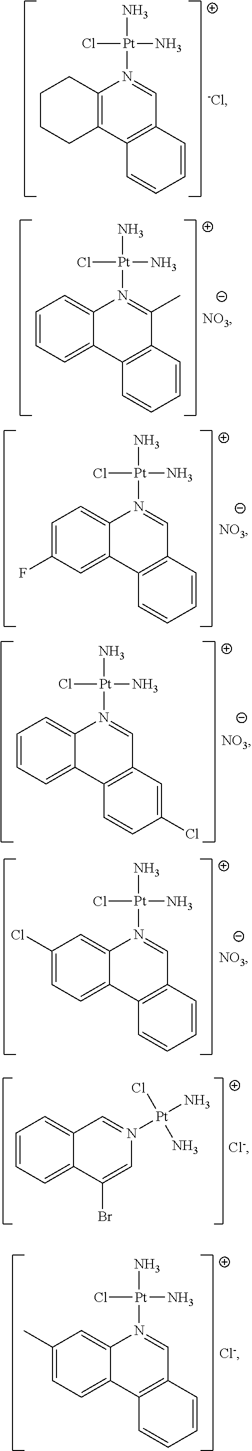

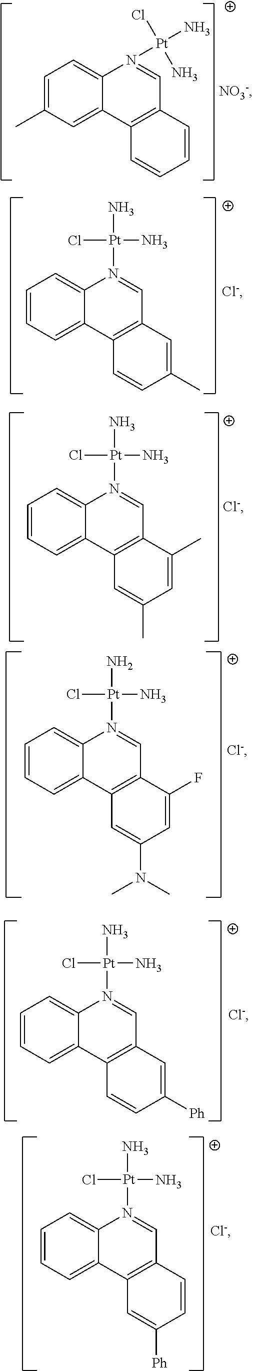

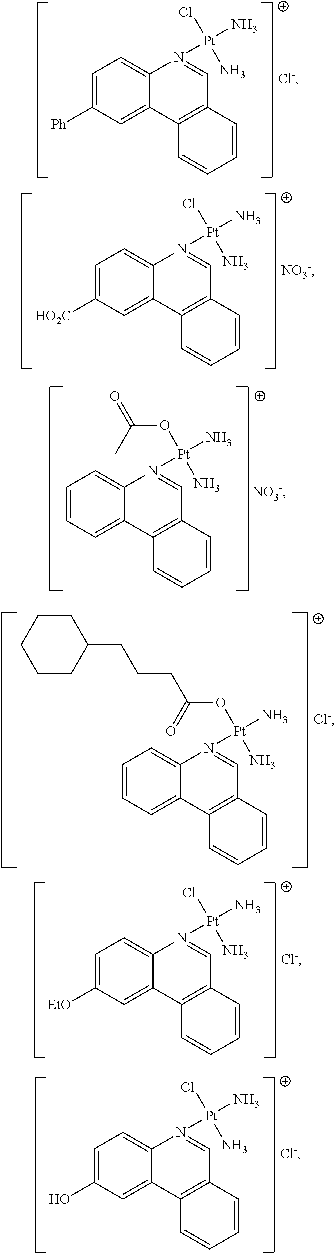

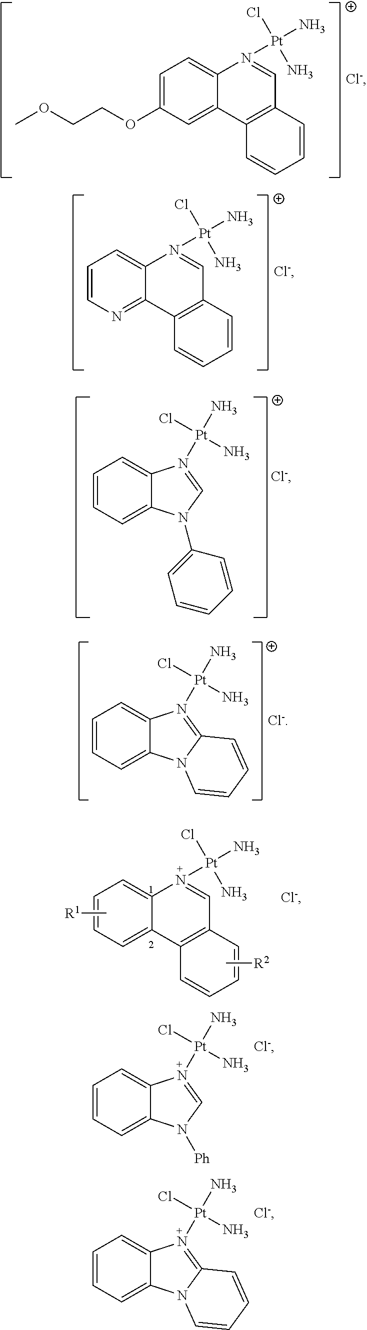

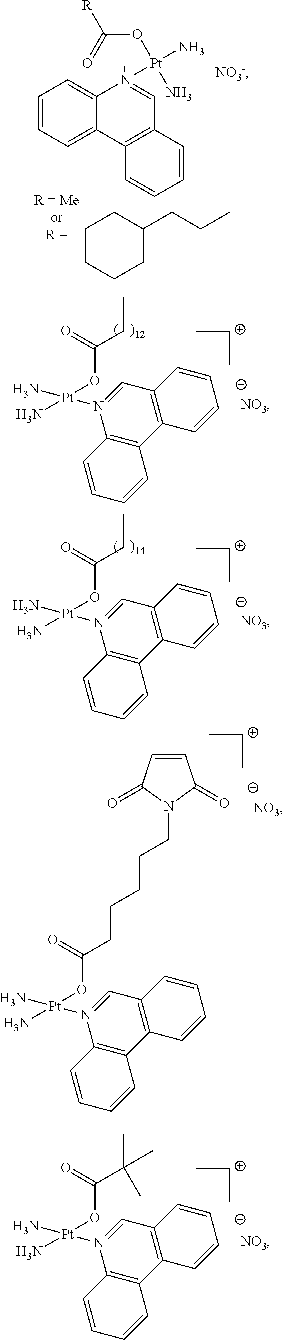

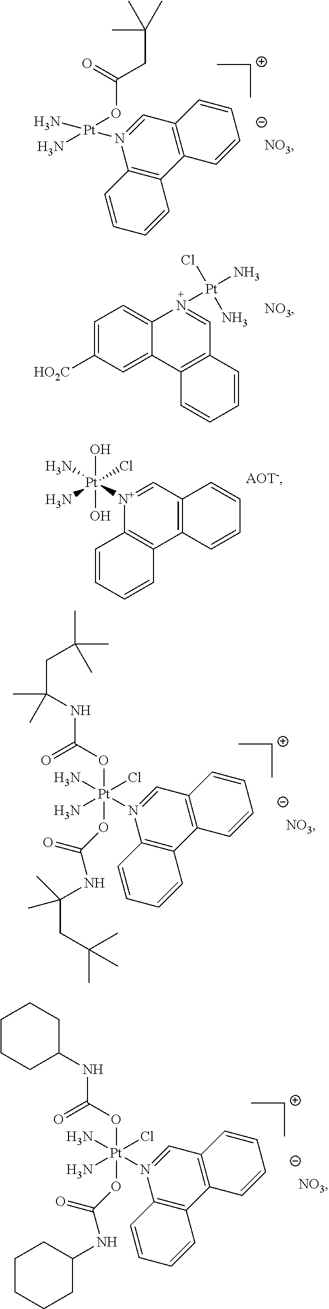

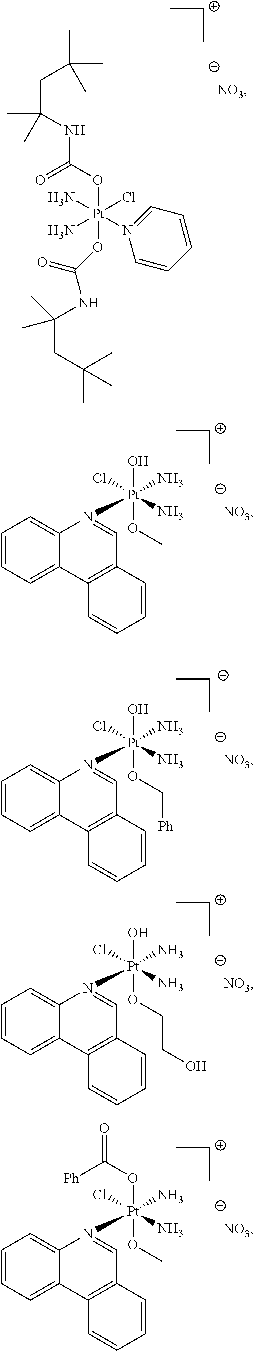

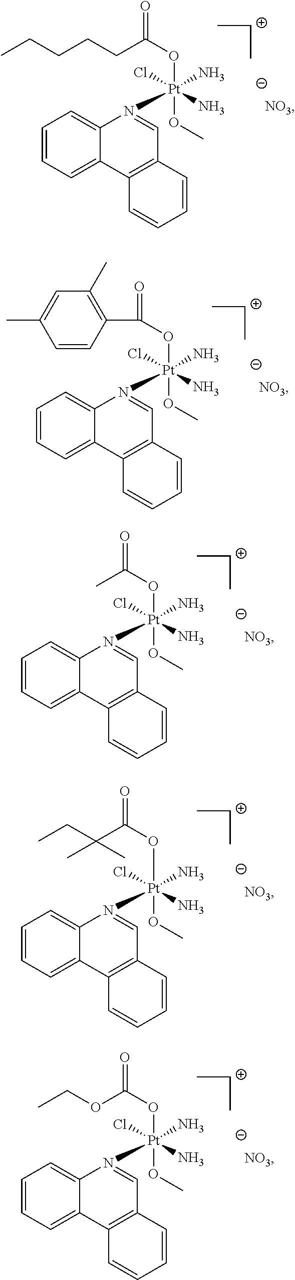

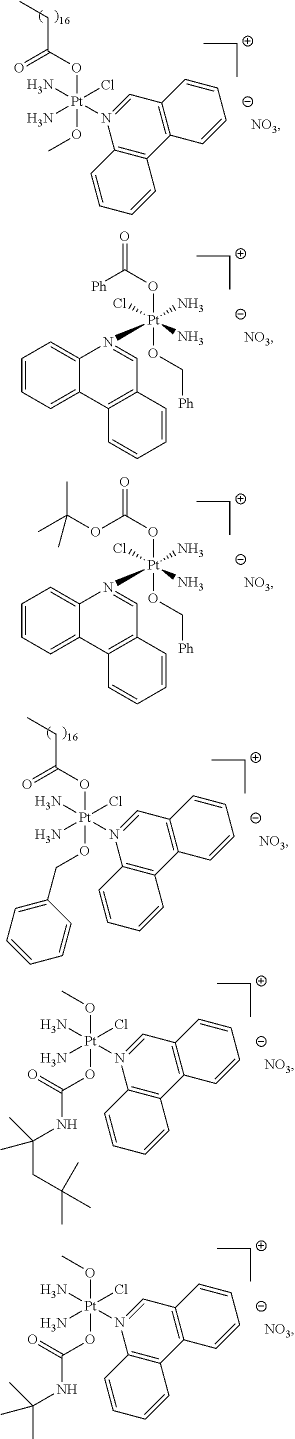

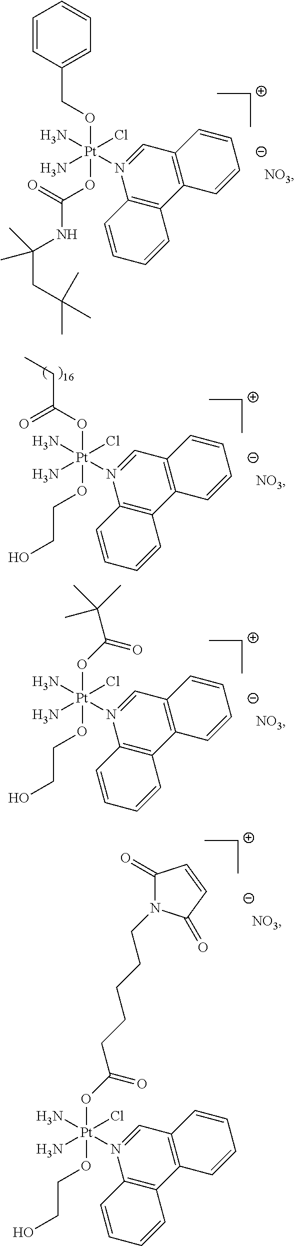

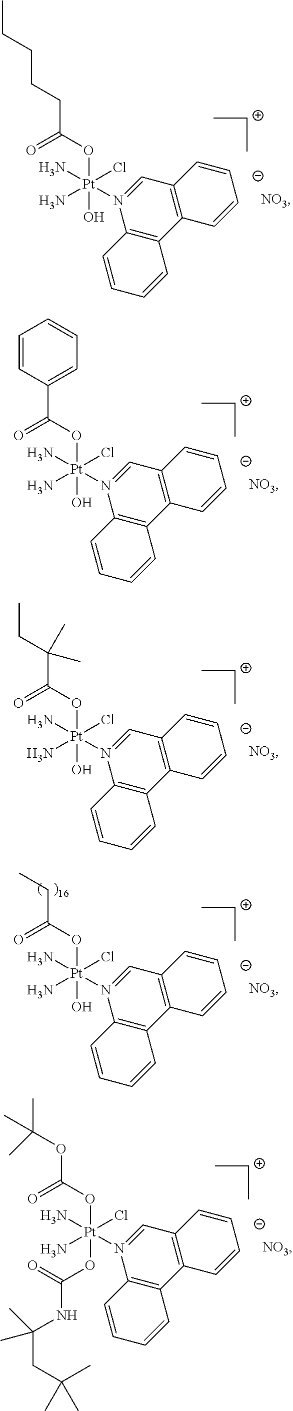

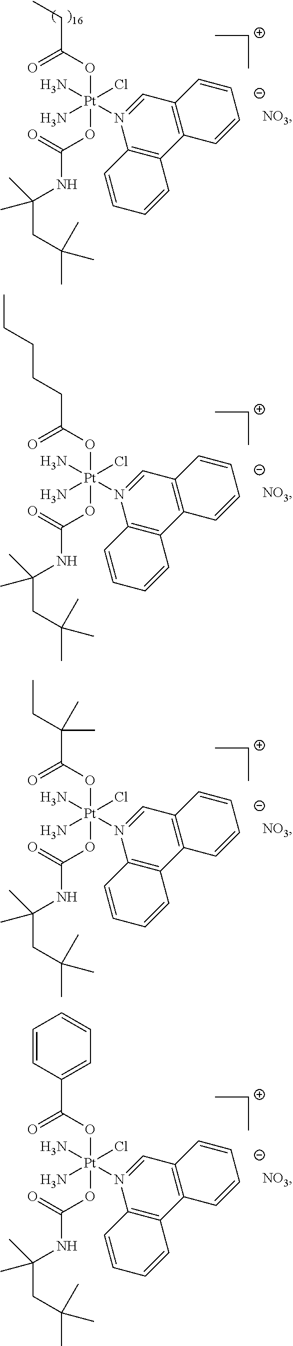

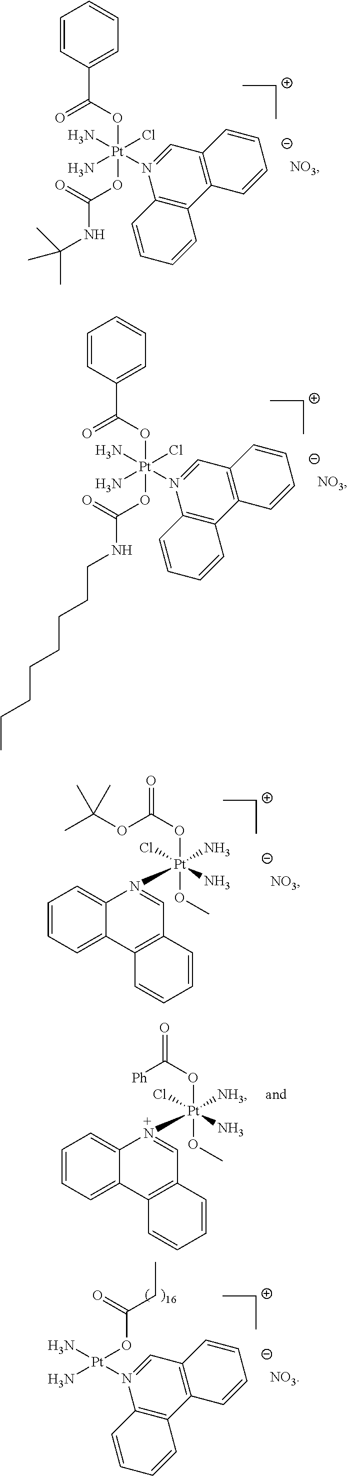

27. A pharmaceutical composition comprising a compound from any one of claims 1 to 26.

28. A method of treating cancer selected from a group consisting of lung cancer, breast cancer, colorectal cancer, ovarian cancer, bladder cancer, prostate cancer, cervical cancer, renal cancer, leukemia, central nerve system cancers, myeloma, and melanoma, comprising administering a therapeutically effective amount of a compound of any one of claims 1 to 26.

29. A nanoparticle and/or microparticle comprising a compound of any one of claims 1 to 26.

30. The nanoparticle and/or microparticle of claim 29, wherein the compound is phenanthriplatin.
